(19) United States
(12) Patent Application Publication
(10) Pub. No.: US 2015/0312530 A1
(43) Pub. Date: Oct. 29, 2015

(54) DYNAMICALLY ADJUSTABLE MIRRORS

(71) Applicant: RAZMIK KARABED, SAN JOSE, CA (US)

(72) Inventor: RAZMIK KARABED, SAN JOSE, CA (US)

(21) Appl. No.: 14/536,060

(22) Filed: Nov. 7, 2014

Related U.S. Application Data
(60) Provisional application No. 61/985,497, filed on Apr. 29, 2014.
(60) Provisional application No. 62/038,314, filed on Aug. 17, 2014.

(51) Int. Cl. H04N 7/18; G01B 11/26; B60R 1/08; B60R 1/02; B60R 1/00

(52) U.S. Cl. CPC H04N 7/183; B60R 1/025; B60R 1/006; B60R 1/08; G01B 11/26

(57) ABSTRACT

A dynamically adjustable system for updating an angular orientation of a surveillance device of a moving vehicle is disclosed. The system comprises a surveillance device, a motor coupled to the surveillance device, a compass based angular sensor configured for detecting the orientation of a vehicle, and a controller. The controller calculates the updated angular orientation of the surveillance device and sends control signals to the motor. The motor rotates the surveillance device such that the surveillance device provides a driver of the vehicle with a key desired field of view. Pitch and roll sensors may also be employed by the system. When a turning event is detected, the controller dynamically changes the angles of the surveillance devices to provide the driver with a view of important roads within the intersection.

### RELATED APPLICATION INFORMATION

The present application claims priority under 35 U.S.C. Section 119(e) to U.S. Provisional Patent Application Ser. No. 61/985,497 filed Apr. 29, 2014 entitle“Dynamically Adjustable Mirror” and to U.S. Provisional Patent Application Ser. No. 62/038,314 filed Aug. 17, 2014 entitled “Dynamically Adjustable Views” the disclosures of which are incorporated herein by reference in their entirety.

### BACKGROUND OF THE INVENTION

1. Field of the Invention

The present invention relates to mirrors or other surveillance devices for moving vehicles. More particularly, the invention is directed to dynamically adjustable mirrors for moving vehicles.

2. Description of the Related Art

The proper use of rear-view, right-side and left-side mirrors is part of necessary driving habits and skills. These mirrors provide great help to a driver in making many important driving decisions. Nevertheless, during a typical left or right turn, except at the start and at the end of the turn, these mirrors provide views that, in general, are not the most helpful. A study of the following situations would confirm the above assertion. There are six scenarios including A1) Right-side mirror during a left turn, A2) Right-side mirror during a right turn, A3) Left-side mirror during a left turn, A4) Left-side mirror during a right turn, A5) Rear-view mirror during a left turn, and A6) Rear-view mirror during a right turn

With respect to scenario A1 (Right-side mirror during a left turn) and referring to FIG. 1, an automobile 100 is depicted in three positions: facing north at an intersection 10 (position 120), facing north-west in the intersection 10 (position 122), and facing west past the intersection 10 (position 124). The automobile 100 has a right-side mirror 1, a left-side mirror 2, and a rear-view mirror 3. At the start of the turn, the mirrors 1, 2, and 3 are all showing views facing south. The rear-view mirror 3 is showing a view generally toward south, the right-side mirror 1 is showing a view toward south from the right side of the automobile 100, and the left-side mirror 2 is showing a view toward south from the left side of the automobile 100. And, at the end of the left turn, the mirrors 1, 2, and 3 are showing views facing east. However, during the left turn in the intersection 10, these mirrors are mostly showing views of the surroundings at the south/east corner of the intersection 10. In general, these views are not the most helpful. Views of the two streets would be more helpful since they would show nearby automobiles.

With respect to scenario A2 (Right-side mirror during a right turn) and referring to FIG. 2, the automobile 100 is depicted in three positions again: facing north at the intersection 10 (position 120), facing north-east in the intersection 10 (position 126), and facing east past the intersection 10 (position 128). Again at the start of the turn, the mirrors 1, 2, and 3 are all showing views facing south. And, at the end of the right turn, the mirrors 1, 2, and 3 are showing views facing west. However, during the right turn in the intersection 10, these mirrors are mostly showing views of the surroundings at the south/west corner of the intersection 10. Again in general, these views are not the most helpful since they show a portion of the street which carries cars going south, past the intersection 10.

With respect to scenario A3 (Left-side mirror during a left turn), this is the same as A2 except rotational polarities are reversed.

With respect to scenario A4 (Left-side mirror during a right turn), this is the same as A1 except rotational polarities are reversed. With respect to scenarios A5 and A6 and referring to FIGS. 1 and 2, the rear-view mirror 3 generally has the same limitations during a turn that the side mirrors 1 and 2 have.

According to the U.S. Department of Transportation, National Highway Traffic Safety Administration (NHTSA), DOT HS 811 366, September 2010, entitled “Crash Factors in Intersection-Related Crashes: An On-Scene Perspective”. Among 12 critical pre-crash events a) Vehicle turning left at intersection is number 1, with 22.2% of all crashes, b) Vehicle crossing over at intersection is number 3, with 12.6%, and c) Vehicle turning right at intersection is number 10, with 1.2%.

Table I below lists the relative ratio of driver-attributed critical reason in intersection-related versus non-intersection-related crashes.

TABLE I

| Critical Reason | Relative ratio |
|---|---|
| Turned With Obstructed View | 335.0 |
| Inadequate Surveillance | 6.1 |

Therefore, improving the view and improving surveillance at intersections, especially, improving the view and improving the surveillance for making a left turn at intersections, will reduce the top critical crash reasons significantly.

Four patents including U.S. Pat. No. 5,132,851, U.S. Pat. No. 5,306,953, U.S. Pat. No. 5,980,048, and U.S. Pat. No. 6,390,631 are briefly described below. Some solutions treat vehicle and trailer pairs. There is a need for more comprehensive solutions for stand-alone vehicles. In general these solutions generally involve the vehicle driver side-side mirror during a left turn (FIG. 10, U.S. Pat. No. 5,132,851) or the vehicle passenger-side mirror during a right turn (FIG. 11 U.S. Pat. No. 5,132,851). There is a need for solutions for all mirrors for both left turns as well as right turns.

A first class of solutions involves use of ultrasonic sensor(s). There is a need for more accurate sensors. A second class of solutions involves use of a gyroscope sensor.

More and more solutions in other applications show that gyroscopes are not the best sensors to measure angles accurately. They generally suffer from an error accumulation (drift).

In U.S. Pat. No. 6,390,631, it is stated that gyroscope sensors are accurate when vehicle speed is not less than a minimum speed, speed-min, and when vehicle speed does not exceed a maximum speed, speed-max. Solutions without such constraints are desired because they can be applied to a bigger class of real life left/right turn situations.

In US patent application 6390631, the following situation is discussed using WO9523079A as a reference. For a tractor-trailer, the goal is first to measure the angle between the two, then to modify the left side mirror position to improve the blind spot.

Referring to WO9523079A, they report on a solution where one magnetic sensor is placed on the tractor and another magnetic sensor is placed on the trailer. The readings from the two magnetic sensors are used to measure the angle between the trailer and the tractor. They claim this method may not be as good because the magnetic sensor on the tractor is influenced by the noise in its surroundings, and the magnetic sensor on the trailer is influenced by the noise in its surroundings; when the two readings are used, then the result gets corrupted by the noise in both surroundings.

For one, in U.S. Pat. No. 6,390,631, the key angle is between the two parts of the moving vehicle: the tractor and the trailer, but the key angle here is between the position of a moving vehicle at time t1 and the position of the same moving vehicle at time t2.

Another difference between the two problems is that, generally while in reading two magnets, the “noises” “add”, but in reading the same magnet twice, some “noises” fully or partially cancel each other.

Accordingly, a need exists to improve dynamically adjusted mirror systems.

### SUMMARY OF THE INVENTION

In the first aspect, a dynamically adjustable system for updating an angular orientation of a surveillance device of a moving vehicle is disclosed. The system comprises a surveillance device, a motor coupled to the surveillance device, the motor configured to rotate the surveillance device about an axis, and a compass based angular sensor configured for detecting the orientation of a vehicle, the angular sensor providing an angular position signal. The system further comprises a controller communicating with the angular sensor and a turn signal switch of the vehicle, the controller receiving the angular position signal and a turn indication signal from the turn signal switch, the controller calculating the updated angular orientation of the surveillance device based on the angular position signal and the turn indication signal, the controller providing an updated angular orientation signal to the motor. The motor rotates the surveillance device based on the updated angular orientation signal from the controller, the surveillance device providing a driver of the vehicle with a key desired field of view.

In a first preferred embodiment, the key desired view comprises a view of pedestrians crossing a street. The key desired view preferably comprises a view of a road section immediately behind the vehicle before the turning is initiated. The key desired view preferably comprises a view of a road section opposite to that of the road section into which the vehicle is turning. The key desired view preferably comprises a view of a road section into which the vehicle is turning. The controller preferably delays the calculating the updated angular orientation of the surveillance device until the vehicle initiates the turn. The system preferably further comprises a Global Positioning System (GPS) providing GPS signals to the controller, where the controller is further configured to calculate the updated angular orientation of the surveillance device based on the GPS signals. The angular orientation of the surveillance device is preferably bounded from above. The system preferably further comprises a microswitch configured to limit the rotation of the motor. The surveillance device preferably comprises a reflective mirror.

In a second aspect, a dynamically adjustable system for updating an angular orientation of a surveillance device of a moving vehicle is disclosed. The system comprises a surveillance device, a motor coupled to the surveillance device, the motor configured to rotate the surveillance device about an axis, and a pitch and roll sensor providing a pitch and roll signal. The system further comprises a controller communicating with the pitch and roll sensor and a turn signal switch of the vehicle, the controller receiving a turn indication signal from the turn signal switch and the pitch and roll signal from the pitch and roll sensor, the controller calculating the updated angular orientation of the surveillance device based on the turn indication signal and the pitch and roll signal, the controller providing an updated angular orientation signal to the motor. The motor rotates the surveillance device based on the updated angular orientation signal from the controller, the surveillance device providing a driver of the vehicle with a key desired field of view.

In a second preferred embodiment, the key desired view comprises a view of pedestrians crossing a street. The key desired view preferably comprises a view of a road section immediately behind the vehicle before the turning is initiated. The key desired view preferably comprises a view of a road section opposite to that of the road section into which the vehicle is turning. The key desired view preferably comprises a view of a road section into which the vehicle is turning. The controller preferably delays the calculating the updated angular orientation of the surveillance device until the vehicle initiates the turn. The system preferably further comprises a Global Positioning System (GPS) providing GPS signals to the controller, where the controller is further configured to calculate the updated angular orientation of the surveillance device based on the GPS signals. The angular orientation of the surveillance device is preferably bounded from above. The system preferably further comprises a microswitch configured to limit the rotation of the motor. The surveillance device preferably comprises a reflective mirror.

In a third aspect, a method for dynamically updating an angular orientation of a surveillance device of a moving vehicle is disclosed. The method comprises receiving the angular position signal from a compass based angular sensor, receiving a turn indication signal from a turn signal switch, calculating the updated angular orientation of the surveillance device based on the angular position signal and the turn indication signal by a controller, providing an updated angular orientation signal to the motor based on the updated angular orientation, and rotating the surveillance device based on the updated angular position signal.

In a third preferred embodiments, the method further comprises receiving a pitch and roll signal from the pitch and roll sensor, where the controller is further configured to calculate the updated angular orientation of the surveillance device based on the angular position signal, the turn indication signal, and the pitch and roll signal.

In a fourth aspect, a dynamically adjustable system for updating an angular orientation of mirrors of a moving vehicle is disclosed. The system comprises a mirror assembly comprising a center mirror section having a left side and a right side, a left mirror section rotatively coupled to the left side of the center mirror section, a first motor coupled to the center mirror section and the left mirror section, the first motor configured to rotate the left mirror relative to the center mirror section, a right mirror assembly rotatively coupled to the right side of the center mirror section, and a second motor coupled to the center mirror section and the right mirror section, the motor configured to rotate the right mirror relative to the center mirror section. The system further comprises a controller coupled to the first motor and the second motor, the controller configured for changing the view of the left mirror section and a right mirror section during a turn, the left and the right mirror sections providing a driver of the vehicle with a key desired field of view.

In a fourth preferred embodiment, the system further comprises a compass based angular sensor configured for detecting the orientation of a vehicle, the angular sensor providing an angular position signal. The controller is configured to communicate with the angular sensor and a turn signal switch of the vehicle, the controller receiving the angular position signal and a turn indication signal from the turn signal switch, the controller calculating the updated angular orientation of the left and right mirror sections based on the angular position signal and the turn indication signal, the controller providing an updated angular orientation signal to the first and second motors. The key desired view preferably comprises a view of a road section opposite to that of the road section into which the vehicle is turning.

These and other features and advantages of the invention will become more apparent with a description of preferred embodiments in reference to the associated drawings.

### DESCRIPTION OF THE DRAWINGS

FIG. 1 illustrates an automobile making a left turn and the automobile mirror views.

FIG. 2 illustrates an automobile making a right turn and the automobile mirror views.

FIG. 3A depicts a dynamically adjustable mirror apparatus 1 for the right side mirror according to the first embodiment.

FIG. 3B depicts a dynamically adjustable mirror apparatus 1 for the left side mirror according to the first embodiment.

FIG. 4A depicts an application of the dynamically adjustable mirror apparatus 1 for the right side mirror at the beginning of a left turn, according to the first embodiment.

FIG. 4B depicts an application of the dynamically adjustable mirror apparatus 1 for the left side mirror at the beginning of a right turn, according to the first embodiment.

FIG. 5A depicts an application of the dynamically adjustable mirror apparatus 1 for the right side mirror during a left turn, according to the first embodiment.

FIG. 5B depicts an application of the dynamically adjustable mirror apparatus 1 for the left side mirror during a right turn, according to the first embodiment.

FIG. 6A depicts an application of the dynamically adjustable mirror apparatus 1 for the right side mirror at the end of a left turn, according to the first embodiment.

FIG. 6B depicts an application of the dynamically adjustable mirror apparatus 1 for the left side mirror at the end of a right turn, according to the first embodiment.

FIG. 7A depicts an application of the dynamically adjustable mirror apparatus 2 for the right side mirror during a right turn, according to the second embodiment.

FIG. 7B depicts an application of the dynamically adjustable mirror apparatus 2 for the left side mirror during a left turn, according to the second embodiment.

FIG. 8A depicts an application of the dynamically adjustable mirror apparatus 2 for the right side mirror at the end of a right turn, according to the second embodiment.

FIG. 8B depicts an application of the dynamically adjustable mirror apparatus 2 for the left side mirror at the end of a left turn, according to the second embodiment.

FIG. 9A depicts an application of the dynamically adjustable mirror apparatuses 8-10 for the rear view, right side augmented mirror according to the eighth, ninth, and tenth embodiments.

FIG. 9B depicts an application of the dynamically adjustable mirror apparatuses 8-10 for the rear view, left side augmented mirror according to the eighth, ninth, and tenth embodiments.

FIG. 10 illustrates a basic stepper-motor system.

FIG. 11 shows a typical micro-controller.

FIG. 12 shows a dynamically adjustable unit 1.

FIG. 13 shows a circle used to relate 4 sets.

FIG. 14 illustrates an x-y coordinates system that supports compass directions.

FIG. 15 depicts a dynamically adjustable mirror apparatus 1 applied to an augmented portion of the right side mirror.

FIG. 16 shows a dynamically adjustable unit 4.

FIG. 17 shows an automobile on an inclined slope, and shows the automobile pitch and roll angles.

FIG. 18 depicts an application of the dynamically adjustable mirror apparatus 7 for the side mirrors during a reverse, according to the 7th embodiment.

FIG. 19 illustrates an exemplary process for dynamically adjusting mirrors in one or more embodiments.

FIG. 20A depicts an application of the dynamically adjustable mirror apparatus 6 for the right side mirror during a right turn, according to the sixth embodiment.

FIG. 20B depicts an application of the dynamically adjustable mirror apparatus 6 for the left side mirror during a left turn, according to the sixth embodiment.

FIG. 21A depicts an application of the dynamically adjustable mirror apparatus 8 for the right side augmented mirror at the beginning of a left turn, according to the eighth embodiment.

FIG. 21B depicts an application of the dynamically adjustable mirror apparatus 8 for the left side augmented mirror at the beginning of a right turn, according to the eighth embodiment.

FIG. 22A depicts an application of the dynamically adjustable mirror apparatus 8 for the right side augmented mirror during a left turn, according to the eighth embodiment.

FIG. 22B depicts an application of the dynamically adjustable mirror apparatus 8 for the left side augmented mirror during a right turn, according to the eighth embodiment.

FIG. 23A depicts an application of the dynamically adjustable mirror apparatus 8 for the right side augmented mirror at the end of a left turn, according to the eighth embodiment.

FIG. 23B depicts an application of the dynamically adjustable mirror apparatus 8 for the left side augmented mirror at the end of a right turn, according to the eighth embodiment.

FIG. 24A depicts an application of the dynamically adjustable mirror apparatus 9 for the right side augmented mirror during a right turn, according to the ninth embodiment.

FIG. 24B depicts an application of the dynamically adjustable mirror apparatus 9 for the left side augmented mirror during a left turn, according to the ninth embodiment.

FIG. 25A depicts an application of the dynamically adjustable mirror apparatus 9 for the right side augmented mirror at the end of a right turn, according to the ninth embodiment.

FIG. 25B depicts an application of the dynamically adjustable mirror apparatus 9 for the left side augmented mirror at the end of a left turn, according to the ninth embodiment.

FIG. 26A depicts an application of the dynamically adjustable mirror apparatus 10 for the right side augmented mirror during a right turn, according to the tenth embodiment.

FIG. 26B depicts an application of the dynamically adjustable mirror apparatus 10 for the left side augmented mirror during a left turn, according to the tenth embodiment.

### DETAILED DESCRIPTION OF THE PREFERRED EMBODIMENTS

One or more embodiments apply to stand-alone vehicles, are directly adaptable to vehicle and trailer pairs, and use either compass based sensors or (pitch and roll) based sensors. They have been shown to be more accurate in measuring angles in other applications. The terms “compass” and magnetometer are used inter-changeably in this disclosure.

One or more embodiments use a group of sensors containing either one compass sensor or one (pitch roll) sensor. It has been shown in other applications that each sensor has its strong properties and its weak properties. Therefore, a carefully selected combination of sensors can provide a better all-around performance. For example, a group of sensors comprising compasses and accelerometers to measure yaw is proposed in “Professional Android Sensor Programming,” Greg Milette, and Adam Stroud, Publisher is Wrox Publisher, Jun. 5, 2012, Part II: Inferring Information from Physical Sensors.

One or more embodiments may use filtering such as low pass, high pass, and Kalman filters to remove noise from sensors, as discussed in the reference immediately above.

One or more embodiments provide solutions 1) for left side, right side, and rear view mirrors during both left turn and right turn; 2) for left side, right side, and rear view mirrors during a reverse, and that are easily adaptable to incorporate GPS side information.

One or more embodiments provide a general solution for A1 and A2 cases. An apparatus is proposed that moves the mirrors into positions with key viewing angles during turns. Further, embodiments move the mirrors such that they produce steady, or slow moving, viewing backgrounds during turns.

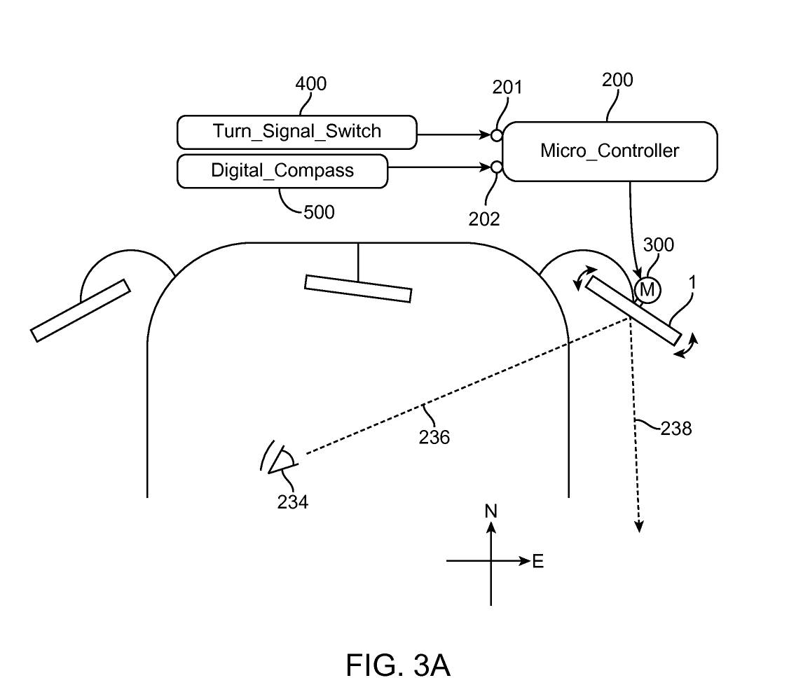

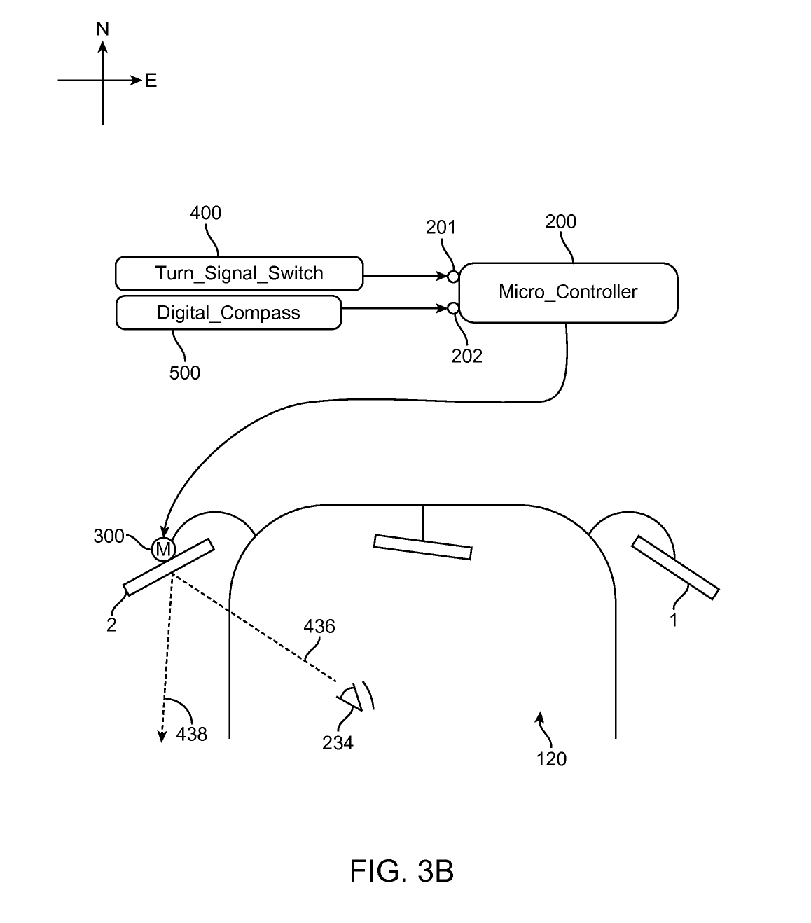

Referring to FIG. 3A, a microcontroller 200 controls the right-side mirror 1 viewing angle. The microcontroller 200 has input ports 201 and 202. The input port 201 is connected to an automobile turn signal switch 400 and the input port 202 is connected to a digital compass 500. The micro-controller 200 controls the right-side mirror 1 viewing angle by an electric motor 300. The mirror 1 enables the driver 234 to view the field of vision 238 via the field of vision 236 of mirror 1.

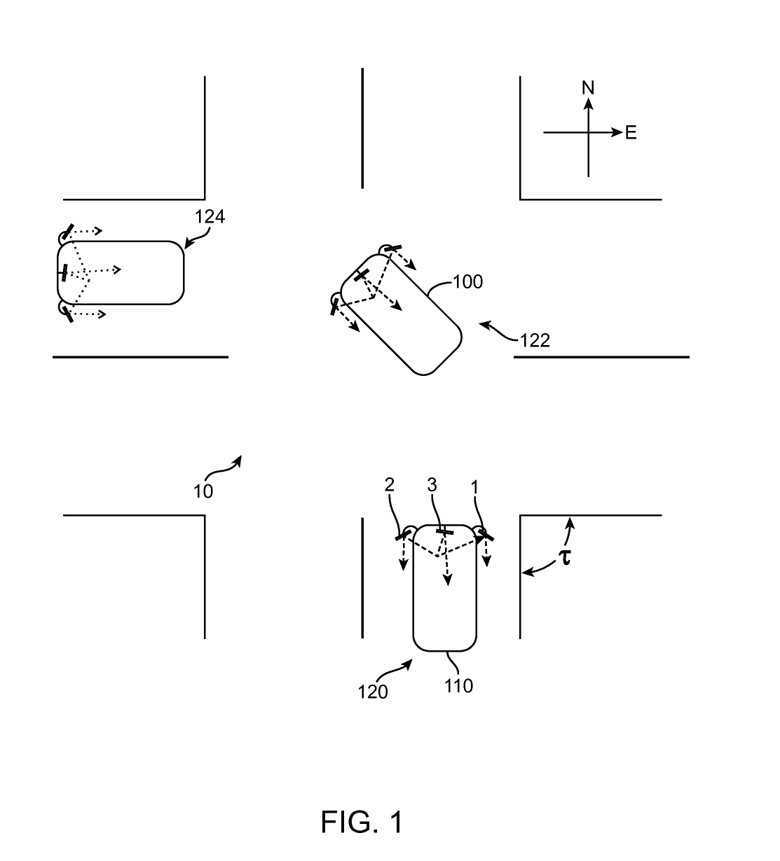

Embodiments provide solutions for scenario A1 (right-side mirror during a left turn). Briefly, on a left turn on the intersection 10 of FIG. 1, in the absence of the micro-controller, the right-side mirror 1 view gradually changes from facing south to facing east. Embodiments quickly moves the right-side mirror 1 view facing east in the beginning of the turn. Then by making gradual changes to the right-side mirror 1 position, the proposed apparatus continuously maintains a view facing east at all times during the turn. The apparatus disengages once the turn is completed.

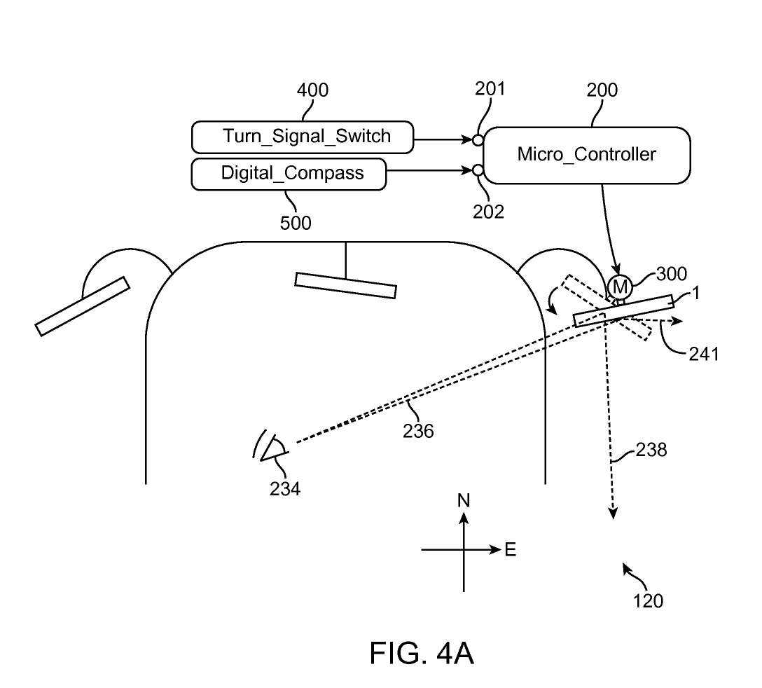

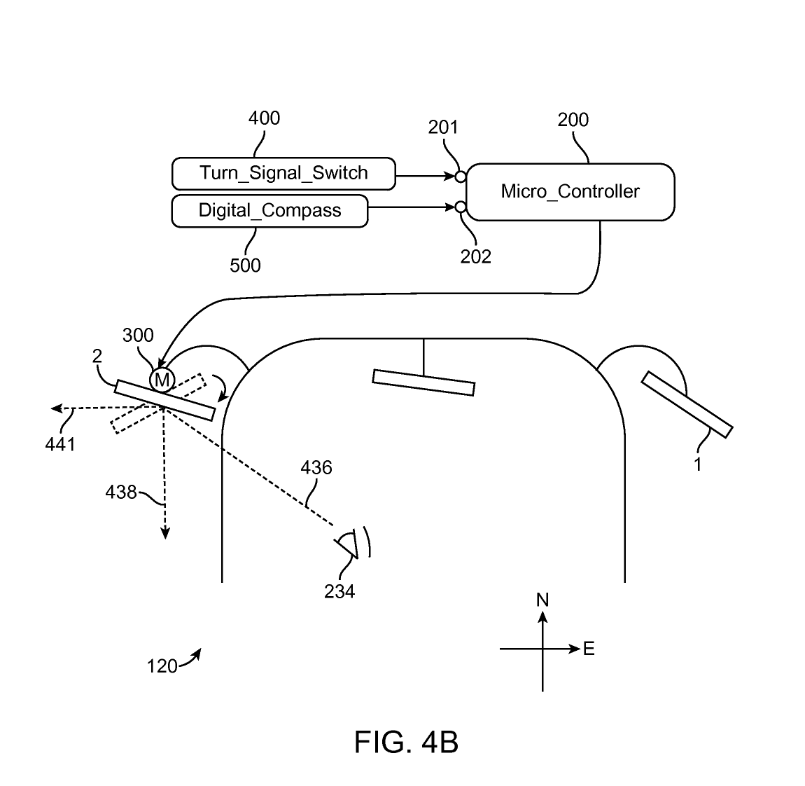

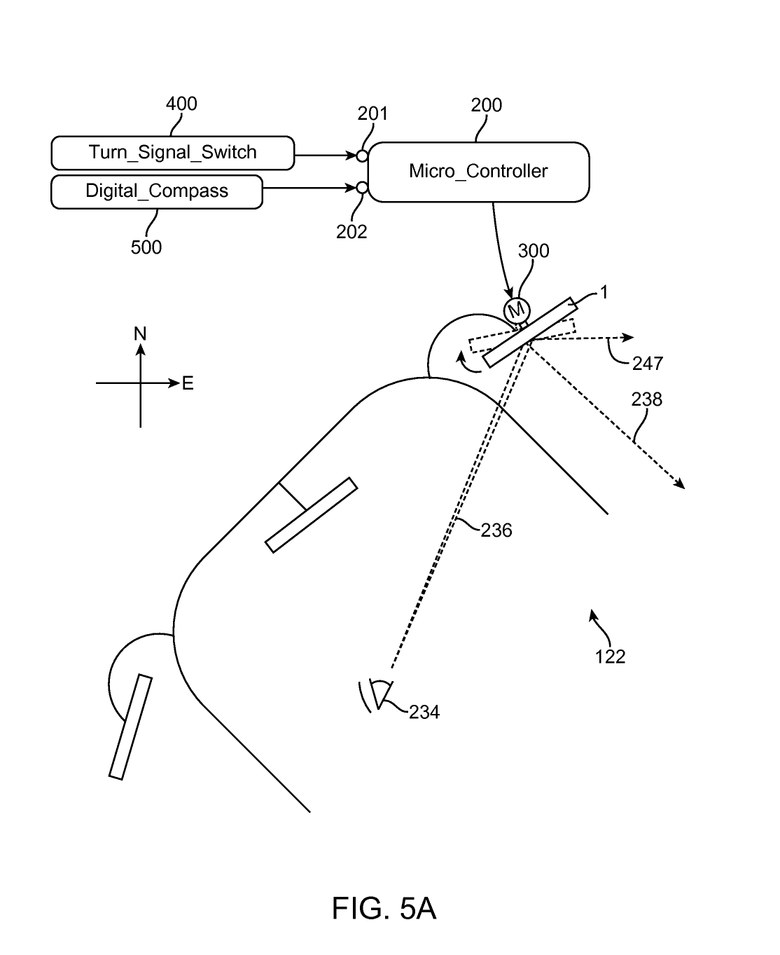

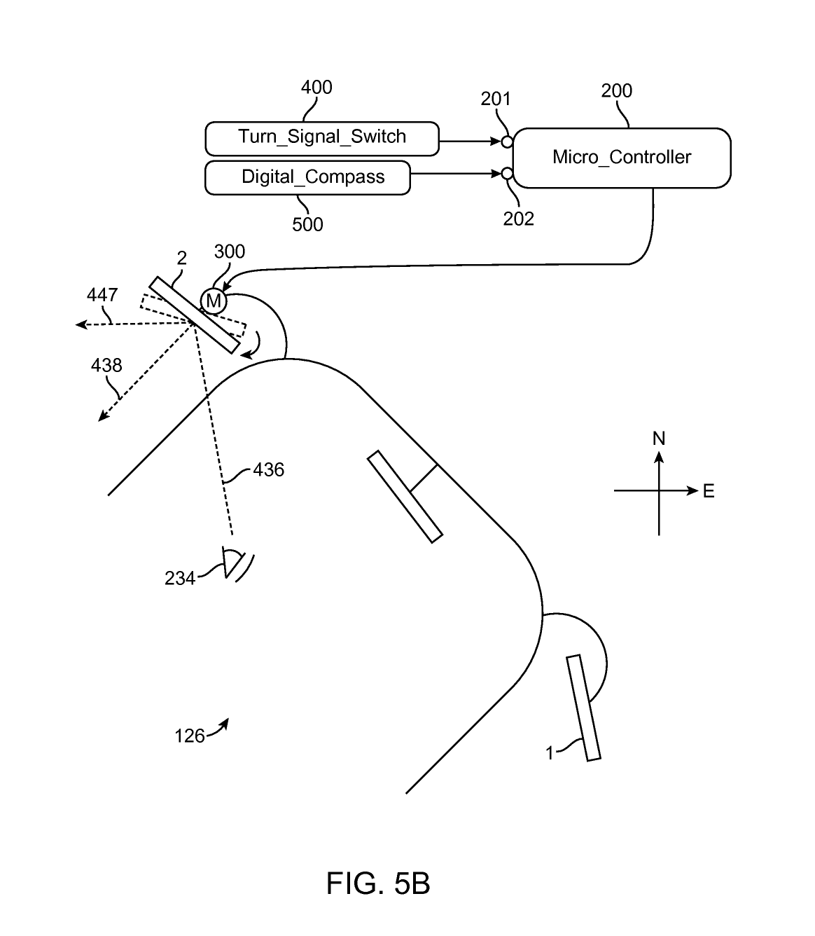

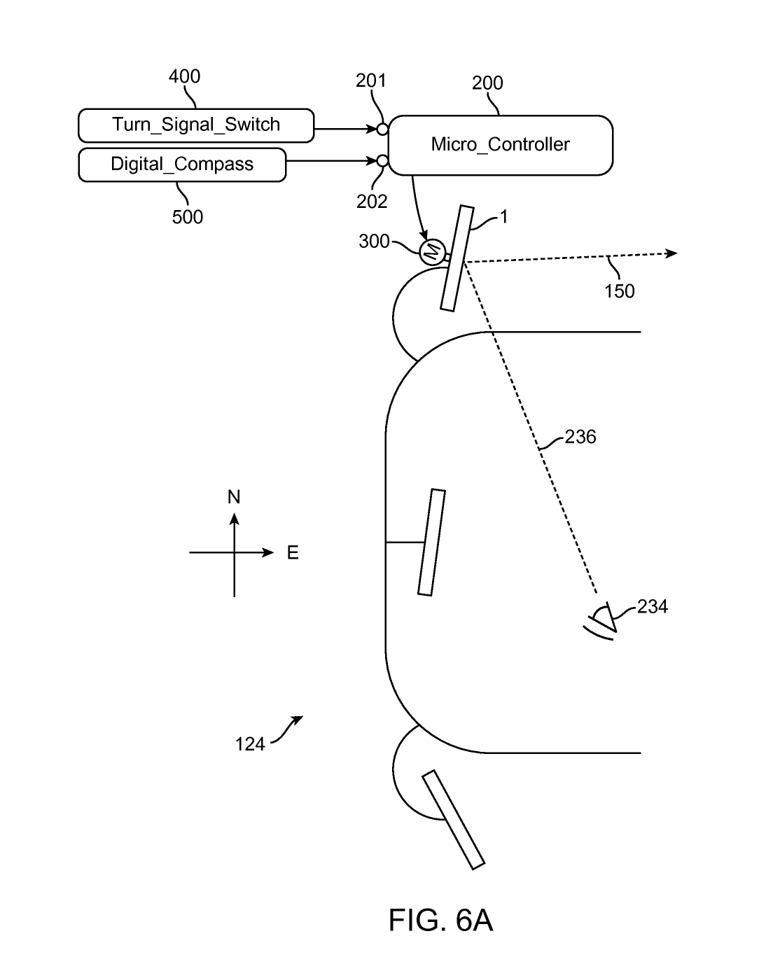

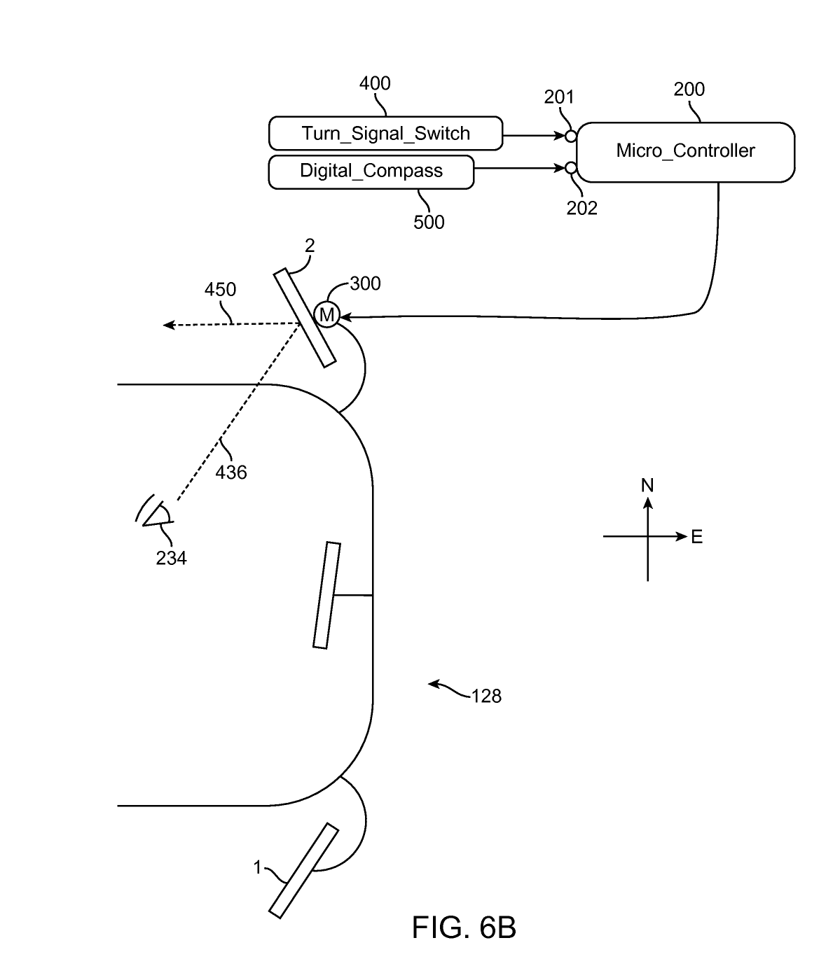

Specifically, FIGS. 4A, 5A, and 6A relate to three positions 120, 122, and 124 of the automobile 100, during a left turn. These positions are depicted in FIG. 1. FIG. 4A relates to the automobile 100 position 120 at the start of the left turn. The mirror 1 oriented as shown enables the driver 234 to view the field of vision 241 via the field of vision 236 of mirror 1. FIG. 5A relates to the automobile 100 position 122 during the left turn. The right-side mirror 1 oriented as shown enables the driver 234 to view the field of vision 247 via the field of vision 236 of the right-side mirror 1. FIG. 6A relates to the automobile 100 position at the end of the left turn 124. The mirror 1 oriented as shown enables the driver 234 to view the field of vision 150 via the field of vision 236 of mirror 1.

On a left turn, the micro-controller 200 performs the following tasks with respect to the right-side mirror 1.

First, a left turn is detected based on the turn signal switch 400 signal through the port 200.

Second, the right-side mirror 1 position is depicted with dotted lines in FIG. 4A. In this position, the right-side mirror 1 shows a view of the field of vision 238, this is generally toward south. Once a left turn is detected, the micro-controller 200 quickly rotates the right-side mirror 1 by about 45 degrees counter-clockwise with respect to FIG. 4A top view reference. The micro-controller 200 uses the electric motor 300 to move the right-side mirror 1. After this rotation, the view of the right-side mirror 1 rotates about 90 degrees in counter-clockwise direction, facing generally east. The right-side mirror 1 position after the rotation is depicted with solid lines in FIG. 4A.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the right-side mirror 1 position through the motor 300, so that the right-side mirror 1 continuously provides a view facing generally east. FIG. 5A shows the situation when the automobile 100 has completed half the turn. The right-side mirror 1 position in the absence of the micro-controller 200 is shown with dotted lines. In this position the right-side mirror 1 is showing a view of the field of vision 238, this is generally facing south/east. The right-side mirror 1 position in the presence of the micro-controller 200 is shown with solid lines. In this position, the right-side mirror 1 is showing a view of the field of vision 247, this is facing generally east.

Fourth, as the automobile 100 ends the left turn, FIG. 6A, two positions of the right-side mirror 1: 1) in the presence of the micro-controller 200 changes, and 2) in the absence of the micro-controller changes, coincide. This concludes the micro-controller 200 operations during a left turn.

In summary, referring to FIG. 1, in the absence of the DACU-1 700, the right-side mirror 1 views during a left turn spans the south east corner of the intersection 10, while with the DACU-1 700, the view focuses on the traffic approaching the intersection 10 from east. The later view provides surveillance information that is highly relevant to making a safe left turn in at least two regards: 1) Avoiding collisions with incoming traffic from east, and 2) Giving the driver of the automobile 100 more time to concentrate on the traffic from north and the traffic from west, by quickly informing the driver about the traffic from east.

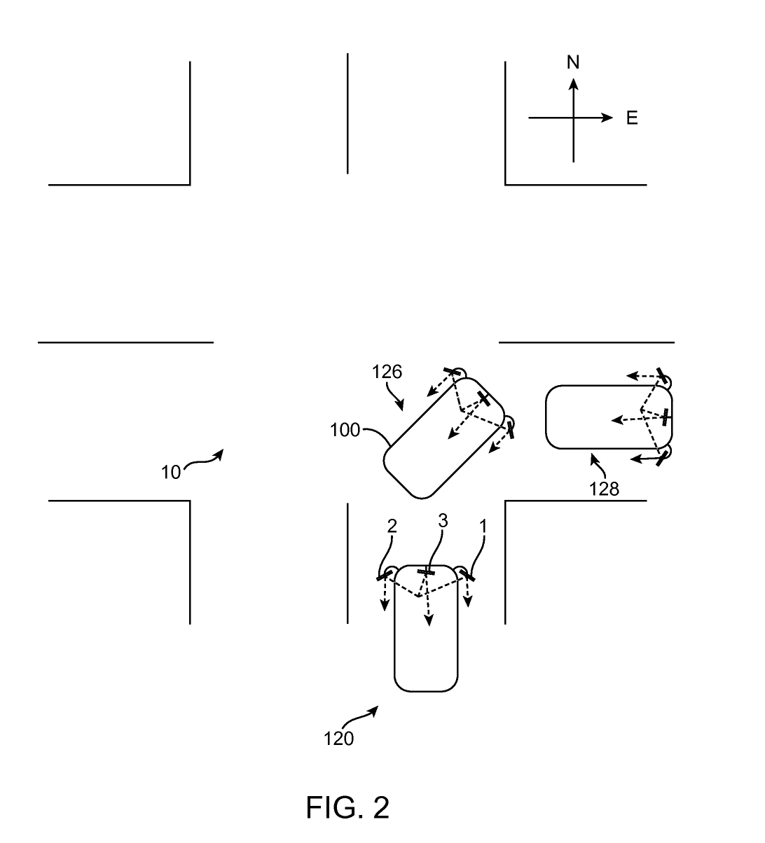

One or more embodiments provide solutions for scenario A2 (right-side mirror during a right turn). Briefly, on a right turn at the intersection 10 of FIG. 2, in the absence of the micro-controller 200, the view of the right-side mirror 1 gradually changes from facing south to facing west.

By making gradual changes to the right-side mirror 1 position, the proposed apparatus maintains the view of the right-side mirror 1 facing generally south at all times during the right turn. Then at the end of the right turn, the apparatus will quickly move the right-side mirror 1 to its neutral position—the position the right-side mirror 1 would have had in the absence of the micro-controller 200. At the end of the turn, in the neutral position, the view of the right-side mirror 1 is toward west.

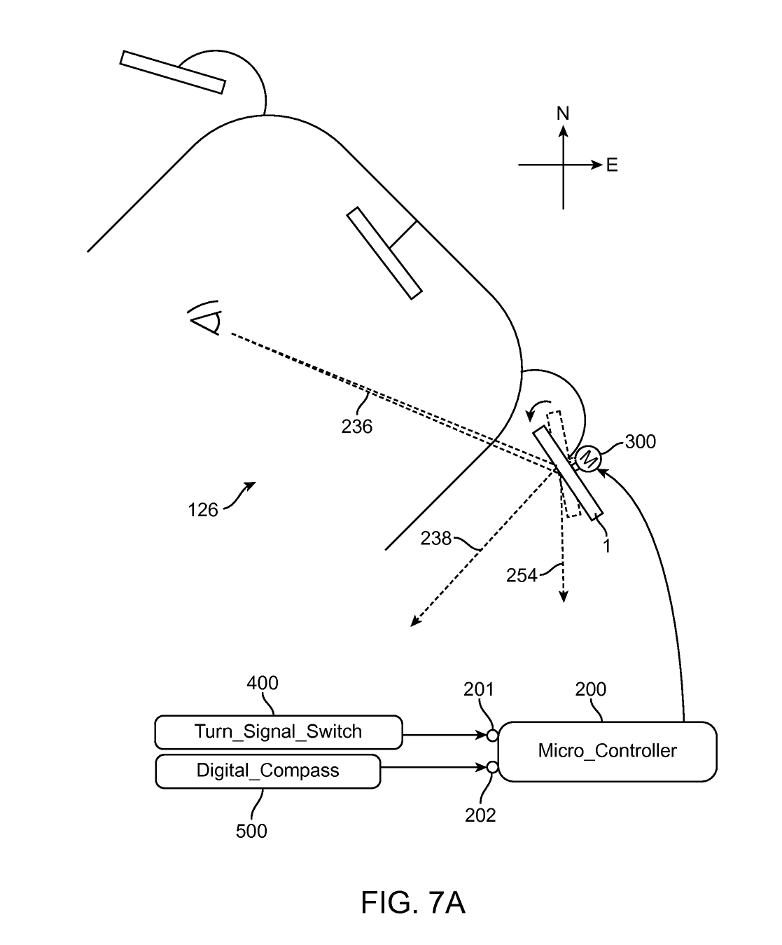

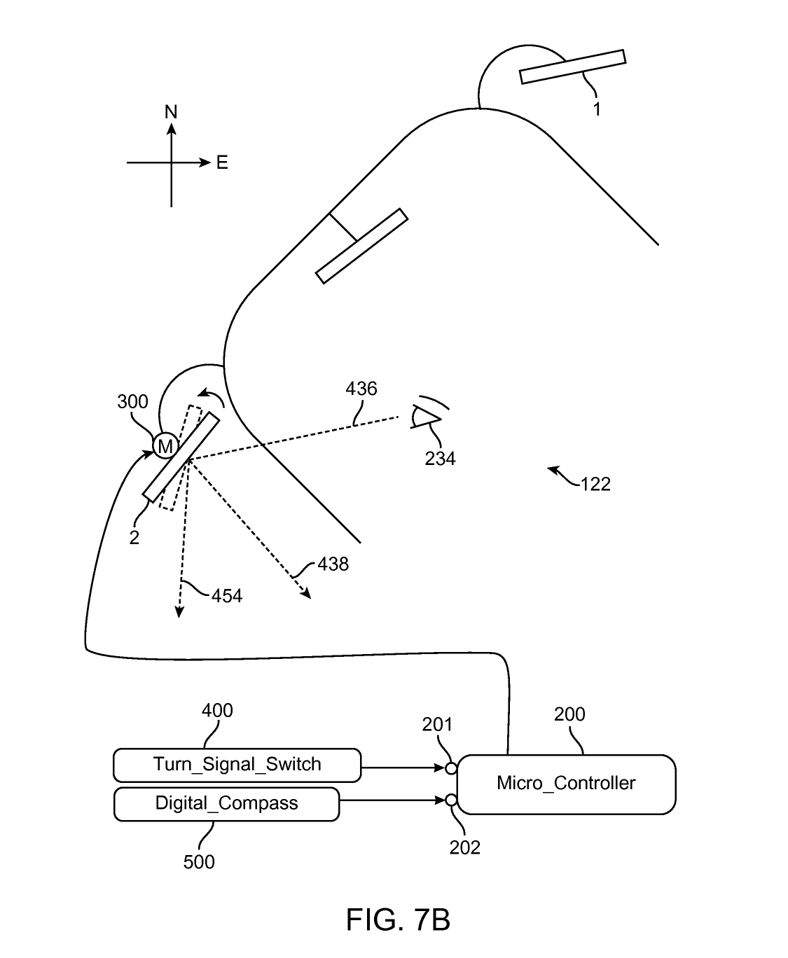

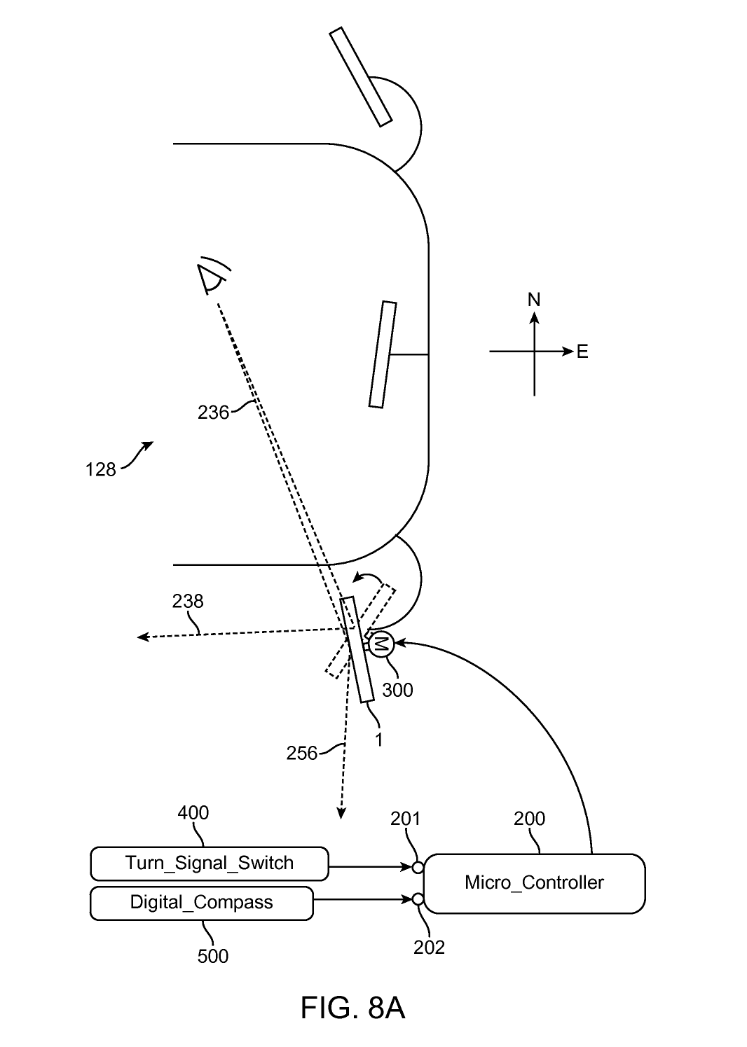

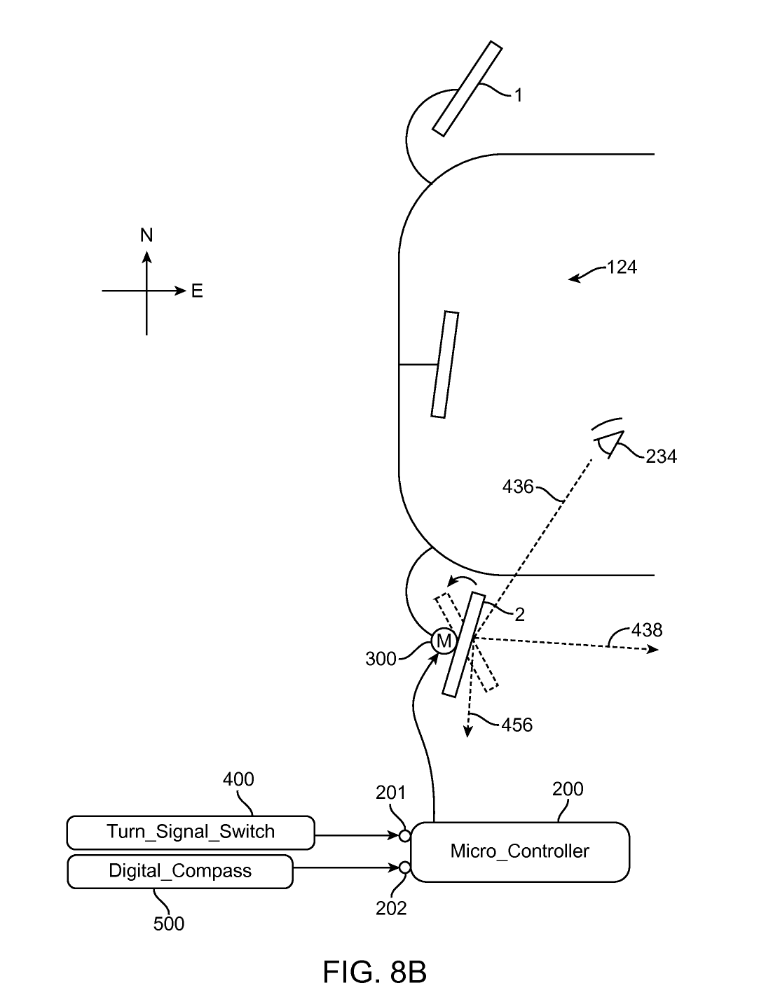

Specifically, FIGS. 3A, 7A, and 8A relate to the automobile 100, three positions 120, 126, and 128 during a right turn. These positions were depicted in FIG. 2. FIG. 3A relates to the automobile 100 position 120 at the start of the right turn. The mirror 1 oriented as shown enables the driver 234 to view the field of vision 238 via the field of vision 236 of mirror 1. FIG. 7A relates to the automobile 100 position during the right turn. The mirror 1 oriented as shown enables the driver 234 to view the field of vision 254 via the field of vision 236 of the right-side mirror 1. FIG. 8A relates to the automobile 100 position at the end of the right turn. The right-side mirror 1 oriented as shown enables the driver 234 to view the field of vision 256 via the field of vision 236 of the right-side mirror 1.

On a right turn, the microcontroller performs the following tasks with respect to the right-side mirror 1.

First, a right turn is detected based on the turn signal switch 400 signal through the port 201.

Second, the right-side mirror 1 position is depicted with solid lines in FIG. 3A. At this position, the right-side mirror 1 shows the view generally toward south.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the right-side mirror 1 position through the motor 300, so that the right-side mirror 1 continuously provides a view generally facing south.

FIG. 7A show the situation when the automobile 100 has completed half of the right turn and it has completed about a 45 degrees clockwise turn in position 126. The right-side mirror 1 position in the absence of the micro-controller 200 is shown with dotted lines. In this position the right-side mirror 1 is showing a view facing south/west. The right-side mirror 1 position in the presence of the micro-controller 200 is shown with solid lines. In this position, the right-side mirror 1 is showing a view 254 generally facing south.

Fourth, as the automobile 100 ends the right turn, FIG. 8A, two positions of the right-side mirror 1: First, in the presence of the micro-controller 200 changes, and second in the absence of the micro-controller changes, are shown with solid and dotted lines respectively. Next the proposed embodiment quickly returns the right-side mirror 1 to its neutral position, corresponding to the position shown with dotted lines. This concludes the operations of the proposed embodiment on the right-side mirror 1 during a right turn.

In summary, referring to FIG. 2, in the absence of the DACU-2(α, side=1), 800, the right-side mirror 1 view during a right turn spans the south west corner of the intersection 10, while with the DACU-2 800, the view focuses on the traffic approaching the intersection 10 from south. The later view provides surveillance information that is highly relevant to making a safe right turn in regards to:

1) Avoiding collisions with traffic from south, especially in multi-lane intersections. Referring to the automobile 100 in FIG. 2, if there is another lane to the right of the automobile 100, then the automobile 100 becomes very vulnerable to traffic going north in that lane.
2) Avoiding collisions with a bicycle or a motorcycle following the automobile 100.
3) Giving the driver of the automobile 100 more time to concentrate on the traffic from other directions, by quickly informing the driver about the traffic from the south.

Embodiments providing a solution for A3 scenario (left-side mirror during a left turn) may employ a method similar to the solution of A2, except rotational polarities are reversed. Specifically, the left mirror 2 during a left turn will rotate to provide the driver of the field of view of the road immediately behind the vehicle. For example, a car 100 driving north making a left turn (position 122), the mirror 2 will provide the driver with a view of the south.

Embodiments providing a solution for A4 (left-side mirror during a right turn) may employ a method similar to the solution of A1, except rotational polarities are reversed. Specifically, the left mirror 2 during a right turn will rotate to provide the driver of the field of view of the road immediately to the left of the vehicle. For example, a car 100 driving north making a right turn (position 126), the mirror 2 will provide the driver with a view of the west.

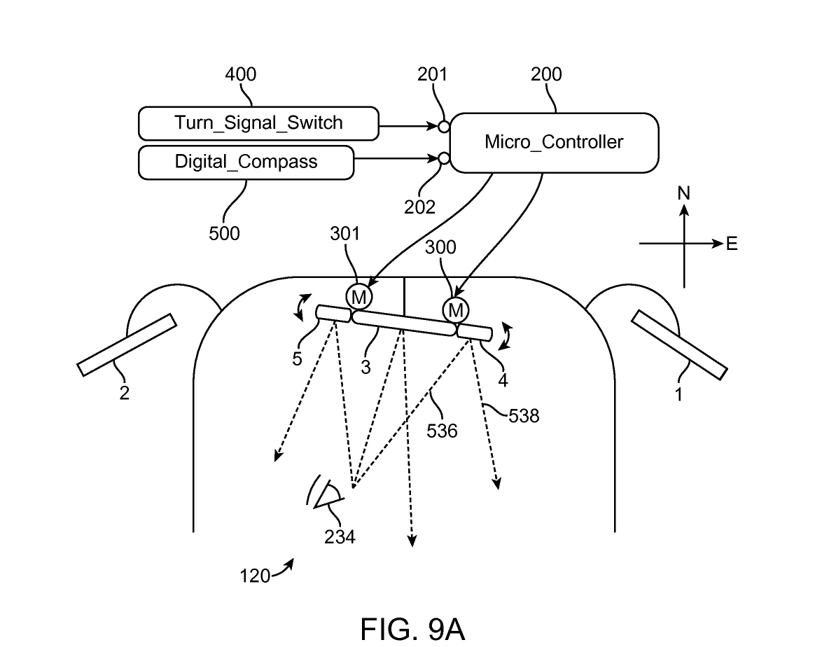

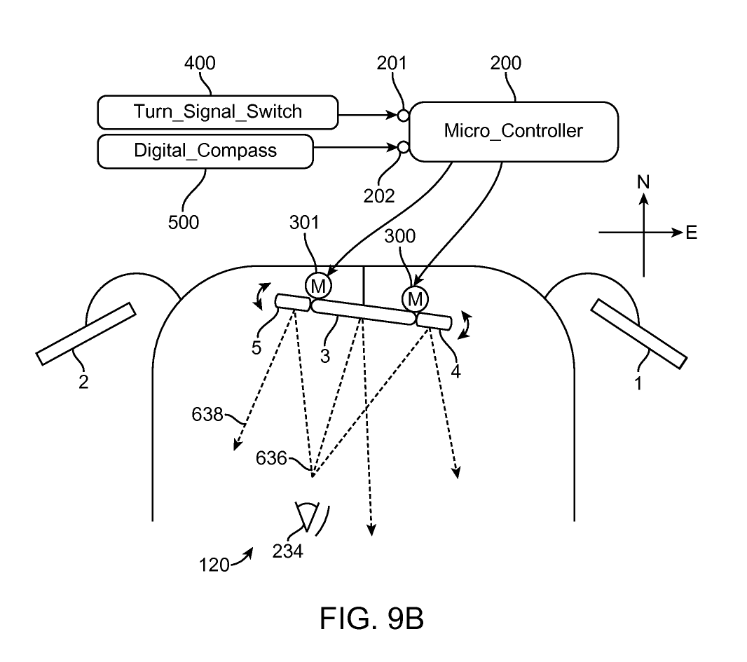

Embodiments providing solutions for A5 (rear-view mirror during a left turn), and A6 (rear-view mirror during a right turn) may employ a method as follows. Referring to FIG. 9A, the rear-view mirror 3 is augmented on the right with a mirror 4. The mirror 4 behaves as follows. On either right or left turn, first, at the start of the turn, the mirror 4 quickly rotates counter-clockwise to provide a view generally toward east. Second, during the turn, the mirror 4 dynamically adjusts its position to provide the same direction of view, toward east. The first step above is the same for the right-side mirror 1 during a left turn, except the mirror 4 incorporates this step for both right and left turns.

In another method, referring to FIG. 9B, the rear-view mirror 3 is augmented on the left with a mirror 5. The mirror 5 behaves as follows. On either right or left turn, first, at the start of the turn, the mirror 5 quickly rotates clockwise to provide a view generally toward west. Second, during the turn, the mirror 5 dynamically adjusts its position to provide the same direction of view, toward west. The first step above is the same for the left-side mirror 2 during a right turn, except the mirror 5 incorporates this step for both right and left turns.

TABLE II
List of the Major Components.

| | |
|---|---|
| 1 | right-side mirror |
| 2 | left-side mirror |
| 3 | rear-view mirror |
| 4 | mirror |
| 5 | mirror |
| 10 | intersection |
| 100 | automobile |
| 101 | automobile |
| 102 | automobile |
| 200 | micro-controller |
| 201 | I/O port |
| 202 | I/O port |
| 203 | I/O port |
| 204 | I/O port |
| 205 | I/O port |
| 206 | I/O port |
| 207 | I/O port |
| 210 | Clock |
| 220 | Interrupt |
| 250 | CPU |
| 260 | ROM |
| 270 | RAM |
| 280 | Timer |
| 290 | Counter |
| 300 | stepper-motor |
| 301 | stepper-motor |
| 310 | Controller |
| 320 | Driver |
| 330 | Buffer |
| 340 | Micro-switch |
| 350 | Micro-switch |
| 400 | Turn-signal-switch |
| 401 | Right-turn-signal |
| 402 | Left-turn-signal |
| 500 | Digital-compass |
| 600 | Odometer |
| 700 | DACU-1 |
| 710 | DACU-3-1 |
| 720 | DACU-3-2 |
| 730 | DACU-3-3 |
| 740 | DACU-3-4 |
| 750 | DACU-4 |
| 760 | DACU-5 |
| 765 | DACU-6 |
| 770 | DACU-7 |
| 780 | DACU-8 |
| 790 | DACU-9 |
| 795 | DACU-10 |
| 800 | DACU-2 |
| 1000 | circle |
| 1100 | Camera |
| 1105 | Monitor |
| 1200 | right-side mirror |
| 1201 | first right mirror |
| 1202 | second right mirror |
| 1500 | steering wheel |
| 1510 | wheel encoder |

Before describing the preferred embodiments, the major components are defined briefly for the micro-controller 200, odometer 600, turn-signal-switch 400, digital compass 500, stepper motor 300, stepper motor 301, micro-switch 340, micro-switch 350, and the automobile 100,

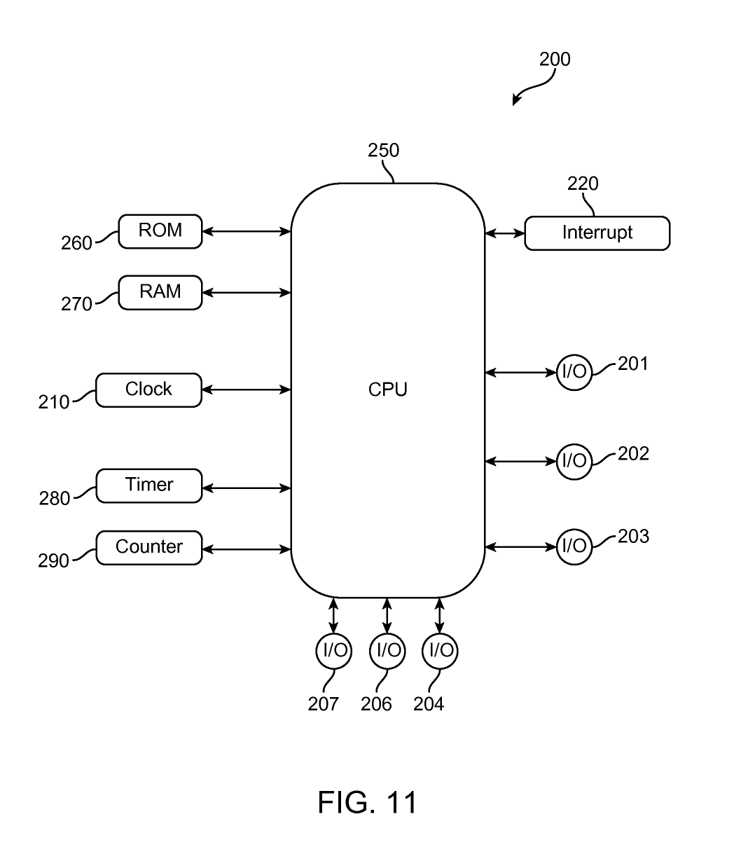

Referring to FIG. 11, the micro-controller 200, comprises a central processing unit ‘CPU’ 250, a ROM 260, a RAM 270, a clock 210, a timer 280, a counter 290, I/O port 201 (2 bits configured)(turn signal switch), I/O port 202 (10 bits configured)(digital compass), I/O port 203 (1 bit configured)(odometer), I/O port 204 (8 bits configured)(motor), I/O port 205 (8 bits configured)(motor), I/O port 206 (1 bit configured)(micro-switch), I/O port 207 (1 bit configured)(micro-switch), and an interrupt port 220.

Briefly, the CPU 250 is the brain of the microcontroller. The ROM 260 is a memory unit that stores instruction for the CPU 250 to perform. The RAM 270 is another memory unit that holds results generated during execution of the instructions by the CPU 250. The clock 210 is a circuit that generates pulses of electricity at a very specific frequency. In the embodiment 4, the frequency is 16 Mhz. The timer 280 and the counter 290 provide timing and counting functions inside the micro-controller. They can also be used for counting external pulses.

The I/O ports 201 (2 bits configured)(turn signal switch). The I/O port 202 (10 bits configured)(digital compass). The I/O port 203 (1 bit configured)(odometer). The I/O port 204 (8 bits configured)(motor). The I/O port 205 (8 bits configured)(motor). The I/O port 206 (1 bit configured)(micro-switch). The I/O port 207 (1 bit configured)(micro-switch).

The interrupt port 220 enables the microcontroller to monitor certain events in the background while executing instructions, and to react to the event, if necessary, by pausing the original instructions. This is all coordinated by the interrupt module. See “Programmable Microcontrollers with Applications MSP430 LaunchPad with CCS and Grace” by Cern Ünsalan and H. Deniz Gürhan, copyright © 2014 by McGraw-Hill Education, and “Microcontrollers and Microcomputers Principles of Software and Hardware Engineering” by Frederick M Cady, (Jun. 19, 2009), Oxford University Press, USA; 2 edition (Jun. 19, 2009)

With respect to the odometer 600, the odometer 600 provides pulses that can be used to measure speed or distance traveled. Between time t₁ and t₂, t₁<t₂, the frequency of the pulses is proportional to the average speed of the automobile 100. Therefore the number of pulses is proportional to the distance traveled by the automobile 100 from time t₁ to t₂.

With respect to the turn-signal-switch 400, the Turn-signal-switch 400 comprises a right turn switch 401 and a left turn switch 402.

Digital-compass. The digital-compass 500 measures north/south/east/west in two dimensional axes, and it produces a nb-compass bits output, c. When nb-compass=10, then c=(c9 c8 c7 c6 c5 c4 c3 c2 c1 c0), where decimal(c)=2⁹c9+2⁸c8+2⁷c7+2⁶c6+2⁵c5+2⁴c4+2³c3+2²c2+2¹c1+2⁰c0, and angle(c)=decimal(c)*360°/1024 in degrees

Without loss of generality, we measure directions as suggested in Appendix 1; east/north/west/south in angles, counter-clock-wise, with 0° pointing east.

Therefore,

$$\underline{c} = \begin{matrix}( 0 & 0 & 0 & 0 & 0 & 0 & 0 & 0 & 0 & 0 ) & indicates east direction \\ ( 0 & 1 & 0 & 0 & 0 & 0 & 0 & 0 & 0 & 0 ) & indicates north direction \\ ( 1 & 0 & 0 & 0 & 0 & 0 & 0 & 0 & 0 & 0 ) & indicates west direction \\ ( 1 & 1 & 0 & 0 & 0 & 0 & 0 & 0 & 0 & 0 ) & indicates south direction\end{matrix}$$

We assume the digital-compass 500 updates c a few times/second.

Stepper Motor. The stepper-motor 300 has two operating modes of 1) Full-stepping mode=200 steps/revolution, and 2) Half-stepping mode=400 steps/revolution.

The stepper-motor 300 has an output shaft that rotates in a series of discrete angular intervals. In this embodiment, the motor 300 is used in half-stepping mode. Therefore the motor 300 shaft has 400 discrete angular stopping positions. These positions can be represented with 9 bits (2⁹=512>400). When the stepper-motor 300 shaft is in a position p1 in {0-399}, the stepper-motor 300 shaft can be forced to move to a position p2, which is one step away from p1. p2=p1−1 mod 400 or p2=p1+1 mod 400.

The stepper-motor 300 variables comprise 1) motor-initial is one of the stepper-motor 300 shaft positions in {0-399}, and it corresponds to a predetermined position of the motor 300; 2) motor-old corresponds to the stepper-motor 300 current shaft positions in {0-399}; 3) motor-new corresponds to a shaft position (from {0-399}) of the stepper-motor 300 that is the next desired stopping position; and 4) motor-next corresponds to a shaft position (from {0-399}) of the stepper-motor 300 that is the next desired shaft position, one step away from the motor-old.

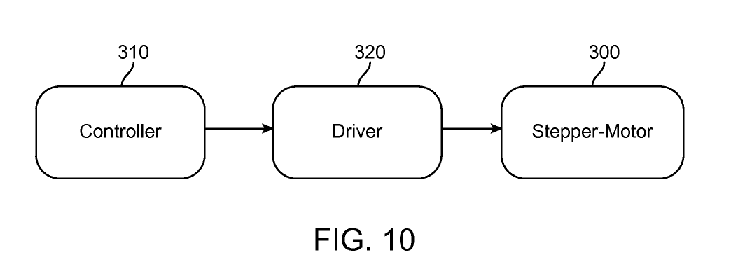

Referring to FIG. 10, a basic stepper-motor system is shown. The system comprises a controller 310, a driver 320, and the stepper-motor 300.

The controller 310 generates positions motor-initial, motor-old, motor-new, and motor-next.

And the driver 320 translates the above positions into power necessary to energize the stepper-motor 300 windings, driving the motor from its current position (motor-old) to its final position (motor-new).

In this disclosure, the micro-controller 200 performs the controller 310 functions. And the driver 320 is merged with the stepper-motor 300, except in the last embodiment. We use “stepper-motor” to refer to the stepper-motor and to the grouping of the driver and the stepper-motor interchangeably. Servo motors can be used instead of stepper motors here, especially since more and more accurate servos are becoming available at practical costs. There are bipolar and unipolar stepper motors. One or more embodiments use a bipolar motor. In one or more embodiments, the stepper-motor 301 is identical to the stepper-motor 300. See “Running small motors with PIC microcontrollers” by Harprit Singh Sandhu, McGraw-Hill Companies, Inc., 2009. “Electric Motors and Drives Fundamentals, Types and Applications”, Third edition, by Austin Hughes, Elsevier Ltd., 2006.

Micro-switch. Micro-switches 340 and 350 are small long-lasting buttons.

### Embodiment 1

Embodiment 1 provides a method for dynamically adjustable mirrors. Specifically a method for: a) The right-side mirror 1 for left turns and b) The left-side mirror 2 for right turns. At the heart of embodiment 1 is an apparatus called Dynamically Adjustable Mirror Control Unit 1, DACU-1 700.

We first describe the DACU-1 700 apparatus, and then we explain its role in embodiment 1.

Apparatus DACU-1 700 is explained in 5 sections below.

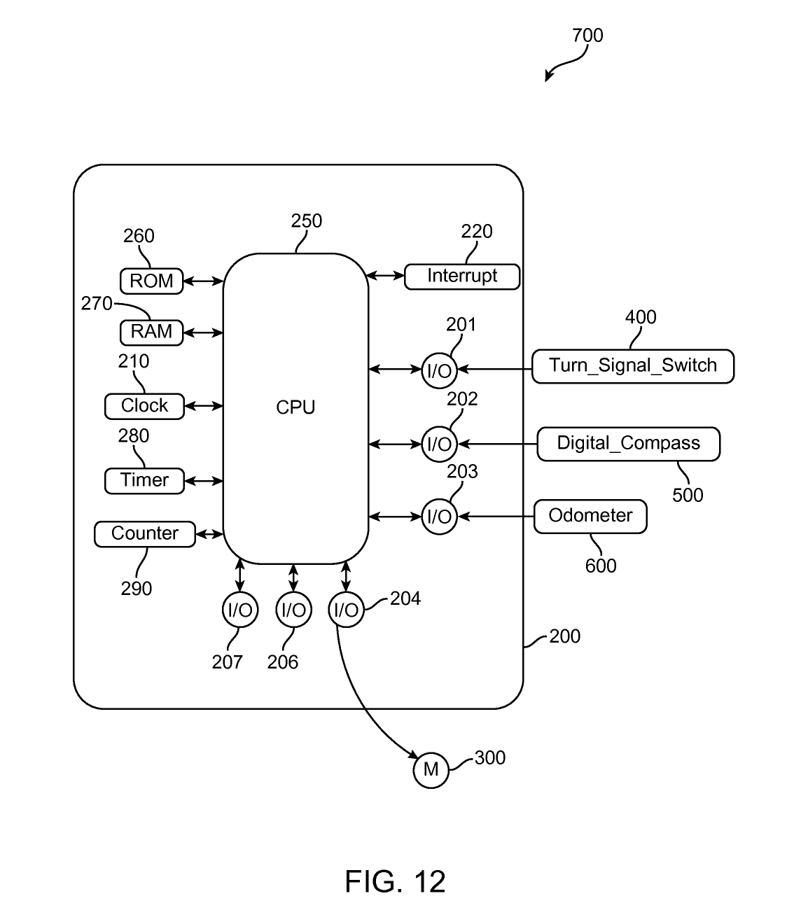

Section 1: The DACU-1 700 parameters. The DACU-1 has two parameters: a and side. The parameters are shown explicitly by DACU-1(α, side). The parameter a, (α>0) is an angle in degrees, and the parameter side is a binary number, where side=0 for the left-side mirror 2, and side=1 for the right-side mirror 1
Section 2. The DACU-1 700 hardware units. Referring to FIG. 12, the DACU-1 700 comprises: the micro-controller 200, the Turn-signal-switch 400, the digital-compass 500, the odometer 600, and the stepper-motor 300
Section 3. The connectivity of the DACU-1 700 hardware units and their internal variables. Referring to FIG. 12, a) The Turn-signal-switch 400 is connected to the I/O port 201, b) The digital-compass 500 is connected to the I/O port 202, c) The odometer 600 is connected to the I/O port 203, and d) The stepper-motor 300 is connected to the I/O port 204. More specifically, a) The Turn-signal-switch 400 communicates its setting to the CPU 250 through the two bits (pins) of the I/O port 201.

Let I/0_201.p1 to denote pin 1 of the I/O port 201, and I/0_201.p2 to denote pin 2 of the I/O port 201. Now I/0_201.p1 of the I/O port 201, is connected the right-turn-signal 401 and I/0_201.p2 of the I/O port 201, is connected the left-turn-signal 402.

The CPU 250 internal variables for the Turn-signal-switch 400 are s-o, and s-n. Parameter ‘s-n’ is the current setting, s-n=I/0_201.p2 if side=1 (the right-side mirror 1), and s-n=I/0_201.p1 if side=0 (the left-side mirror 2). And s-o is the previous setting. Parameter s-o is initialized to 0 at power on.

The digital-compass 500. The digital-compass 500 communicates its direction to the CPU 250 through the ten bits (pins) I/O port 202. Let I/0_202.p1 denote pin 1 of the I/O port 202, I/0_202.p2 denote pin 2 of the I/O port 202, . . . and I/0_202.p10 denote pin 10 of the I/O port 202.

The CPU 250 internal variables for the digital-compass 500 are c-i, c-n, and c-o. The variable c-i is the 10 bits direction (please see Appendix 1) at the start of a task or series of tasks. The variable c-n is the current 10 bits direction, and the variable c-o is the previous 10 bits direction. The variable c-o is initialized to (0 0 0 0 0 0 0 0 0 0) at power on.

The odometer 600. The odometer 600 communicates its pulses to the CPU 250 through the one pin, I/O port 203. Let I/0_203.p1 to denote one pin, the I/O port 203

The stepper-motor 300. The CPU 250 communicates driving positions to the stepper-motor 300 through the eight pin, I/O port 204. Let I/0_204.p1 denote pin 1 of the I/O port 204, and I/0_204.p2 denote pin 2 of the I/O port 204, . . . , and I/0_204.p8 denote pin 8 of the I/O port 204.

The CPU 250 internal variables for the stepper-motor 300 are motor-initial, motor-old, motor-new, and motor-next. These variables are defined above and each one is stored in 8-bits registers.

The clock 210. In this embodiment, the clock 210 has 16 MHz frequency.

The counter 290. When needed (as explained later) the CPU 250 first initializes the counter 290, then it uses it to keep a count of the odometer 600 pulses. Without loss of generality, we assume the rising edge of each pulse is counted.

The timer 280. When needed (as explained later) first the CPU 250 initializes the timer 280, then it uses the timer 280 to measure time. It does so based on the clock 210 signal.

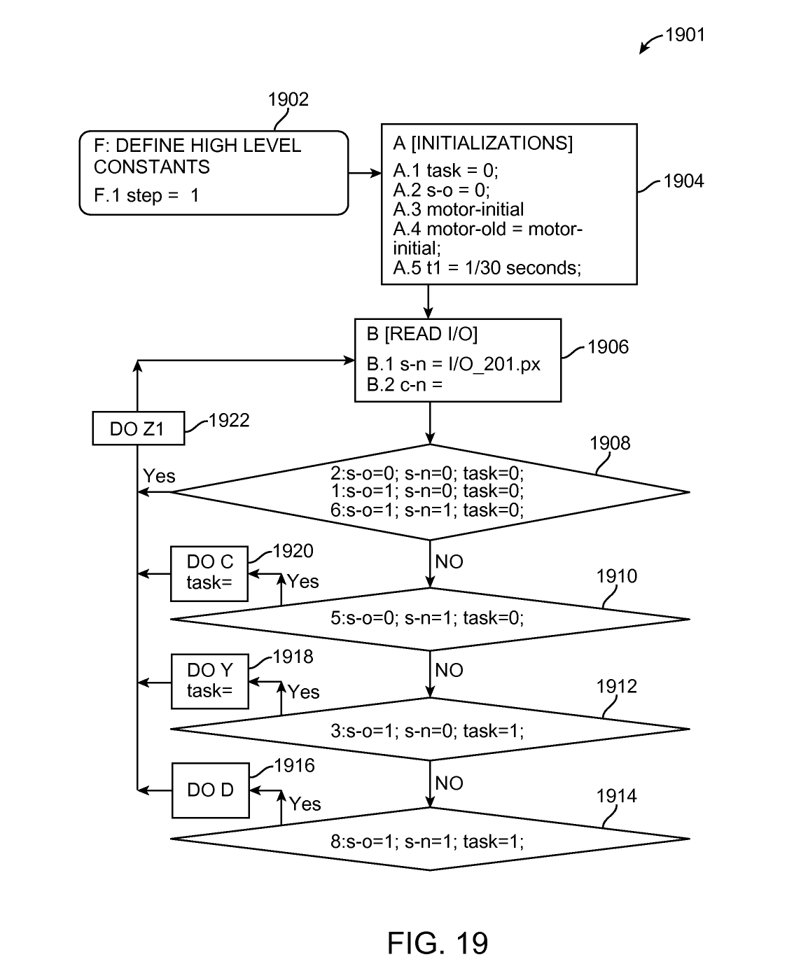

Section 4. The DACU-1 700 general function. Given an angle α, α>0, in degrees, and a side ε{0 1}, the DACU-1(α, side) 700 performs the following general tasks: [For this embodiment, a is about 45° ]. i) It detects the following event: Turn: (s-o=0) AND (s-n=1). We use CW to denote Clock-Wise rotation, and CCW to denote Counter-Clock-Wise rotation. We assign a binary 0 to CW, and a binary 1 to CCW. ii) Once an event is detected, the DACU-1 700 rotates the stepper-motor 300 shaft by a degrees in CW direction if side=0, and in CCW if side=1.
iii) Next, it monitors changes, Δd in the digital-compass 500 angular direction, and it dynamically updates the stepper-motor 300 shaft angular position by −Δd /2 (negative sign indicates the update is in the opposite direction of the digital-compass 500 change). Please see Appendix 2.
iv) There are a few terminating conditions as we will see. Once any of the terminating conditions is detected by the DACU-1 700, it returns the stepper-motor 300 shaft to motor-initial position, concluding it tasks.
Section 5. The CPU 250 instructions of the DACU-1 700. The CPU 250 instructions to perform DACU-1(α, side) tasks are stored in the ROM 260. Below, the instructions are given in a flow chart form as depicted in FIG. 19. In addition, the flow chart steps are explained in brackets. We first look at side=1 case, DACU-1(α, side=1) 700.
F [DEFINE HIGH LEVEL CONSTANTS]. [The following constants are defined on power on.].
F.1 side=1;
F.2 I/O_201.px=I/0_201.p2

### A [INITIALIZATIONS]

[The following variables are initialized on power on.]
A.1 task=0;
A.2 s-o=0;
A.3 motor-initial
A.4 motor-old=motor-initial;
A.5 t1=1/30 seconds; [t1 needs to be large enough to allow an update from digital-compass 500; in this case, digital-compass 500 update rate is 160 Hz, therefore t1 needs to be larger than 1/160 seconds.]
A.6 T1=10 seconds; [DACU-1 700 is active over the first T1 seconds of the left turn, after that it terminates its operation. To have DACU-1 700 engaged longer, we set T1 equal to a larger value.]

### B [READ I/O]

B.1 s-n=I/0_201.px
B.2 c-n=(I/O_202.p1, I/O_202.p2, I/O_202.p3, . . . I/O_202.p10)

### [BRANCHING]

If condition i, 1≦i≦8, below holds, then execute its steps.
1. {(s-o—s-n & s-n=0) & task=0}=>(switch to neutral),
steps
do Z1 (see below for Z1)
go to B
   2. {(s-o=s-n & s-n=0) & task=0}=>(continue in neutral),
steps
do Z1
go to B
   3. {(s-o≠s-n & s-n=0) & task=1}=>(switch to neutral),
steps
do Y (see below for Y)
task=0
do Z1
go to B
   4. {(s-o=s-n & s-n=0) & task=1}=>(continue in neutral),
steps
do Y
task=0
do Z1
go to B
   5. {(s-o≠s-n & s-n=1) & task=0}=>(switch to turn),
steps
do C (see below for C)
task=1
do Z1
go to B
   6. {(s-o=s-n & s-n=1) & task=0}=>(continue to turn),
steps
do Z1
go to B
   7. {(s-o≠s-n & s-n=1) & task=1}=>(switch to turn),
steps
do Y
task=0
do Z2 (see below for Z2)
go to B
   8. {(s-o=s-n & s-n=1) & task=1}=>(continue in left),
do D (see below for D)
do Z1
go to B
   Y [initialize the motor]
   Y.1 if motor-old≠motor-initial,
   Y.2 turn the stepper-motor 300 from motor-old to motor-initial position
   Y.3 motor-old=motor-initial
   Z1 [updates]
   Z1.1 s-o=s-n
   Z1.2 c-o=c-n
   Z1.3 wait t1 seconds
   Z2 [updates]
   Z2.1 s-o=0
   Z2.2 c-o=c-n
   Z2.3 wait t1 seconds

### C:

since task=0=>motor-old=motor-initial
C.1 c-i=c-n
C.2 reset and start the timer 280
C.3 reset and start the counter 290
[Calculate the number of steps the stepper-motor 300 shaft need to rotate α°. See
appendix 3.]
C.4 motor-steps=floor(α/0.9) [since α>0]
C.5 motor-direction=side
C.6 turn the stepper-motor 300 motor-steps steps in motor-direction direction
C.7 motor-new=motor-old ⊕ (motor-steps motor-direction)
[m_p⊕(m_s d) denotes the stepper-motor 300 position derived from starting at position m_p and taking m_s steps in the d direction]
C.8 motor-old=motor-new

### D

[Check terminate condition]
D.1 if the timer 280>T1; [terminate]
[Initialize the stepper-motor 300 shaft]

### D.2 do Y

D.3 task=0
D.6 else if the timer 280≦T1 [not terminate]
[generate Q1 and Q2 see Appendix 1]

### D.7 do E

Calculate number of steps for the stepper-motor 300]

[Map34(Map23(2¹⁰))=360°, please see Appendix 1, therefore Q1 corresponds to angle (Q1*360/2¹⁰) degrees. Since each step equals 0.9 degree, then Q1 corresponds to (Q1*360/2¹⁰)/0.9 steps. But recall that the stepper-motor 300 should move half of these
steps in the Q2 direction. Please see Appendix 2]
D.8 motor-steps=floor(Q1*0.1953125);
D.9 motor-direction=Q2 [Q2=0, CW] [Q2=1, CCW]
[turn the stepper-motor 300 motor-steps steps in motor-direction direction]
D.10 motor-new=motor-old⊕(motor-steps motor-direction)
D.11 motor-old=motor-new
E [generate Q1 and Q2, see appendix 1]

```
if c-n > c-o
  if c-n - c-o < 2⁹
    Case 1:
    Q1 = c-n - c-o
    Q2 = 0 [CW]
  else if c-n - c-o ≧ 2⁹
    Case 2:
    Q1 = 2¹⁰-(c-n- c-o)
    Q2 = 1 [CCW]
  end
else if c-n ≦ c-o
  if c-o − c-n < 2⁹
    Case 3:
    Q1 = c-o - c-n
    Q2 = 1 [CCW]
  else if c-o - c-n ≧ 2⁹
    Case 4:
    Q1 = 2¹⁰-(c-o - c-n)
    Q2 = 0 [CW]
  end
end
```

End of the DACU-1(α, side=1) 700 instructions.

Note: Two of the branches are never visited; they are: branch 4 and branch 7. These branches can be eliminated without affecting the performance. Below we give the flowchart depicting section 5 for side=1.

FIG. 19 presents the FLOWCHART DACU-1(α, side=1) 1901. In block 1902, high level constants are defined. Block 1904 shows the initializations. The I/O is read at block 1906.

For Z1, Y, C, D and E, please see above. There are four diamonds 1908, 1910, 1912, and 1914 in the flowchart of DACU-1(α, side=1) 700. The top diamond 1908 contains:

2:s-o=0; s-n=0; task=0;
1:s-o=1; s-n=0; task=0;
6:s-o=1; s-n=1; task=0;

This diamond implies: if (s-o=0 & s-n=0 & task=0 & side=1) (which is the condition of the second branch in section 5) OR if (s-o=1 & s-n=0 & task=0 & side=1) (which is the condition of the first branch in section 5) OR if (s-o=1 & s-n=1 & task=0 & side=1) (which is the condition of the sixth branch in section 5) is true.

The other three diamonds 1910, 1912, and 1914 are explained similarly.

The “yes” output of diamond directs the process to block 1922, the “yes” output of diamond 1910 to the block 1920, the output of the 1912 block to the block 1918, and the output of the diamond 1914 to the block 1916.

DACU-1(α, side=0) 700, is described using DACU-1(α, side=1) 700. In both the description and the flowchart of DACU-1(α, side=1) 700:

replace side=1 with side=0
replace I/O_201.px=I/O_201.p2 with I/O_201.px=I/O_201.p1

Now that DACU-1 700 is described, we explain its role in embodiment 1. Recall, embodiment 1 relates to a) the right-side mirror 1 during a left turn, and to b) the left-side mirror 2 during a right turn.

First we explain the DACU-1 700 role that relates to the right-side mirror 1 referring to FIG. 1. The stepper-motor 300 of the DACU-1 700 is connected to the right-side mirror.

The DACU-1 700 parameters are set as follows: α=45° and side=1 (the right-side mirror 1)

Imagine the automobile 100 at the intersection 10 is about to make a left turn.

At step i) (Section 4 above) the DACU-1 700 quickly detects a left turn once the Turn-signal-switch 400 is set to left turn. At step ii) (Section 4 above) the stepper-motor 300 of the DACU-1 700 rotates the right-side mirror 1 by 45° CCW. Referring to FIG. 4A, now we see a view toward east in the right-side mirror 1.

Referring to FIG. 1, let's assume the automobile 100 makes a smooth continuous left turn. At step iii) (Section 4 above) the DACU-1 700 detects small angular changes, Ad, of the automobile 100 and it dynamically updates the right-side mirror 1 position by −Δd/2. Referring to FIGS. 4A, 5A, and 6A the DACU-1 700 keeps the view of the right-side mirror 1 generally fixed toward east during the left turn.

Finally, at step iv) (Section 4 above) after reaching the terminating condition, the DACU-1 700 returns the right-side mirror 1 to its original position. A few good terminating conditions are given later.

Therefore, the DACU-1 700 moves the right-side mirror 1 into positions with key viewing angles during left turns. Furthermore, it moves the right-side mirror 1 in a way that the right-side mirror 1 produces a steady, and slow moving, viewing background during left turns. In summary, referring to FIG. 1, in the absence of the DACU-1 700, the right-side mirror 1 view during a left turn spans the south east corner of the intersection 10, while with the DACU-1 700, the view focuses on the traffic approaching the intersection 10 from east. The later view provides surveillance information that is highly relevant to making a safe left turn in at least two regards:

1) Avoiding collisions with incoming traffic from east, and
2) Giving the driver of the automobile 100 more time to concentrate on the traffic from north and the traffic from west, by quickly informing the driver about the traffic from east.

If the left turn is not smooth or continuous, having both positive and negative Ad's, then generally the DACU-1 700 will still provide a view according the properties above, since the DACU-1 700 updates are sensitive to the sign of Ad.

Nevertheless, we suggest placing a limit on the net amount of Δd that the DACU-1 700 processes. One reason is: a) Imagine the automobile 100 at the intersection 10, in the first position in FIG. 1. b) Next, imagine the left-turn-signal 402 being switched into left. c) Further, imagine the automobile 100 turning right instead of left.

Now let's take a look at what happens to the DACU-1 700. 1) It detects the left turn signal in a) above. 2) Quickly, it rotates the right-side mirror 1 45° CCW producing a view toward east. 3) As the automobile 100 is making a right turn (instead of the signaled left), the DACU-1 700 makes further angular adjustments to the right-side mirror 1 in the CCW direction. 4) The apparent size of the right-side mirror 1 view, as observed by the automobile 100 driver gets smaller and smaller going from step 1) to 2) to 3) above. This is because the right-side mirror 1 is being rotated CCW. Therefore, at some angle the view vanishes. To avoid this situation, we suggest placing a limit to the net amount of CCW adjustments to the right-side mirror 1, during a left turn. Once the limit is reached, the process of dynamically adjusting the mirror can either be aborted or halted until the net adjustment falls back within the limit.

To avoid similar pathological situations, we suggest placing such limits in the embodiments presented in this disclosure. More details on limits on rotation are given in a later embodiment.

The DACU-1 700 relates to the left-side mirror 2 in a similar way.

This time, the DACU-1 700 is connected to the left-side mirror 2 and the DACU-1 700 parameters are chosen to be α=45° and side=0. The rest of the description follows the above with directions reversed.

Briefly, on a right turn at the intersection 10 of FIG. 2, in the absence of the micro-controller 200, the left-side mirror 2 view gradually changes from facing south to facing west.

DACU-1(α, side=0) 700, quickly moves the left-side mirror 2 view facing west in the beginning of the turn. Then by making gradual changes to the left-side mirror 2 position, the proposed embodiment continuously maintains a view facing west at all times during the turn. The embodiment disengages once the turn is completed.

Specifically, FIGS. 4B, 5B, and 6B relate to three positions 120, 126, and 128 of the automobile 100, during a right turn. These positions are depicted in FIG. 2. FIG. 4B relates to the automobile 100 position 120 at the start of the right turn. The left-side mirror 2 oriented as shown enables the driver 234 to view the field of vision 441 via the field of vision 436 of mirror 2. FIG. 5B relates to the automobile 100 position 126 during the right turn. The left-side mirror 2 oriented as shown enables the driver 234 to view the field of vision 447 via the field of vision 436 of the left-side mirror 2. FIG. 6B relates to the automobile 100 position at the end of the right turn 128. The left-side mirror 2 oriented as shown enables the driver 234 to view the field of vision 450 via the field of vision 436 of mirror 2.

On a right turn, the micro-controller 200 performs the following tasks with respect to the left-side mirror 2.

First, a right turn is detected based on the turn signal switch 400 signal through the port 200.

Second, the left-side mirror 2 position is depicted with dotted lines in FIG. 4B. In this position, the left-side mirror 2 shows a view of the field of vision 238, this is generally toward south. Once a right turn is detected, the micro-controller 200 quickly rotates the left-side mirror 2 by about 45 degrees clockwise with respect to FIG. 4B top view reference. The micro-controller 200 uses the electric motor 300 to move the left-side mirror 2. After this rotation, the view of the left-side mirror 2 rotates about 90 degrees in clockwise direction, facing generally west. The left-side mirror 2 position after the rotation is depicted with solid lines in FIG. 4B.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the left-side mirror 2 position through the motor 300, so that the left-side mirror 2 continuously provides a view facing generally west. FIG. 5B shows the situation when the automobile 100 has completed half the turn. The left-side mirror 2 position in the absence of the micro-controller 200 is shown with dotted lines. In this position the left-side mirror 2 is showing a view of the field of vision 438, this is generally facing south/west. The left-side mirror 2 position in the presence of the micro-controller 200 is shown with solid lines. In this position, the left-side mirror 2 is showing a view of the field of vision 447, this is facing generally west.

Fourth, as the automobile 100 ends the right turn, FIG. 6B, two positions of the left-side mirror 2: 1) in the presence of the micro-controller 200 changes, and 2) in the absence of the micro-controller changes, coincide. This concludes the micro-controller 200 operations during a right turn.

In summary, referring to FIG. 2, in the absence of the DACU-1 700, the left-side mirror 2 views during a right turn spans the south west corner of the intersection 10, while with the DACU-1 700, the view focuses on the traffic approaching the intersection 10 from west. The later view provides surveillance information that is highly relevant to making a safe right turn in at least two regards:

1) Avoiding collisions with incoming traffic from west, and
2) Giving the driver of the automobile 100 more time to concentrate on the traffic from north and the traffic from east, by quickly informing the driver about the traffic from west.

### Embodiment 2

Our Embodiment 2 provides a method for dynamically adjustable mirrors. Specifically a method for: a) the right-side mirror 1 for a right turn and b) the left-side mirror 2 for a left turn. At the heart of embodiment 2 is an apparatus called Dynamically Adjustable Mirror Control Unit 2, DACU-2 800 in one or more embodiments. First we describe the DACU-2 800 apparatus, and then we explain its role in embodiment 2. The apparatus DACU-2 800 is explained in 5 sections below.

Section 1: The DACU-2 800 parameters. The DACU-2 800 has two parameters: a and side. The parameters are identical to DACU-1 700 parameters.
Section 2: The DACU-2 800 hardware units. The DACU-2 800 has the same hardware units as the DACU-1 700.
Section 3: The connectivity of the DACU-2 800 hardware units and their internal variables. The DACU-2 800 has the same hardware connectivity as the DACU-1 700.
Section 4: The DACU-2 800 general function.

Given an angle α, α>0, in degrees, and a side ε{0 1}, the DACU-2(α, side) 800 performs the following general tasks. i) It detects the following events: Turn: (s-o=0) AND (s-n=1), and ii). Once the event is detected, the DACU-2 800 monitors changes, Ad, in the digital-compass 500 angular direction, and it dynamically updates the stepper-motor 300 shaft angular position by −Δd/2.

iii) There are a few terminating conditions as we will see, once any of the terminating conditions are detected by DACU-2 800, it returns the stepper-motor 300 shaft to motor-initial position, concluding its tasks.
Section 5: The CPU 250 instructions of the DACU-2 800. The CPU 250 instructions to perform the DACU-2(α, side) 800 tasks are stored in the ROM 260.

The instructions for the DACU-2(α, side=1) 800, are the same as the instructions for the DACU-1(α, side=1) 700, except 1) Replace F.2 I/O_201.px=I/O_201.p2 by F.2 I/O_201.px=I/O_201.p1, and 2) Use an instruction list F below instead of the instruction list C.

Also the instructions for the DACU-2(α, side=0) 800, are the same as the instructions for the DACU-1(α, side=0) 700, except

1) Replace F.2 I/O_201.px=I/O_201.p1 by F.2 I/O_201.px=I/O_201.p2, and
2) Use an instruction list F below instead of the instruction list C.

### F:

since task=0=>motor-old=motor-initial
F.1 c-i=c-n
F.2 reset and start the timer 280
F.3 reset and start the counter 290

Now that the DACU-2 800 is described, we explain its role in embodiment 2. First, we explain the DACU-2 800 role that relates to the right-side mirror 1, referring to FIG. 2. The stepper-motor 300 of the DACU-2 800 is connected to the right-side mirror 1.

The DACU-2 800 parameters are set as follows: α=45° and side=1 (the right-side mirror 1)

Imagine the automobile 100 at the intersection 10 is about to make a right turn. At step i) (Section 4 above) the DACU-2 800 detects a right turn.

Referring to FIG. 2, let's assume the automobile 100 makes a smooth continues right turn. At step ii) (Section 4 above) the DACU-2 800 detects small angular changes, Δd, of the automobile 100 and it dynamically updates the right-side mirror 1 position by −Δd/2. Referring to FIGS. 3A, 7A, and 8A the DACU-2 800 keeps the view of the right-side mirror 1 generally fixed toward south during the right turn.

Finally, at step iii) (Section 4 above) after reaching the terminating condition, the DACU-2 800 returns the right-side mirror 1 to its original position. Again, a few good terminating conditions are given later.

Therefore, the DACU-2 800 moves the right-side mirror 1 into positions with key viewing angles during right turns. Furthermore, it moves the right-side mirror 1 in a way that the right-side mirror 1 produces steady, slow moving, viewing background during right turns.

In summary, referring to FIG. 2, in the absence of the DACU-2 800, the right-side mirror 1 view during a right turn spans the south west corner of the intersection 10, while with the DACU-2 800, the view focuses on the traffic approaching the intersection 10 from south. The later view provides surveillance information that is highly relevant to making a safe right turn in regards to:

1) Avoiding collisions with traffic from south, especially in multi-lane intersections. Referring to the automobile 100 in FIG. 2, if there is another lane to the right of the automobile 100, then the automobile 100 becomes very vulnerable to traffic going north in that lane.
2) Avoiding collisions with a bicycle or a motorcycle following the automobile 100.
3) Giving the driver of the automobile 100 more time to concentrate on the traffic from other directions, by quickly informing the driver about the traffic from the south.

If the right turn is not smooth or continuous, having both positive and negative Ad's, then generally the DACU-2 800 still will provide a view according to the properties above, since the DACU-2 800 updates are sensitive to the sign of Ad. Again we suggest limiting the net Ad, as before.

The DACU-2 800 relates to the left-side mirror 2 in a similar way. This time, the DACU-2 800 is connected to the left-side mirror 2 and the DACU-2 800 parameters are chosen to be α=45° and side=0. The rest of the description follows the above with directions reversed.

Briefly, on a left turn at the intersection 10 of FIG. 1, in the absence of the micro-controller 200, the view of the left-side mirror 2 gradually changes from facing south to facing east.

By making gradual changes to the left-side mirror 2 positions, the DACU-2(α, side=0) 800 maintains the view of the left-side mirror 2 facing generally south at all times during the left turn. Then at the end of the left turn, the embodiment will quickly move the left-side mirror 2 to its neutral position—the position the left-side mirror 2 would have had in the absence of the micro-controller 200. At the end of the turn, in the neutral position, the view of the left-side mirror 2 is generally toward east.

Specifically, FIGS. 3B, 7B, and 8B relate to the automobile 100, three positions 120, 122, and 124 during a left turn. These positions were depicted in FIG. 1. FIG. 3B relates to the automobile 100 position 120 at the start of the left turn. The left-side mirror 2 oriented as shown enables the driver 234 to view the field of vision 438 via the field of vision 436 of the left-side mirror 2. FIG. 7B relates to the automobile 100 position during the left turn. The left-side mirror 2 oriented as shown enables the driver 234 to view the field of vision 454 via the field of vision 436 of the left-side mirror 2. FIG. 8B relates to the automobile 100 position at the end of the left turn. The left-side mirror 2 oriented as shown enables the driver 234 to view the field of vision 456 via the field of vision 436 of the left-side mirror 2.

On a left turn, the microcontroller 200 performs the following tasks with respect to the left-side mirror 2.

First, a left turn is detected based on the turn signal switch 400 signal through the port 201.

Second, the left-side mirror 2 position is depicted with solid lines in FIG. 3B. At this position, the left-side mirror 2 shows the view generally toward south.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the left-side mirror 2 position through the motor 300, so that the left-side mirror 2 continuously provides a view generally facing south. FIG. 7B shows the situation when the automobile 100 has completed half of the left turn and it has completed about a 45 degrees counter-clockwise turn in position 122. The left-side mirror 2 position in the absence of the micro-controller 200 is shown with dotted lines. In this position the left-side mirror 2 is showing a view facing south/east. The left-side mirror 2 position in the presence of the micro-controller 200 is shown with solid lines. In this position, the left-side mirror 2 is showing a view generally facing south.

Fourth, as the automobile 100 ends the left turn, FIG. 8B, two positions of the left-side mirror 2: First, in the presence of the micro-controller 200 changes, and second in the absence of the micro-controller changes, are shown with solid and dotted lines respectively. Next the proposed embodiment quickly returns the left-side mirror 2 to its neutral position, corresponding to the position shown with dotted lines. This concludes the operations of the proposed embodiment on the left-side mirror 2 during a left turn.

In summary, referring to FIG. 1, in the absence of the DACU-2(α, side=0), 800, the left-side mirror 2 view during a left turn spans the south east corner of the intersection 10, while with the DACU-2 800, the view focuses on the traffic approaching the intersection 10 from south. The later view provides surveillance information that is highly relevant to making a safe left turn in regards to:

1) Avoiding collisions with traffic from south, especially in multi-lane intersections. Referring to the automobile 100 in FIG. 1, if there is another lane to the left of the automobile 100, then the automobile 100 becomes very vulnerable to traffic going north in that lane.
2) Avoiding collisions with a bicycle or a motorcycle following the automobile 100.
3) Giving the driver of the automobile 100 more time to concentrate on the traffic from other directions, by quickly informing the driver about the traffic from the south.

Although parameter a played no role in this embodiment, as we will see later, it does play a role in another version of the embodiment 2 where it is used to flag termination in D.

Note: The stepper-motor 300 shaft is updated by floor(Q1*0.1953125) steps in the direction of Q2 in section 4 of both the DACU-1 700 and the DACU-2 800. To reduce errors due to the use of floor function, we suggest a second method to the computation of the updates.

Imagine a person going shopping at the same store every day, and the purchases are $P1 $P2 $P3 . . . for days 1 2 3 . . . . Now suppose the person can only carry paper money and after each purchase you must throw away all the change you receive. However to be somewhat fair, the clerk must give you no more than 99c in change. After N days, there is the possibility that you have thrown away and lost almost $N.

Now suppose instead of throwing away the change the person makes a deal with the store clerk so that in return for you shopping there every day he would keep the change for you and he would use it toward your next day purchase. And he would repeat the same favor the next day. This time after N days, the persons loss is not more than 99c!

With respect to errors in updating, our embodiments DACU-1 700 and the DACU-2 800 are similar to the first shopping arrangement. Next we propose a version of them that would behave like the second shopping arrangement.

For DACU-1 700, and DACU-2 800, the second method to the computation of the updates is achieved after the following five modifications:

1) There is no need to update c-o=c-n in Z1 and Z2.
2) For DACU-1 700, in C, after line C.8, two new lines C.91 and C.92 are added as follows.
C.8 motor-old=motor-new

### C.91 H1_old=0

### C.92 Q2_old=0

For DACU-2 800, in F, after line F.3, two new lines F.4 and F.5 are added as follows.

F.3 reset and start the counter 290

### F.4 H1_old=0

### F.5 Q2_old=0

3) In D, lines D.8 and D.9 are replaced by the following lines.
H1=floor(Q1*0.1953125);
if Q2=(Q2-old) AND H1 (H1-old),
then motor-steps=H1−(H1-old) and
motor-direction=Q2
   if Q2=(Q2-old) AND H1<(H1-old),
then motor-steps=(H1_old)−H1 and
motor-direction=opposite of Q2
   if Q2≠(Q2-old),
then motor-steps=H1+(H1-old) and
motor-direction=Q2
   4) In D, after line D.11, two new lines D.11.1 and D.11.2 are added as follows.
   . . . . . . .
   D.11 motor-old=motor-new;

### D.11.1 H1_old=H1;

### D.11.2 Q2_old=Q2;

5) In E, c-i replaces c-o.

Below are the instruction lists C, F, D and E according to the second update rule.

C: According to the second update rule
[since task=0=>motor-old=motor-initial]
C.1 c-i=c-n
C.2 reset and start the timer 280
C.3 reset and start the counter 290
[Calculate the number of steps the stepper-motor 300 shaft need to rotate α°. See appendix 3.]
C.4 motor-steps=floor(α/0.9) [since α>0]
C.5 motor-direction=side
C.6 turn the stepper-motor 300 motor-steps steps in motor-direction direction
C.7 motor-new=motor-old ⊕(motor-steps motor-direction)
C.8 motor-old=motor-new

### C.91 H1_old=0

### C.92 Q2_old=0

F: According to the second update rule
since task=0=>motor-old=motor-initial
F.1 c-i=c-n
F.2 reset and start the timer 280
F.3 reset and start the counter 290

### F.4 H1_old=0

### F.5 Q2_old=0

D: According to the second update rule
[Check terminate condition]
D.1 if the timer 280>T1; [terminate]
[Initialize the stepper-motor 300 shaft]
D.2 DO Y
D.3 task=0
   D.6 else if the timer 280≦T1 [not terminate]
   [generate Q1 and Q2 see Appendix 1]

### D.7 DOE

[Calculate number of steps for the stepper-motor 300]
[Map34(Map23(2¹⁰))=360°, please see Appendix 1, therefore Q1 corresponds to angle (Q1*360/2¹⁰) degrees. Since each step equals 0.9 degree, then Q1 corresponds to (Q1*360/2¹⁰)/0.9 steps. But recall that the stepper-motor 300 should move half of these steps in the Q2 direction. Please see Appendix 2]
H1=floor(Q1*0.1953125);

### if Q2=(Q2_old) AND H1≧(H1_old),

then motor-steps=H1−(H1_old) and
   motor-direction=Q2

### if Q2=(Q2_old) AND H1<(H1_old),

then motor-steps=(H1_old)−H1 and
   motor-direction=opposite of Q2

### if Q2≠(Q2_old),

then motor-steps=H1+(H1_old) and
motor-direction=Q2
   [turn the stepper-motor 300 motor-steps steps in motor-direction direction]
D.10 motor-new=motor-old⊕(motor-steps motor-direction)
D.11 motor-old=motor-new
D.11.1 H1_old=H1;
D.11.2 Q2_old=Q2;
   E: According to the second update rule [generate Q1 and Q2, see appendix 1]

```
if c-n > c-i
  if c-n - c-i < 2⁹
    Case 1:
    Q1 = c-n - c-i
    Q2 = 0 [CW]
  else if c-n - c-i ≧ 2⁹
    Case 2:
    Q1 = 2¹⁰-(c-n - c-i)
    Q2 = 1 [CCW]
  end
else if c-n ≦ c-i
  if c-i − c-n < 2⁹
    Case 3:
    Q1 = c-i - c-n
    Q2 = 1 [CCW]
  else if c-i - c-n ≧ 2⁹
    Case 4:
    Q1 = 2¹⁰-(c-i - c-n)
    Q2 = 0 [CW]
  end
end
```

Finally, in the instruction list Z according to the second update rule, c-o update is not needed.

### Embodiment 3

This embodiment offers four variations to the embodiment 1. These variations all have the same hardware and hardware connections as embodiment 1;

only the CPU 250 instructions are different. To explain the main differences, let's focus on the view in the right-side mirror 1 during a left turn, referring to FIG. 1 and Table 1 below:

1) At the absence of the DACU-1 700, first, the view is toward south, then as the automobile 100 makes the turn the view rotates 90° CCW. The final view of the right-side mirror 1 is toward east.
2) With the DACU-1 700, first the view is toward south; once a left turn is detected, the view quickly changes toward east. In general this happens when the automobile 100 is still at position 1, facing north. Then while the automobile 100 is making the left turn, the view generally remains toward east. The final view is toward east too.
3) The version 1 of embodiment 3 introduces a Dynamically Adjustable Mirror Control Unit 3-1, DACU-3-1 710. With the DACU-3-1 710, first the view is toward south, next the view rotates by β° (β=5 for example) as the result of β° rotation of the automobile 100 during the left turn. Then the view quickly changes toward east by the DACU-3-1 710. Then while the automobile is completing its left turn, the view generally remains toward east. The final view is toward east too.
4) The version 2 of embodiment 3 introduces a Dynamically Adjustable Mirror Control Unit 3-2, DACU-3-2 720. With the DACU-3-2 720, first the view is toward south; once a left turn is detected, the view quickly changes toward S_{—}2α°E (from south rotate α° counter-clock-wise toward east, 2α<90). Therefore, the view is not quite toward east. It is at −(90−2α)° direction (east is 0°).

Next the view moves from S_{—}2α°E to E, as the automobile is making the first stage of its left turn, making the first β° CCW rotation ((3=90−2a). Then the DACU-3-2 720 keeps the view in the general east direction as the automobile 100 is completing its left turn.

5) The version 3 of embodiment 3 introduces a Dynamically Adjustable Mirror Control Unit 3-3, DACU-3-3 730. With the DACU-3-3 730, first the view is toward south; once a left turn is detected, the view quickly changes toward S_{—}2α°E, 2α>90, equivalently (E_β° N, β=2α−90<90). Next the view moves from S_{—}2α°E (equivalently E_β° N) to E, as the automobile is making the first stage of its left turn, making the first β° CCW rotation.

Then the DACU-3-3 730 keeps the view in general east direction as the automobile 100 is completing its left turn.

6) The version 4 of embodiment 3 introduces a Dynamically Adjustable Mirror Control Unit 3-4, DACU-3-4 740. With the DACU-3-4 740, first the view is toward south; once a left turn is detected, the view quickly changes toward east (E).

Next the view moves from E to E_(β°/2)N as the automobile is making the first stage of its left turn, making the first β/2 CCW rotation. Then the DACU-3-4 740 moves the view from E_(β°/2)N back to E. Finally, the DACU-3-4 740 keeps the view in general east direction as the automobile 100 is completing its left turn.

The views in 2)-6) above differ while the automobile 100 is in the beginning stage of the left turn, making the initial (3° of the turn.

| | | | | DACU- | DACU- | DACU- |
|---|---|---|---|---|---|---|
| Automobile | | | DACU- | 3-2 | 3-3 | 3-4 |
| 100 location | Normal | DACU-1 | 3-1 | 2α < 90 | 2α > 90 | 2α = 90 |
| At the | S | S to | S | S | S | S |
| intersection | | quickly | | to | to | to |
| 10 facing | | E | | quickly | quickly | quickly |
| north | | | | S_2α°E | S_2α°E | E |
| At the first | S | E | S | S_2α°E | S_2α°E | E |
| stage of the | to | | to | to | to | to |
| turn making | S_β°E | | S_β°E | E | E | E_(β°/ |
| 0° to β° | | | | | | 2)N to |
| | | | | | | E |
| At the second | S_β°E | E | quickly | E | E | E |
| stage of the | to | | to E | | | |
| turn making | E | | stay | | | |
| β° to 90° | | | E | | | |
| At the end of | E | E | E | E | E | E |
| the turn | | | | | | |
| facing west | | | | | | |

Table II: Referring to FIG. 1, Left Turn
S = south;
E = east
S_2α°E = from south to 2α° (CCW) east
S_β°E = from south to β° (CCW) east

Below the four new versions are explained in more detail:

DACU-3-1 710: Note that with DACU-1 700, if the left signal is applied early when the automobile 100 is yet far from the intersection 10, then the view in the right-side mirror 1 rotates 90 degrees prematurely. To alleviate this problem, DACU-3-1 710 delays the initial a rotation of the right-side mirror 1 until the automobile 100 is at the proximity of the intersection 10 and has already made its initial β degree rotation.

DACU-3-2 720: Referring to FIG. 1, to increase surveillance of pedestrians crossing the intersection 10 from the south east corner of the intersection 10 to the south west corner of the intersection 10 also pedestrians crossing the intersection 10 from the south east corner of the intersection 10 to the north east corner of the intersection 10, DACU-3-2 720 keeps the lower left corner of the intersection 10 in the view of the right-side mirror 1 longer.

DACU-3-3 730: This version initially rotates the right-side mirror 1 such that the view instead of south is S_{—}2α°E (2α>90). In other words, the view is at the direction E_(90−2α)° N. This direction is toward traffic reaching the intersection 10 from east. Therefore, DACU-3-3 730 keeps the traffic coming from east in the view of the right-side mirror 1 longer.

DACU-3-4 740: While DACU-3-2 720 emphasizes surveillance for pedestrians, and DACU-3-3 730 emphasizes surveillance for the traffic from east direction, the last version, DACU-3-4 740, tries to balance the two. The right-side mirror 1 view goes through the following changes by DACU-3-4 740:
1) from initial south quickly rotated to east
2) gradually moving from east to E_(δ°/2)N as the automobile 100 is making its initial δ°/2 left turn
3) gradually moving back toward east as the automobile 100 is making its next β°/2 left turn
4) staying east as the automobile 100 completes the turn

Now the view in 2) above enables more surveillance for pedestrians crossing the intersection 10 from south east corner to north east corner. And the views in 2) (the portion that passes from eastward toward east/north) and 3) together enables more surveillance for traffic reaching the intersection 10 from east.

Next the CPU 250 instructions are given for the versions 1-4 of embodiment 3.

Below are the instructions of the CPU 250 for the DACU-3-1 710, according to the second update method. The DACU-3-1 (α, side) 710 tasks are stored in the ROM 260. Parameters are as before, except a, 45>α>0, and β=90−2*α.

Below, the instructions are given in a flow chart form. In addition, the flow chart steps are explained in brackets. We first look at side=1 case, DACU-3-1 (α, side=1) 710.

### F: [DEFINE HIGH LEVEL CONSTANTS]

[This is the same as for DACU-1(α, side=1) 700.]

### A: [INITIALIZATIONS]

[This is the same as for DACU-1(α, side=1) 700, except here there is one additional line.]
A.7 flag=0

### B: [READ I/O]

[This is the same as for DACU-1(α, side=1) 700.]

### [BRANCHING]

If condition k, 13, below holds, then execute its steps.
k=1. flag=0=>
if s-o=0 & s-n=1 then
flag=1
reset and start the timer 280
c-i=c-n
end
s-o=s-n;

### go to B

k=2. flag=1=>
if s-n=0 or timer 280>timer_{—}0 [predetermined time]
stop timer 280
flag=0
s-o=s-n;

### go to B

end
do E [generate Q1 and Q2][Q2=0, CW][Q2=1,CCW]

### H1=Q1*0.3515

### if H1>β,

flag=2
c-i=c-n
stop timer 280

### do C

task=1;
end
s-o=s-n;

### go to B

k=3. flag=2=>If condition 1≦i≦2, below holds, then execute its steps.
1. {(s-o≠s-n & s-n=0) & task=1}=>(switch to neutral),
steps
do Y (see below for Y)
task=0
flag=0

### do Z1

### go to B

2. {(s-o=s-n & s-n=1) & task=1}=>(continue the turn),
do D (see below for D)

### do Z1

### go to B

Y: [initialize the motor]
[This is the same as for DACU-1(α, side=1) 700.]
Z1 [updates]
Z1.1 s-o=s-n
Z1.2 wait t1 seconds
C: According to the second update rule
[This is the same as for DACU-1(α, side=1) 700.]
D: According to the second update rule
[This is the same as for DACU-1(α, side=1) 700, except here there is one additional line, D.31 after line D.3.]
D.3 task=0
D.31 flag=0
E: According to the second update rule
[This is the same as for DACU-1(α, side=1) 700.]
End of the DACU-3-1 (α, side=1) 710 instructions.
Below, DACU-3-1 (α, side=0) 710, is described using DACU-3-1 (α, side=1) 710. In the description of DACU-3-1 (α, side=1) 710:
replace side=1, with side=0
replace I/O_201.px=I/O_201.p2 with I/O_201.px=I/O_201.p1

This concludes the DACU-3-1 710 instructions according to the second update method.

Below are the instructions of the CPU 250 for the DACU-3-2 720, according to the second update method.

The DACU-3-2 (α, side) 720 tasks are stored in the ROM 260.

Parameters are as before, except a, 45>α>0, and β=90−2*α.

The instructions for DACU-3-2 (α, side) 720 are very similar to the instructions of embodiment 1 according to the second update method; the only difference is in D. To obtain D for DACU-3-2 (α, side) 720, immediately after the line:

“then motor-steps=H1+(H1_old) and motor-direction=Q2”
we add three lines:

### AQ1=Q1*360/2¹⁰

### AQ1=AQ1−β

if AQ1<0, then motor-steps=0

Below are the instructions of the CPU 250 for the DACU-3-3 730, according to the second update method.

The DACU-3-3(α, side) 730 tasks are stored in the ROM 260.

Parameters are as before, except a, 90>α≧45, and β=2*α−90.

The instructions for DACU-3-3(α, side) 730 are very similar to the instructions of embodiment 1 according to the second update method; the only difference is in D. To obtain D for DACU-3-3(α, side) 730, immediately after the line:

“then motor-steps=H1+(H1_old) and motor-direction=Q2”
we add the three lines:

### AQ1=Q1*360/2¹⁰

### AQ1=AQ1−β

if AQ1<0, then motor-steps=2*motor-steps

Below are the instructions of the CPU 250 for the DACU-3-4 740, according to the second update method.

The DACU-3-4(α, side) 740 tasks are stored in the ROM 260.

Parameters α (α=45) and γ (γ is small, example γ=10), are angles in degrees, and side ε{0 1}, is as before.

The instructions for DACU-3-4(α, side) 740 are very similar to the instructions of embodiment 1 according to the second update method; the only difference is in their D. To obtain D for DACU-3-4(α, side) 740, immediately after the line:

“then motor-steps=H1+(H1_old) and motor-direction=Q2”
we add the three lines:

### AQ1=Q1*360/2¹⁰

if 0≦AQ1<γ, then motor-steps=0
if γ≦AQ1<2γ, then motor-steps=2*motor-steps

### Embodiment 4

Embodiment 4 relates to dynamically adjustable mirrors that are rotationally constrained between two angles, α1 and α2.

Referring to DACU-1 700, embodiment 4 ignores some angular adjustments to the right-side mirror 1 whenever it finds them not useful:

1) Any angular adjustment that situates the right-side mirror 1 facing away from the driver of the automobile 100 is considered not useful in this embodiment.
2) Any angular adjustment that situates the right-side mirror 1 showing mostly the automobile 100 is considered not useful to this embodiment.

The embodiment 4 introduces a Dynamically Adjustable Mirror Control Unit 4, DACU-4 750 that while performing similar to DACU-1 700, it limits the angular positions to a range [α1α2].

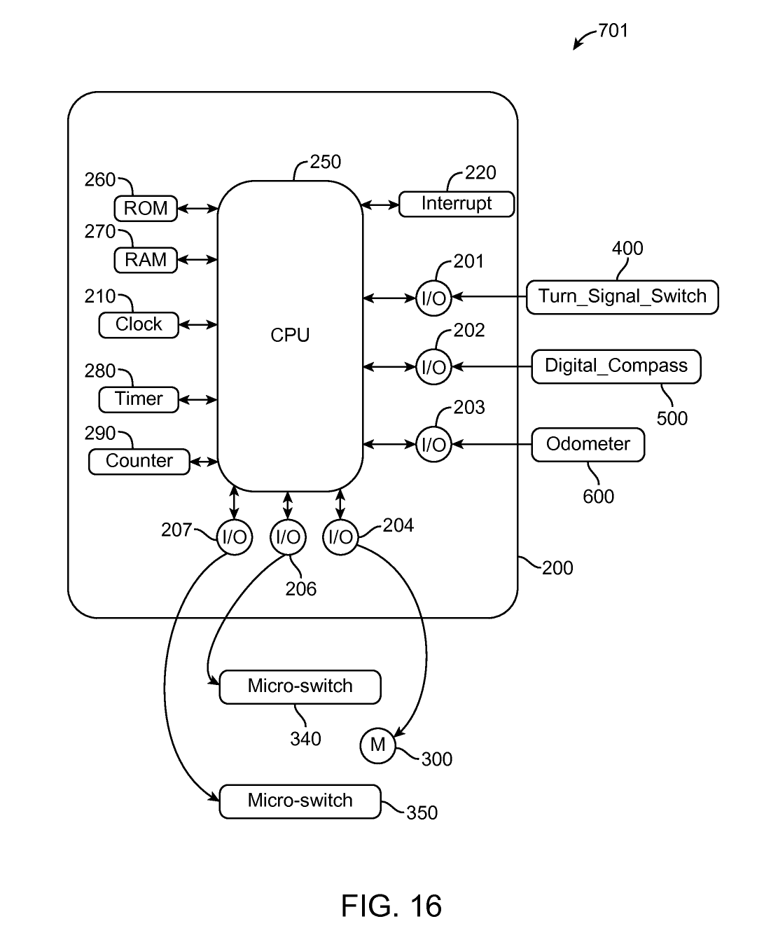

Referring to FIG. 16, two elements, the micro-switch 340 and the micro-switch 350 are added to the hardware of the embodiment 1 to comprise the hardware of DACU-4 750 of the embodiment 4 for the right-side mirror 1.

The micro-switch 340 is connected to the I/O port 206 of the micro-controller 200. And the micro-switch 350 is connected to the I/O port 207 of the micro-controller 200.

With respect to the stepper-motor 300, the micro-switch 340 is placed such that the stepper-motor 300 turns on the micro-switch 340 when the angle of the right-side mirror 1, τ, is reduced to α1. Similarly, the micro-switch 350 is placed such that the stepper-motor 300 turns on the micro-switch 350 when τ is increased to α2. For all angles α1<τ<α2, both of the micro-switches 340 and 350 are in their off position.

Let us digress to note that in this embodiment, we will use the micro-switch 340 to accomplish two different tasks:

A) To mark angle α1 for limiting from below the rotations of the right-side mirror 1, and
B) To guide the initialization of the stepper-motor 300 to its initial position.

On B) above:

In general, stepper motors do not have a fixed position for initialization. In our application, it is important to have the position of the stepper-motor 300 (and consequently the mirrors) initialized prior to use of any of the DACU units.

An initialization method that does not work here is the following.

Method: Just keep track of where the stepper-motor 300 position is with the micro-controller 200, then move the stepper-motor 300 back to its original position at the end of every use.

The reason this method does not work here is that often the stepper-motor 300 skips a step and the information on the skipped steps are not available to the micro-controller 200.

In practice, designers do one of the following:

1) Use a micro-switch to mark the initial position of the stepper-motor 300.
2) Use an absolute encoder that keeps track of every step in the motor. These are expensive in general.
3) Use proximity sensors to mark the initial position of the motor. In general, these are less accurate than micro-switches.

Both usages of the micro-switch 340 will become more apparent below.

Next we describe the DACU-4 750 apparatus.

As before, we explain apparatus DACU-4 750 in 5 sections.

Section 1: The DACU-4 750 parameters. The DACU-4 750 has four parameters: α1α<α2 and side. The parameters are shown explicitly by DACU-4(α1, α, α2, side). The parameters α1, α, α2 are nonnegative angles in degrees, and the parameter side is defined as before.
Section 2: The DACU-4 750 hardware units

The DACU-4 750 hardware units are already described above.

Section 3: The connectivity of the DACU-4 750 hardware units and their internal variables

The DACU-4 750 hardware connectivity is already described above.

Section 4: The DACU-4 750 general function

Given angles α1, α (α is about 45° for thus embodiment), and α2 in degrees, and a side ε{0 1}, the DACU-4(α1, α, α2, side) 750 performs the following general tasks:

i) It detects the following events:
Turn: (s-o=0) AND (s-n=1)
ii) Once an event is detected, the DACU-4(α1, α, α2, side) 750 rotates the stepper-motor 300 shaft by a degrees in CW direction if side=0, and in CCW if side=1.
iii) Next, it monitors changes, Δd in the digital-compass 500 angular direction, and it dynamically updates the angular position of the shaft of the stepper-motor 300−Δd/2. All updates that would push the stepper-motor 300 beyond the limits set by the micro-switches 340 and 350 are ignored. This is one way embodiment 4 differs from the earlier embodiments.
iv) When a terminating condition is detected by the DACU-4(α1, α, α2, side) 750, it returns the stepper-motor 300 shaft to motor-initial position, concluding it tasks. More specifically, the DACU-4(α1, α, α2, side) 750 defines the stepper-motor 300 initial position to be the stepper-motor 300 position that turns on the micro-switch 340. Then, to initialize the stepper-motor 300, the DACU-4(α1, α, α2, side) 750 parks the stepper-motor 300 where the stepper-motor 300 turns on the micro-switch 340. This is another way embodiment 4 differs from the earlier embodiments.
Section 5: The CPU 250 instructions of the DACU-4(α1, α, α2, side) 750

The CPU 250 instructions to perform DACU-4(α1, α, α2, side) 750 tasks are stored in the ROM 260.

Below, the instructions are given in a programming language format. We have used the “ARDUINO” microcontroller programming language.

We first look at side=1 case, DACU-4(α1, α, α2, 1) 750. The instructions are found listed at the end of the Detailed Description but before the claims.

The DACU-4(α1, α, α2, 1) 750, instructions are very similar to the instructions of the DACU-1(α, 1) 700, according to the second update method. We give the following notes.

Note 1: Let's partition the instructions of the DACU-4 750 into two parts:
a) Setting up instructions, and
b) Operating instructions, which are the functions in the program.
a) Setting up instructions

In lines 1-9, the libraries are set up. AFMotor.h library by Adafruit (public domain) was used. The Wire.h library by Arduino was used.

In lines 10-52, the hardware connectivity, constants and variables are set up.

Consider off-the-shelf hardware units that are used, mostly for prototyping such as

Arduino micro-controller, OSEPP motor and servo shield, 3 axes magneto-resistive sensor, two micro-switches, and one left turn signal switch

For clarity, we leave out a few small items from the general description. For one, the three switches each use a 10 KΩ pull up resistor. This is clear to people skilled in the art.

We let one of the micro-switches to represent the micro-switch 340, and the second one to represent the micro-switch 350. Further, we let the left turn signal switch to represent the left turn switch of the turn-signal-switch 400.

For notation consistency with the other embodiments, for the embodiment 4 we merge the stepper-motor driver 320 with the microcontroller 200, instead of the stepper-motor 300. So we would be looking at the combination of the Arduino micro-controller and the OSEPP motor and servo shield as one unit representing the micro-controller 200.

The combined unit has the following conventional I/O ports:

I/O port M1+
I/O port M1−
I/O port M2+
I/O port M2−
I/O port pin 14
I/O port pin 15
I/O port pins 16-17
I/O port pins 21-30

Again for consistency we re-label the above ports as follow:

| Combined unit conventional I/O | Relabeled |
|---|---|
| I/O port M1+ | I/O_204.p1 of I/O port 204 |
| I/O port M1− | I/O_204.p2 of I/O port 204 |
| I/O port M2+ | I/O_204.p3 of I/O port 204 |
| I/O port M2− | I/O_204.p4 of I/O port 204 |
| I/O port pin 14 | I/O_206.p1 of I/O port 206 |
| I/O port pin 15 | I/O_207.p1 of I/O port 207 |
| I/O port pin 16 | I/O_201.p2 of I/O port 201 |
| I/O port pin 17 | I/O_201.p1 of I/O port 201 |
| I/O port pins 21-30 | I/O_202.p1-p10 of I/O port 202 |

Notice that in embodiment 4, the stepper-motor 300 uses only 4 pins instead of 8. The reason is that in this embodiment the pins carry a different signal. Since we included the driver 320 with the micro-controller 200, the four pins: I/O_204.p1-p4 of I/O port 204 represent the signal from the driver 320 to the stepper-motor 300 while in the earlier embodiments, the eight pins: I/O_204.p1-p8 of I/O port 204 represent the signal from the controller 310 to the driver 320 that was grouped with the stepper-motor 300.

However, in embodiment 4, the digital-compass 500 uses all 10 pins I/O_202.p1-p10 of I/O port 202.

Some digital compasses use a serial communication method with the micro-controller. In general, these compasses will not need all 10 pins. In embodiment 4, we assume the interface of the digital-compass 500 with the micro-controller 200 is the 10 bits I/O port 202.

One can have an additional communication rule between the digital-compass 500 and the micro-controller 200 to avoid the micro-controller 200 reading the digital-compass 500 values while they are being refreshed.

Another instruction that falls under a) is in line 28

AF_Stepper motor(STEPS, 1);

This instructs the microcontroller 200 that the stepper-motor 300 is of a bipolar kind and that it is properly connected to the four pins I/O_204.p1-p4 of the I/O port 204.

Finally lines 91-107 give instructions that set up:

1) The physical pin connections and
2) The speed of the stepper-motor 300.
=======================================================

### b) Operating Instructions

Operational instruction of the DACU-4(α1, α, α2, 1) 750 is very similar to the instructions of the DACU-1(α, 1) 700.

Lines 53-56 represent Z of DACU-1(α, 1) 700 (2^{nd} update rule)
Lines 57-65 represent Y of DACU-1(α, 1) 700 (2^{nd} update rule)
Lines 66-73 represent C of DACU-1(α, 1) 700 (2^{nd} update rule)
Lines 74-90 represent E of DACU-1(α, 1) 700 (2^{nd} update rule)
Lines 109-122 represent READ I/O: s-n & c-n
Lines 123-249 represent 6 case branching
case 5 with 8 sub-branching

Other instructions that fall under b) are

Line 176 motor.step(1, BACKWARD, INTERLEAVE);
Line 186 motor.step(1, FORWARD, INTERLEAVE);
Line 200 motor.step(1, FORWARD, INTERLEAVE);
Line 210 motor.step(1, BACKWARD, INTERLEAVE);
Line 220 motor.step(1, BACKWARD, INTERLEAVE);
Line 234 motor.step(1, FORWARD, INTERLEAVE);

INTERLEAVE instructs the microcontroller 200 to control and drive the stepper-motor 300 in half steps.

Note 2: The right-side mirror 1 is subject to small jitter due to
1) Noise in the digital-compass 500 reading, and
2) Mechanical vibrations from the stepper-motor 300.

In the embodiment 4, to reduce 1) first, we isolate small updates (those that require≦DIFF steps) then we delay their processing. If the updates grow large, then we process them. Otherwise we treat them as jitter and we ignore them.

Further we bias the isolated small updates. Specifically, during a typical left turn, the DACU-4(α1, α, α2, 1) 750, first will quickly rotate the right-side mirror 1 CCW by α°, then it will gradually rotate the right-side mirror 1 CW until the right-side mirror 1 returns to its original position. Therefore, the natural direction of rotation for the right-side mirror 1 during a typical left turn is CW. Now we bias the isolation method in the following sense. We only isolate small updates if they will rotate the right-side mirror 1 in CCW direction (opposite of its typical direction).

DIFF=1 and DIFF=2 do very well in the embodiment 4.

In the embodiment 4, with respect to mechanical vibrations, very simple spring/mass dampers do very well because we are turning the stepper-motor 300 relatively slowly and the torque required to rotate the right-side mirror 1 is very small, having a small mass.

This ends the instructions for the DACU-4(α1, α, α2, 1) 750.

We omit the instructions for the DACU-4(α1, α, α2, 0) 750, the left-side mirror 2 case, because it is the exact symmetric version of the DACU-4(α1, α, α2, 1) 750.

Note 3: The microcontroller 200 can monitor each of the switches: turn-signal-switch 400 and the micro-switches 340 and 350, in two ways.
1) By using the interrupt port 220 or
2) By polling, which means every time it cycles through the function loop( )

We have used the polling method in the embodiment 4.

### Embodiment 5

The embodiment 5 modifies the embodiment 2 the same way the embodiment 4 modified the embodiment 1. 1) It introduces limits to angular rotation of the right-side mirror 1 and left-side mirror 2 during right turns, and 2) It fixes a reference for the initialization of the stepper-motor 300

The embodiment 5 introduces a Dynamically Adjustable Mirror Control Unit 5, DACU-5 760 that while performing like DACU-2 800, it limits the angular positions to the range [α1α2].

We will explain the DACU-5 760 using the DACU-4 750. To this end, first we explain the DACU-5(α,1) 760 using the DACU-4(α,1) 750, next we will explain DACU-5(α,0) 760 using the DACU-4(α,0) 750.

We claim the DACU-5(α,1) 760 is very similar to the DACU-4(α,1) 750, and it can be derived from DACU-4(α,1) 750 with a minor modification.

We prove the claim in two steps:

Step 1) Referring to the flowcharts (for the second update rule) given earlier, DACU-1(α, 1) 700 and DACU-2(α,1) 800 differ only:
a) In DACU-1(α,1) 700, we use the left turn signal 402 of the Turn-signal-switch 400: F.2 I/O_201.px=I/O_201.p2, but in DACU-2(α,1) 800, we use the right turn signal 401 of the Turn-signal-switch 400: F.2 I/O_201.px=I/O_201.p1.
b) In DACU-1(α,1) 700, we use the instruction list C, but in DACU-2(α,1) 800, we use the instruction list F. And F is a subset of C.

Therefore we can go from DACU-1(α,1) 700 to DACU-2(α,1) 800 by:

a) Making the connection F.2 I/O_201.px=I/O_201.p1, and
b) Removing commands C-F (=commands that are in C but not in F.)
Step 1) was explained earlier.
Step 2) The changes in Step 1) also transform DACU-4(α,1) 750 into DACU-5(α,1) 760. (We omit the straightforward proof.)

Now using a symmetry argument, we claim DACU-5(α,0) 760 is very similar to DACU-4(α, 0) 750 and it can be derived from DACU-4(α,0) 750 with the following minor modification.

a) Making the connection F.2 I/O_201.px=I/O_201.p2, and
b) Removing commands C-F.

This completes the description of DACU-5 760.

### Embodiment 6

Embodiment 6 provides another method for dynamically adjustable mirrors. Specifically a method for the right-side mirror 1 during a right turn and for the left-side mirror 2 during a left turn. This embodiment gives a new mode of operation for the right-side mirror 1 on right turns and for the left-side mirror 2 on left turns. Its goal is to improve the view and to improve the surveillance for making a turn at intersections, more specifically the view and the surveillance of a road section into which the vehicle is turning.

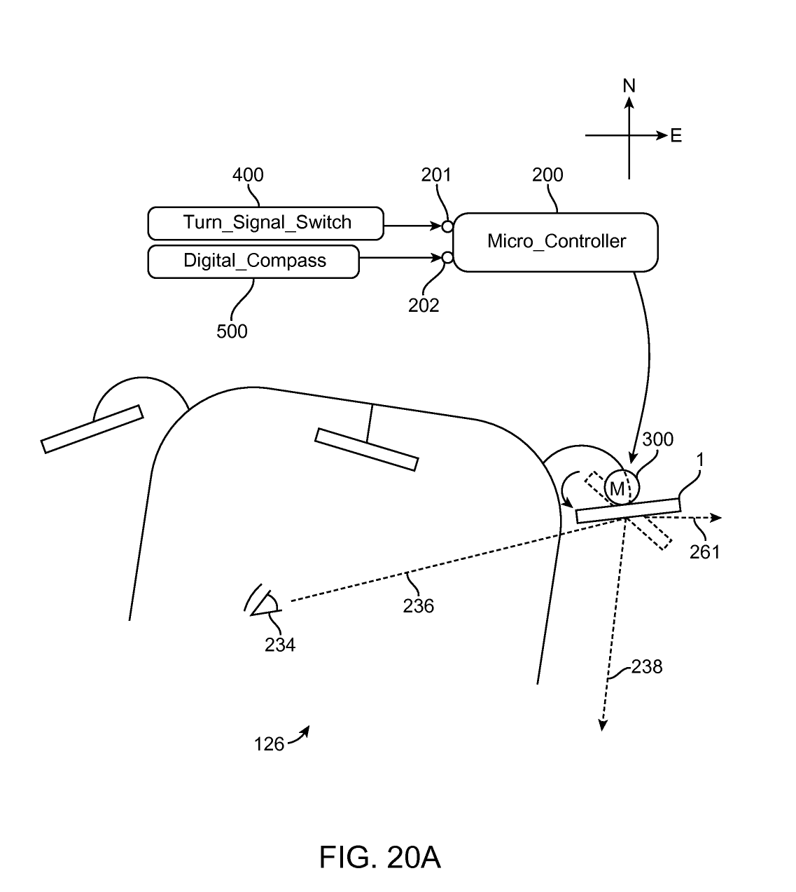

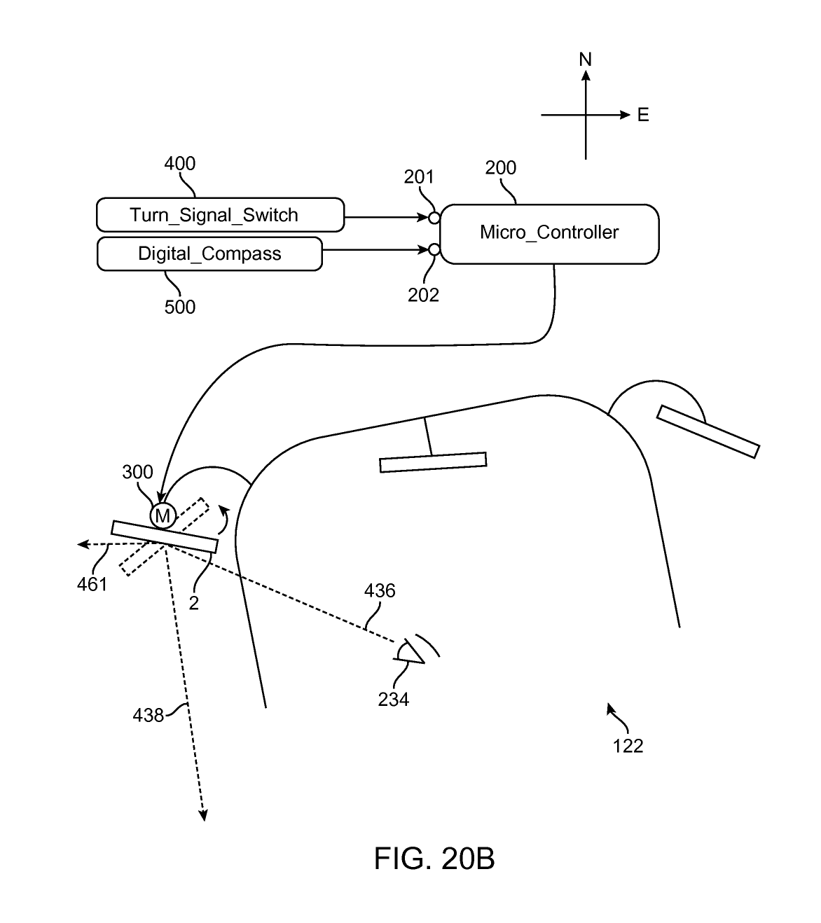

At the heart of Embodiment 6 is an apparatus called Dynamically Adjustable Mirror Control Unit 6, DACU-6 765. DACU-6(α, side=1), 765 relates to the right-side mirror 1 during right turns, and DACU-6(α, side=0), 765 relates to the left-side mirror 2 during left turns. We first describe DACU-6(α, side=1), 765 using FIGS. 4A and 20A. FIG. 4A relates to the automobile 100, position 120 during a right turn, and FIG. 20A relates to the automobile 100, position 126 during a right turn. These positions were depicted in FIG. 2.

FIG. 4A relates to the automobile 100 position 120 at the start of the right turn after a right turn is detected. The mirror 1 oriented as shown enables the driver 234 to view the field of vision 241 via the field of vision 236 of the mirror 1. FIG. 20A relates to the automobile 100 position during the right turn. The mirror 1 oriented as shown enables the driver 234 to view the field of vision 261 via the field of vision 236 of the mirror 1. The fields of vision 241 and 261 provide views of the road section into which the vehicle is turning.

On a right turn, the microcontroller 200 performs the following tasks with respect to the right-side mirror 1.

First, a right turn is detected based on the turn signal switch 400 signal through the port 201.

Second, the right-side mirror 1 position is depicted with dotted lines in FIG. 4A. In this position, the right-side mirror 1 shows a view toward south. Once a right turn is detected, the micro-controller 200 quickly rotates the right-side mirror 1 by about α=45 degrees counter-clockwise with respect to FIG. 4A top view reference. The micro-controller 200 uses the electric motor 300 to move the right-side mirror 1. After this rotation, the view of the right-side mirror 1 rotates about 90 degrees in counter-clockwise direction, facing east. The right-side mirror 1 position after the rotation is depicted with solid lines in FIG. 4A.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the right-side mirror 1 position through the motor 300, so that the right-side mirror 1 continuously provides a view generally facing east.

Fourth, as the automobile 100 ends the right turn, the proposed apparatus, DACU-6 765, quickly returns the right-side mirror 1 to its neutral position, corresponding to the position it had before the right turn was detected.

This concludes the operations of the proposed apparatus, DACU-6, 765, on the right-side mirror 1 during a right turn. A quick inspection shows:

DACU-6(α, side=1), 765 is identical to DACU-1(α, side=1), 700. Therefore, we refer to DACU-1 for the details of DACU-6(α, side=1), 765.

In summary, referring to FIG. 2, in the absence of the DACU-6(α, side=1), 765, the right-side mirror 1 view during a right turn spans the south west corner of the intersection 10, while with the DACU-6(α, side=1), 765, the view focuses on the traffic approaching the intersection 10 from east. The later view provides surveillance information that is highly relevant to making a safe right turn in regards to:

1) Avoiding collisions with incoming traffic from east.
2) Avoiding hitting pedestrians crossing the intersection between south/east and north/east corners of the intersection 10.
3) Giving the driver of the automobile 100 more time to concentrate on the traffic from north and the traffic from west, by quickly informing the driver about the traffic from east.
4) Informing the driver of the automobile 100 about traffic in the road section into which the vehicle is turning.

When the surveillance device is a mirror as in the description above, an upper bound to the rotation of the right-side mirror 1 is desired, as in embodiment 4. However if the surveillance device is a camera 1100, then such upper bounds are not in general necessary, since in the former case, the viewing window of the right-side mirror 1 shrinks as it rotates counter-clockwise while the viewing window of a camera would not necessarily shrink, for instance when we use a monitor 1105 inside the automobile 100.

Next we describe DACU-6(α, side=0), 765 using FIGS. 4B and 20B. FIG. 4B relates to the automobile 100, position 120 during a left turn, and FIG. 20B relates to the automobile 100, position 122 during a left turn. These positions were depicted in FIG. 1.

FIG. 4B relates to the automobile 100 position 120 at the start of the left turn after a left turn is detected. The mirror 2 oriented as shown enables the driver 234 to view the field of vision 441 via the field of vision 436 of the mirror 2. FIG. 20B relates to the automobile 100 position during the left turn. The mirror 2 oriented as shown enables the driver 234 to view the field of vision 461 via the field of vision 436 of the mirror 2. The fields of vision 441 and 461 provide views of the road section into which the vehicle is turning.

On a left turn, the microcontroller 200 performs the following tasks with respect to the left-side mirror 2.

First, a left turn is detected based on the turn signal switch 400 signal through the port 201.

Second, the left-side mirror 2 position is depicted with dotted lines in FIG. 4B. In this position, the left-side mirror 2 shows a view toward south. Once a left turn is detected, the micro-controller 200 quickly rotates the left-side mirror 2 by about α=45 degrees clockwise with respect to FIG. 4B top view reference. The micro-controller 200 uses the electric motor 300 to move the left-side mirror 2. After this rotation, the view of the left-side mirror 2 rotates about 90 degrees in clockwise direction, facing west. The left-side mirror 2 position after the rotation is depicted with solid lines in FIG. 4B.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the left-side mirror 2 position through the motor 300, so that the left-side mirror 2 continuously provides a view generally facing west.

Fourth, as the automobile 100 ends the left turn, the proposed apparatus, DACU-6 765, quickly returns the left-side mirror 2 to its neutral position, corresponding to the position it had before the left turn was detected.

This concludes the operations of the proposed apparatus, DACU-6, 765, on the left-side mirror 2 during a left turn. A quick inspection shows:

DACU-6(α, side=0), 765 is identical to DACU-1(α, side=0), 700. Therefore, we refer to DACU-1 for the details of DACU-6(α, side=0), 765.

In summary, referring to FIG. 1, in the absence of the DACU-6(α, side=0), 765, the left-side mirror 2 view during a left turn spans the south east corner of the intersection 10, while with the DACU-6(α, side=0), 765, the view focuses on the traffic approaching the intersection 10 from west. The later view provides surveillance information that is highly relevant to making a safe left turn in regards to:

1) Avoiding collisions with incoming traffic from west.
2) Avoiding hitting pedestrians crossing the intersection between south/west and north/west corners of the intersection 10.
3) Giving the driver of the automobile 100 more time to concentrate on the traffic from north and the traffic from east, by quickly informing the driver about the traffic from west.
4) Informing the driver of the automobile 100 about traffic in the road section into which the vehicle is turning.

### Embodiment 7

Embodiment 7 relates to dynamically adjustable side-mirrors during reverse. The embodiment 7 introduces a Dynamically Adjustable Mirror Control Unit 7, DACU-7 770.

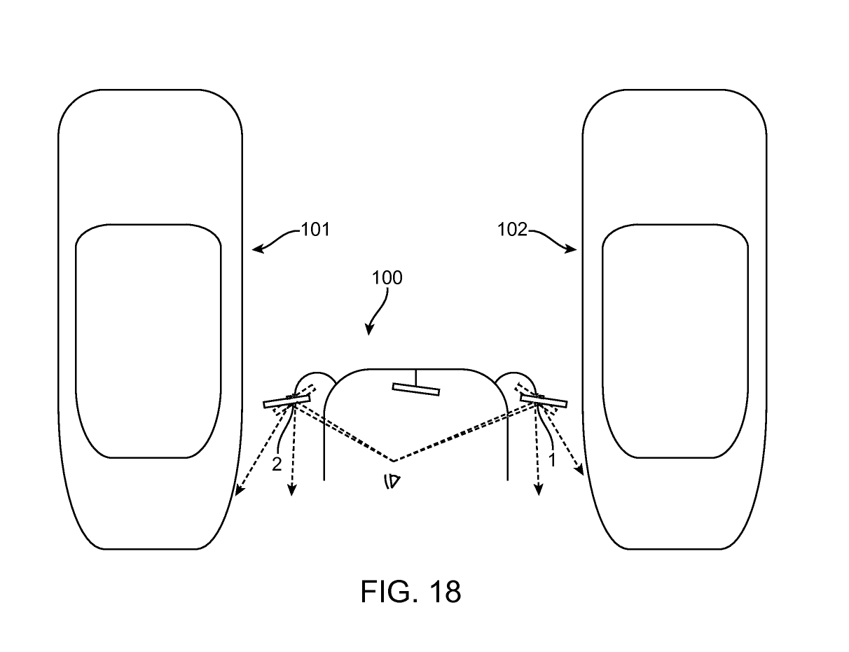

Referring to FIG. 18, the automobile 100 is depicted backing out from a parked spot. There are two parked automobiles, 101 and 102, parked on the left side and the right side of the automobile 100, respectively. In the ordinary situation, the right-side mirror 1 and the left-side mirror 2 are shown with dotted lines.

DACU-7 770, acts on the right-side mirror 1, the same as DACU-1 700, except:

1) It reacts to a reverse drive signal instead of the Turn-signal-switch 400 (left turn signal).
2) After the initial CCW rotation by α°, it does not make any further adjustments. The right-side mirror 1 after the rotation is shown with solid lines.

DACU-7 770, acts on the left-side mirror 2, the same as DACU-2 800, except:

1) It reacts to reverse drive signal instead of the Turn-signal-switch 400 (right turn signal).
2) After the initial CW rotation by α°, it does not make any further adjustments.

The left-side mirror 2 after the rotation is shown with solid lines.

As illustrated in FIG. 18, the embodiment 7 provides viewing angles that are more to the rear sides of the automobile 100 than to the rear. This is helpful in surveying for vehicles approaching the automobile 100 from the rear sides.

Another advantage produced is that the views from the side mirrors according to embodiment 7 complement the driver's view over his/her right shoulder, this is not true without embodiment 7.

Embodiments 8-10 relate to dynamically adjustable rear-view mirrors. Referring to FIG. 9A, the rear-view mirror 3 is augmented on the right with a mirror 4, and on the left with a mirror 5.

### Embodiment 8

Embodiment 8 provides solutions for the right-side augmented mirror 4 during a left turn and for the left-side augmented mirror 5 during a right turn. As before, we first discuss the right-side augmented mirror 4 during a left turn.

The mirror 4 is connected to a Dynamically Adjustable Mirror Control Unit 8, DACU-8 780 comprising 1) The micro-controller 200, 2) The digital-compass 500, 3) The turn-signal-switch 400, and 4) The stepper-motors 300 and 301. The connectivity of these components is as before.

Briefly, on a left turn on the intersection 10 of FIG. 1, in the absence of the micro-controller 200, the right-side augmented mirror 4 view gradually changes from facing south to facing east. Although FIG. 1 does not explicitly depict the augmented mirrors 4 and 5, nevertheless, in the absence of the micro-controller 200, the augmented mirrors 4 and 5 generally provide the same view as the rear-view mirror 3.

Embodiment 8 quickly moves the right-side augmented mirror 4 view facing east in the beginning of the turn. Then by making gradual changes to the right-side augmented mirror 4 position, the proposed embodiment continuously maintains a view facing east at all times during the turn. The embodiment disengages once the turn is completed.

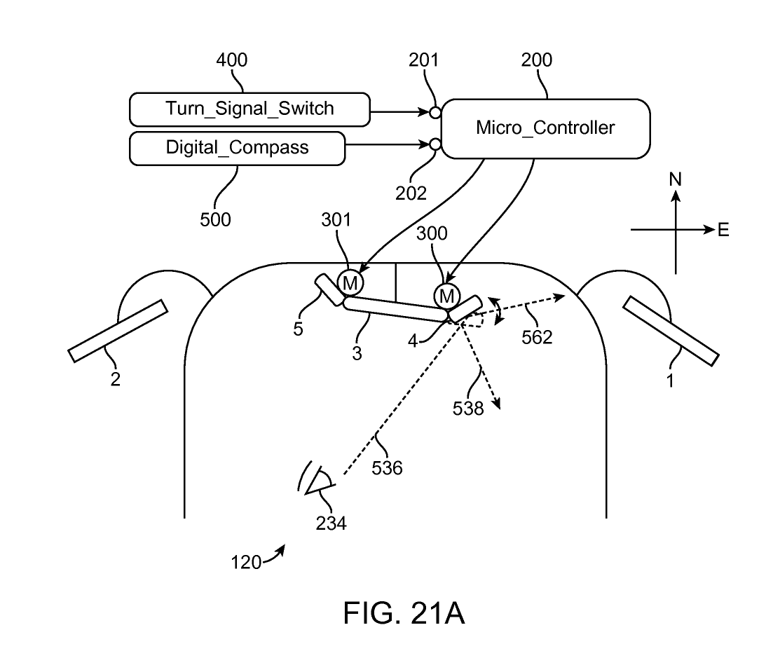

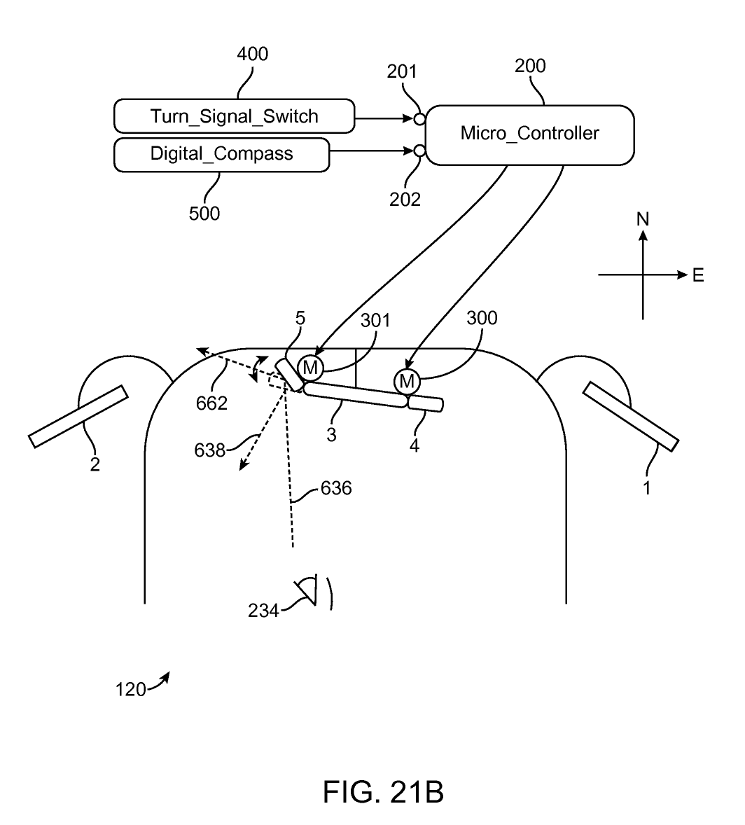

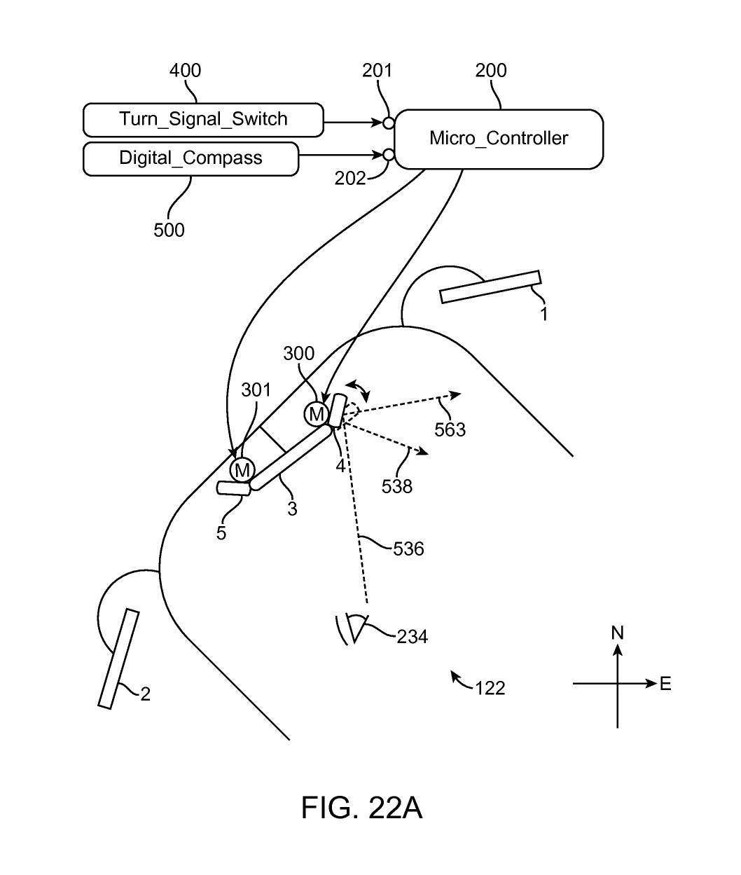

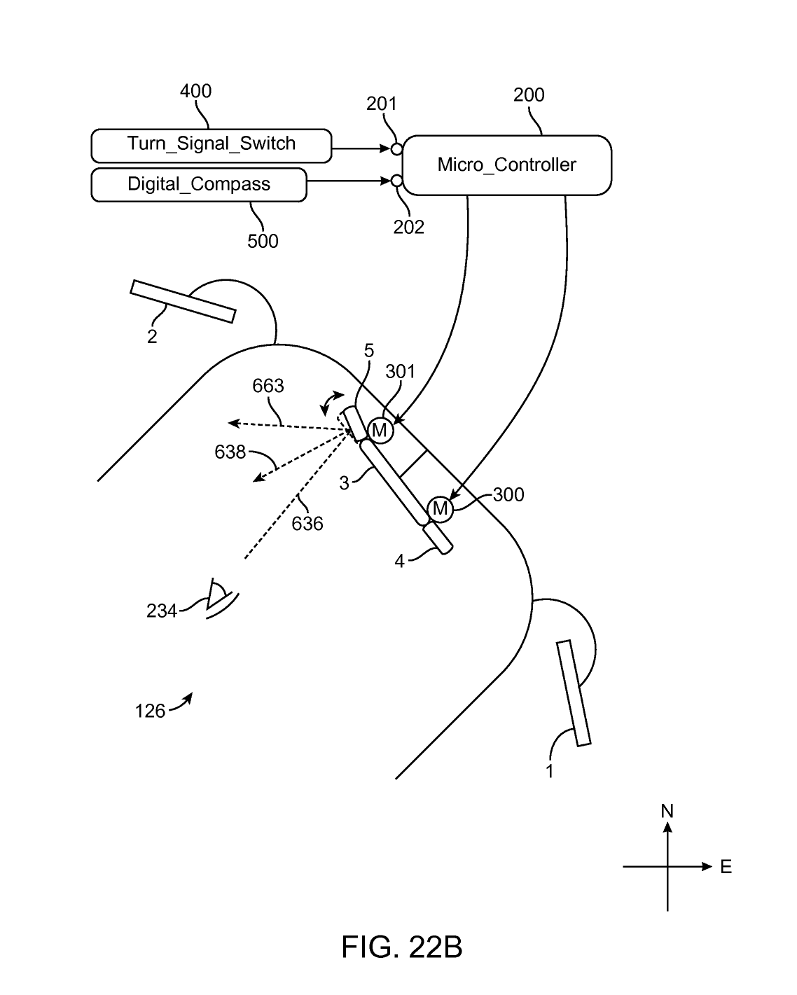

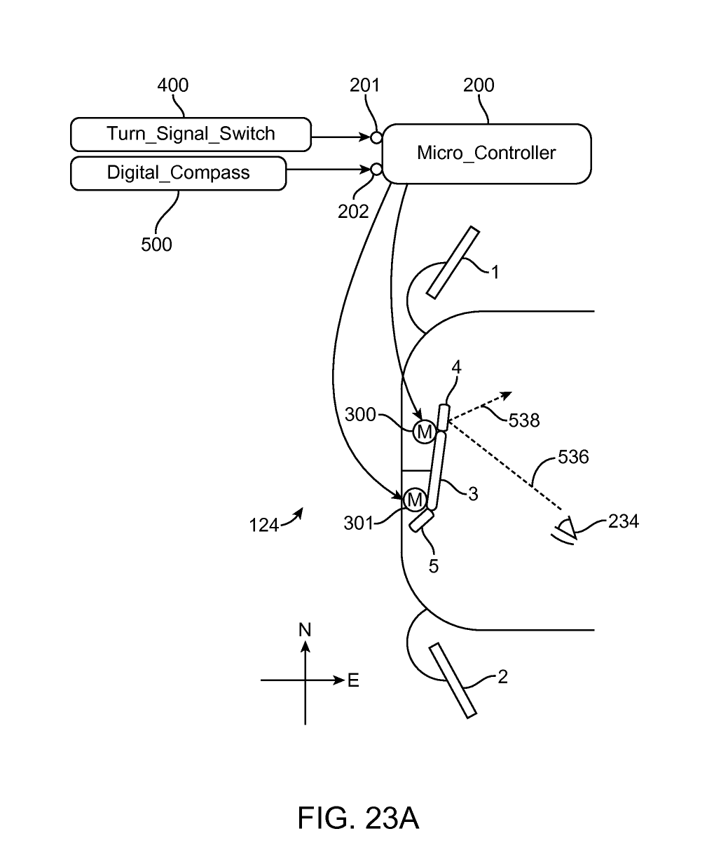

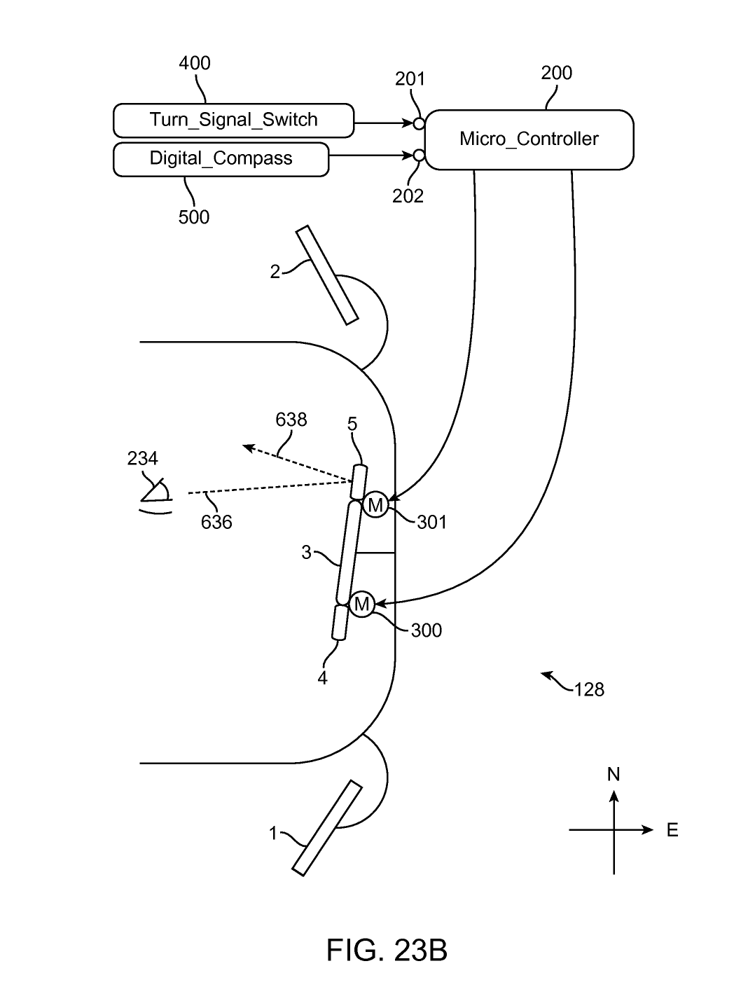

Specifically, FIGS. 21A, 22A, and 23A relate to three positions 120, 122, and 124 of the automobile 100, during a left turn. These positions are depicted in FIG. 1. FIG. 21A relates to the automobile 100 position 120 at the start of the left turn. The right-side augmented mirror 4 oriented as shown enables the driver 234 to view the field of vision 562 via the field of vision 536 of the right-side augmented mirror 4. FIG. 22A relates to the automobile 100 position 122 during the left turn. The right-side augmented mirror 4 oriented as shown enables the driver 234 to view the field of vision 563 via the field of vision 536 of the right-side augmented mirror 4. FIG. 23A relates to the automobile 100 position at the end of the left turn 124. The right-side augmented mirror 4 oriented as shown enables the driver 234 to view the field of vision 538 via the field of vision 536 of the right-side augmented mirror 4.

On a left turn, the micro-controller 200 performs the following tasks with respect to the right-side augmented mirror 4.

First, a left turn is detected based on the turn signal switch 400 signal through the port 200.

Second, the right-side augmented mirror 4 position is depicted with dotted lines in FIG. 21A. In this position, the right-side augmented mirror 4 shows a view generally toward south. Once a left turn is detected, the micro-controller 200 quickly rotates the right-side augmented mirror 4 by about 45 degrees counter-clockwise with respect to FIG. 21A top view reference. The micro-controller 200 uses the electric motor 300 to move the right-side augmented mirror 4. After this rotation, the view of the right-side augmented mirror 4 rotates about 90 degrees in counter-clockwise direction, facing generally east. The right-side augmented mirror 4 position after the rotation is depicted with solid lines in FIG. 21A.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the right-side augmented mirror 4 position through the motor 300, so that the right-side augmented mirror 4 continuously provides a view facing generally east. FIG. 22A shows the situation when the automobile 100 has completed half the turn. The right-side augmented mirror 4 position in the absence of the micro-controller 200 is shown with dotted lines. In this position the right-side augmented mirror 4 is showing a view facing south/east. The right-side augmented mirror 4 position in the presence of the micro-controller 200 is shown with solid lines. In this position, the right-side augmented mirror 4 is showing a view facing generally east.

Fourth, as the automobile 100 ends the left turn, FIG. 23A, two positions of the right-side augmented mirror 4: 1) in the presence of the micro-controller 200 changes, and 2) in the absence of the micro-controller changes, coincide. This concludes the micro-controller 200 operations during a left turn.

Clearly, in the presence of the micro-controller 200, the right-side augmented mirror 4 provides a view that is more important and more relevant to the position of the automobile 100 than the view provided by the right-side augmented mirror 4 in the absence of the micro-controller 200.

In summary, referring to FIG. 1, in the absence of the DACU-8 780, the right-side augmented mirror 4 view during a left turn spans the south east corner of the intersection 10, while with the DACU-8 780, the view focuses on the traffic approaching the intersection 10 from east. The later view provides surveillance information that is highly relevant to making a safe left turn in at least two regards:

1) Avoiding collisions with incoming traffic from east, and
2) Giving the driver of the automobile 100 more time to concentrate on the traffic from north and the traffic from west, by quickly informing the driver about the traffic from east.

The above embodiment would work if we select DACU-8 780 to be the same as DACU-1 700.

Next we discuss the embodiment 8 for the left-side augmented mirror 5 during a right turn. The mirror 5 is connected to DACU-8 780 as follows.

Briefly, on a right turn on the intersection 10 of FIG. 2, in the absence of the micro-controller 200, the left-side augmented mirror 5 view gradually changes from facing south to facing west. Although FIG. 2 does not explicitly depict the augmented mirrors 4 and 5, nevertheless, in the absence of the micro-controller 200, the augmented mirrors 4 and 5 generally provide the same view as the rear-view mirror 3.

Embodiment 8 quickly moves the left-side augmented mirror 5 view facing west in the beginning of the turn. Then by making gradual changes to the left-side augmented mirror 5 position, the proposed embodiment continuously maintains a view facing west at all times during the turn. The embodiment disengages once the turn is completed.

Specifically, FIGS. 21B, 22B, and 23B relate to three positions 120, 126, and 128 of the automobile 100, during a right turn. These positions are depicted in FIG. 2. FIG. 21B relates to the automobile 100 position 120 at the start of the right turn. The left-side augmented mirror 5 oriented as shown enables the driver 234 to view the field of vision 662 via the field of vision 636 of the left-side augmented mirror 5. FIG. 22B relates to the automobile 100 position 126 during the right turn. The left-side augmented mirror 5 oriented as shown enables the driver 234 to view the field of vision 663 via the field of vision 636 of the left-side augmented mirror 5. FIG. 23B relates to the automobile 100 position at the end of the right turn 128. The left-side augmented mirror 5 oriented as shown enables the driver 234 to view the field of vision 638 via the field of vision 636 of the left-side augmented mirror 5.

On a right turn, the micro-controller 200 performs the following tasks with respect to the left-side augmented mirror 5.

First, a right turn is detected based on the turn signal switch 400 signal through the port 200.

Second, the left-side augmented mirror 5 position is depicted with dotted lines in FIG. 21B. In this position, the left-side augmented mirror 5 shows a view generally toward south. Once a right turn is detected, the micro-controller 200 quickly rotates the left-side augmented mirror 5 by about 45 degrees clockwise with respect to FIG. 21B top view reference. The micro-controller 200 uses the electric motor 301 to move the left-side augmented mirror 5. After this rotation, the view of the left-side augmented mirror 5 rotates about 90 degrees in clockwise direction, facing generally west. The left-side augmented mirror 5 position after the rotation is depicted with solid lines in FIG. 21B.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the left-side augmented mirror 5 position through the motor 301, so that the left-side augmented mirror 5 continuously provides a view facing generally west. FIG. 22B shows the situation when the automobile 100 has completed half the turn. The left-side augmented mirror 5 position in the absence of the micro-controller 200 is shown with dotted lines. In this position the left-side augmented mirror 5 is showing a view facing south/west. The left-side augmented mirror 5 position in the presence of the micro-controller 200 is shown with solid lines. In this position, the left-side augmented mirror 5 is showing a view facing generally west.

Fourth, as the automobile 100 ends the right turn, FIG. 23B, two positions of the left-side augmented mirror 5: 1) in the presence of the micro-controller 200 changes, and 2) in the absence of the micro-controller changes, coincide. This concludes the micro-controller 200 operations during a right turn.

Clearly, in the presence of the micro-controller 200, the left-side augmented mirror 5 provides a view that is more important and more relevant to the position of the automobile 100 than the view provided by the left-side augmented mirror 5 in the absence of the micro-controller 200.

In summary, referring to FIG. 2, in the absence of the DACU-8 780, the left-side augmented mirror 5 view during a right turn spans the south west corner of the intersection 10, while with the DACU-8 780, the view focuses on the traffic approaching the intersection 10 from west. The later view provides surveillance information that is highly relevant to making a safe right turn in at least two regards:

1) Avoiding collisions with incoming traffic from west, and
2) Giving the driver of the automobile 100 more time to concentrate on the traffic from north and the traffic from east, by quickly informing the driver about the traffic from west.

The above embodiment would work if we select DACU-8 780 to be the same as DACU-1 700.

### Embodiment 9

Embodiment 9 provides solutions for the right-side augmented mirror 4 during a right turn and for the left-side augmented mirror 5 during a left turn. We first discuss the right-side augmented mirror 4 during a right turn.

The mirror 4 is connected to a Dynamically Adjustable Mirror Control Unit 9, DACU-9 790 comprising 1) The micro-controller 200, 2) The digital-compass 500, 3) The turn-signal-switch 400, and 4) The stepper-motors 300 and 301. The connectivity of these components is as before.

Briefly, on a right turn at the intersection 10 of FIG. 2, in the absence of the micro-controller 200, the view of the right-side augmented mirror 4 gradually changes from facing south to facing west. By making gradual changes to the right-side augmented mirror 4 positions, the proposed embodiment maintains the view of the right-side augmented mirror 4 facing generally south at all times during the right turn. Then at the end of the right turn, the embodiment will quickly move the right-side augmented mirror 4 to its neutral position—the position the right-side augmented mirror 4 would have had in the absence of the micro-controller 200. At the end of the turn, in the neutral position, the view of the right-side augmented mirror 4 is generally toward west.

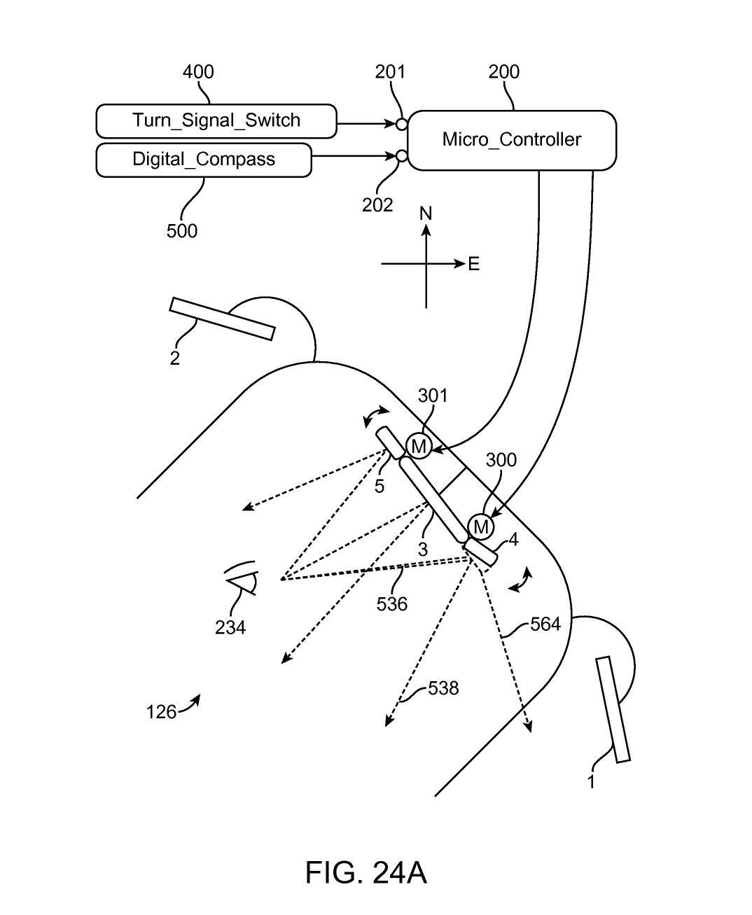

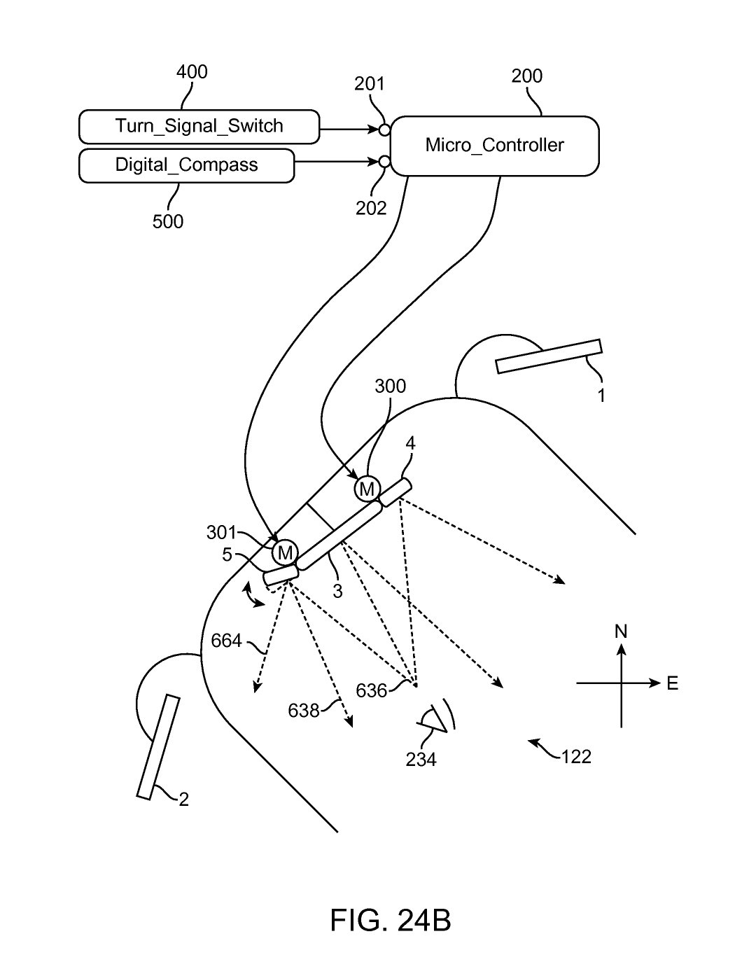

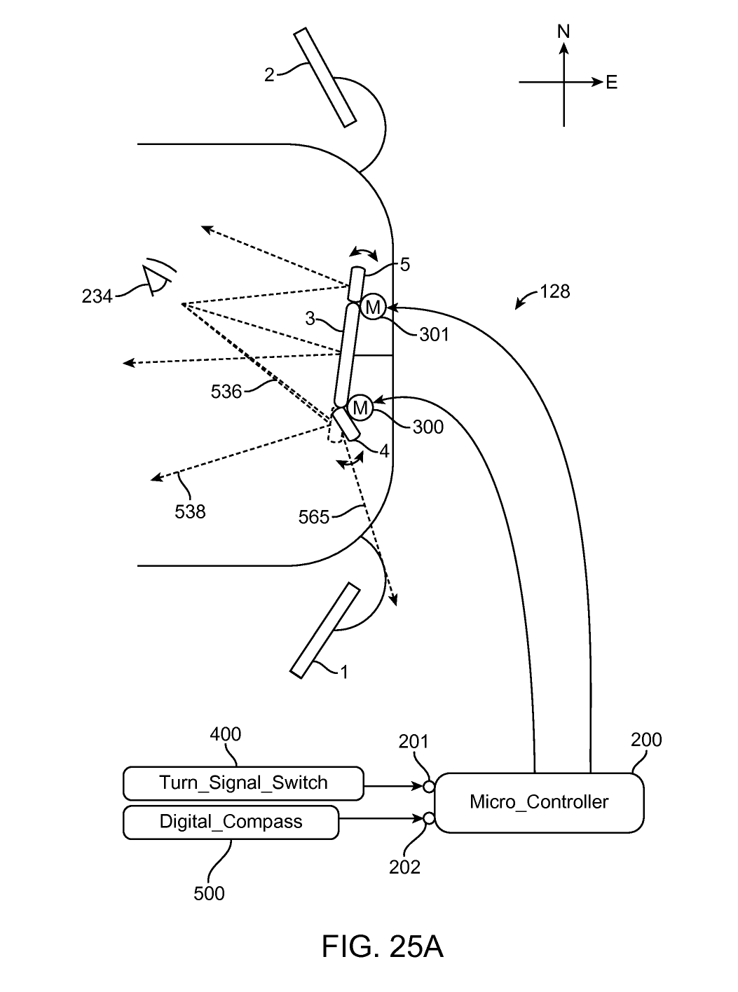

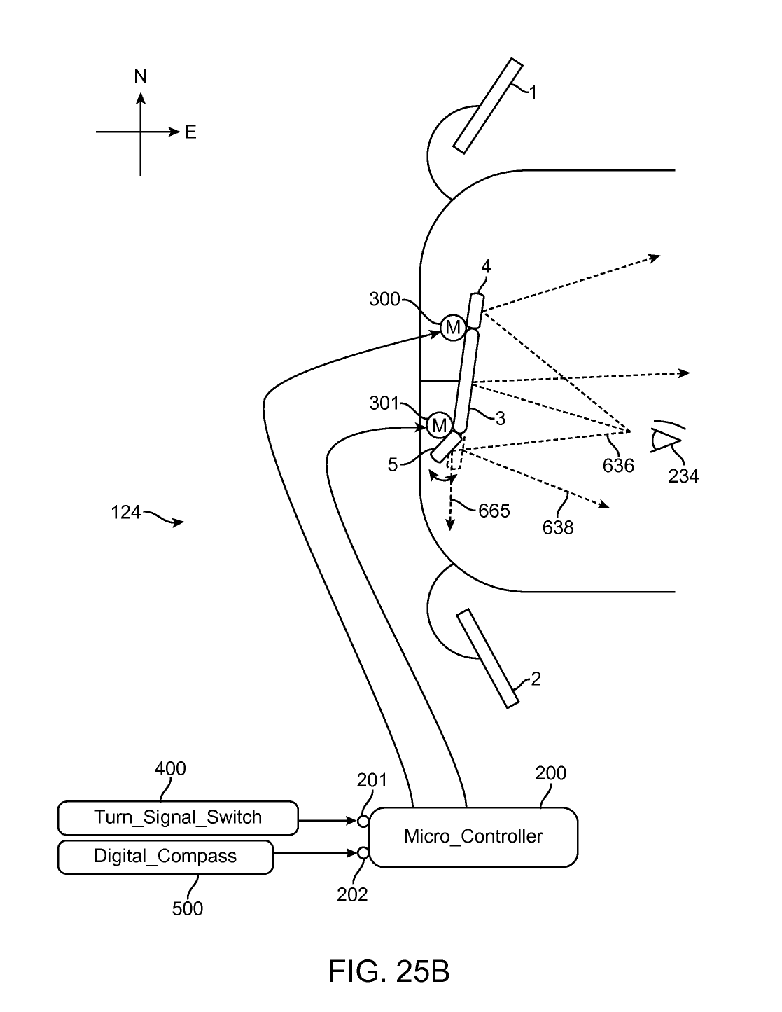

Specifically, FIGS. 9A, 24A, and 25A relate to the automobile 100, three positions 120, 126, and 128 during a right turn. These positions were depicted in FIG. 2. FIG. 9A relates to the automobile 100 position 120 at the start of the right turn. The right-side augmented mirror 4 oriented as shown enables the driver 234 to view the field of vision 538 via the field of vision 536 of the right-side augmented mirror 4. FIG. 24A relates to the automobile 100 position during the right turn. The right-side augmented mirror 4 oriented as shown enables the driver 234 to view the field of vision 564 via the field of vision 536 of the right-side augmented mirror 4. FIG. 25A relates to the automobile 100 position at the end of the right turn. The right-side augmented mirror 4 oriented as shown enables the driver 234 to view the field of vision 565 via the field of vision 536 of the right-side augmented mirror 4.

On a right turn, the microcontroller 200 performs the following tasks with respect to the right-side augmented mirror 4.

First, a right turn is detected based on the turn signal switch 400 signal through the port 201.

Second, the right-side augmented mirror 4 position is depicted with solid lines in FIG. 9A. At this position, the right-side augmented mirror 4 shows the view generally toward south.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the right-side augmented mirror 4 position through the motor 300, so that the right-side augmented mirror 4 continuously provides a view generally facing south. FIG. 24A shows the situation when the automobile 100 has completed half of the right turn and it has completed about 45 degrees clockwise turn in position 126. The right-side augmented mirror 4 position in the absence of the micro-controller 200 is shown with dotted lines. In this position the right-side augmented mirror 4 is showing a view facing south/west. The right-side augmented mirror 4 position in the presence of the micro-controller 200 is shown with solid lines. In this position, the right-side augmented mirror 4 is showing a view generally facing south.

Fourth, as the automobile 100 ends the right turn, FIG. 25A, two positions of the right-side augmented mirror 4: First, in the presence of the micro-controller 200 changes, and second in the absence of the micro-controller changes, are shown with solid and dotted lines respectively. Next the proposed embodiment quickly returns the right-side augmented mirror 4 to its neutral position, corresponding to the position shown with dotted lines. This concludes the operations of the proposed embodiment on the right-side augmented mirror 4 during a right turn.

Therefore, the DACU-9 790 moves the right-side augmented mirror 4 into positions with key viewing angles during right turns. Furthermore, it moves the right-side augmented mirror 4 in a way that the right-side augmented mirror 4 produces steady, slow moving, viewing background during right turns.

In summary, referring to FIG. 2, in the absence of the DACU-9 790, the right-side augmented mirror 4 views during a right turn spans the south west corner of the intersection 10, while with the DACU-9 790, the view focuses on the traffic approaching the intersection 10 from south. The later view provides surveillance information that is highly relevant to making a safe right turn in regards to:

1) Avoiding collisions with traffic from south, especially in multi-lane intersections. Referring to the automobile 100 in FIG. 2, if there is another lane to the right of the automobile 100, then the automobile 100 becomes very vulnerable to traffic going north in that lane.
2) Avoiding collisions with a bicycle or a motorcycle following the automobile 100.
3) Giving the driver of the automobile 100 more time to concentrate on the traffic from other directions, by quickly informing the driver about the traffic from the south.

The above embodiment would work if we select DACU-9 790 to be the same as DACU-2 800.

Next we discuss the embodiment 9 for the left-side augmented mirror 5 during a left turn. The mirror 5 is connected to DACU-9 790 as follows.

Briefly, on a left turn at the intersection 10 of FIG. 1, in the absence of the micro-controller 200, the view of the left-side augmented mirror 5 gradually changes from facing south to facing east. By making gradual changes to the left-side augmented mirror 5 positions, the proposed embodiment maintains the view of the left-side augmented mirror 5 facing generally south at all times during the left turn. Then at the end of the left turn, the embodiment will quickly move the left-side augmented mirror 5 to its neutral position—the position the left-side augmented mirror 5 would have had in the absence of the micro-controller 200. At the end of the turn, in the neutral position, the view of the left-side augmented mirror 5 is generally toward east.

Specifically, FIGS. 9B, 24B, and 25B relate to the automobile 100, three positions 120, 122, and 124 during a left turn. These positions were depicted in FIG. 1. FIG. 9B relates to the automobile 100 position 120 at the start of the left turn. The left-side augmented mirror 5 oriented as shown enables the driver 234 to view the field of vision 638 via the field of vision 636 of the left-side augmented mirror 5. FIG. 24B relates to the automobile 100 position during the left turn. The left-side augmented mirror 5 oriented as shown enables the driver 234 to view the field of vision 664 via the field of vision 636 of the left-side augmented mirror 5. FIG. 25B relates to the automobile 100 position at the end of the left turn. The left-side augmented mirror 5 oriented as shown enables the driver 234 to view the field of vision 665 via the field of vision 636 of the left-side augmented mirror 5.

On a left turn, the microcontroller 200 performs the following tasks with respect to the left-side augmented mirror 5.

First, a left turn is detected based on the turn signal switch 400 signal through the port 201.

Second, the left-side augmented mirror 5 position is depicted with solid lines in FIG. 9B. At this position, the left-side augmented mirror 5 shows the view generally toward south.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the left-side augmented mirror 5 position through the motor 301, so that the left-side augmented mirror 5 continuously provides a view generally facing south. FIG. 24B shows the situation when the automobile 100 has completed half of the left turn and it has completed about 45 degrees counter-clockwise turn in position 122. The left-side augmented mirror 5 position in the absence of the micro-controller 200 is shown with dotted lines. In this position the left-side augmented mirror 5 is showing a view facing south/east. The left-side augmented mirror 5 position in the presence of the micro-controller 200 is shown with solid lines. In this position, the left-side augmented mirror 5 is showing a view generally facing south.

Fourth, as the automobile 100 ends the left turn, FIG. 25B, two positions of the left-side augmented mirror 5: First, in the presence of the micro-controller 200 changes, and second in the absence of the micro-controller changes, are shown with solid and dotted lines respectively. Next the proposed embodiment quickly returns the left-side augmented mirror 5 to its neutral position, corresponding to the position shown with dotted lines. This concludes the operations of the proposed embodiment on the left-side augmented mirror 5 during a left turn.

Therefore, the DACU-9 790 moves the left-side augmented mirror 5 into positions with key viewing angles during left turns. Furthermore, it moves the left-side augmented mirror 5 in a way that the left-side augmented mirror 5 produces steady, slow moving, viewing background during left turns.

In summary, referring to FIG. 1, in the absence of the DACU-9(α, side=0) 790, the left-side augmented mirror 5 views during a left turn spans the south east corner of the intersection 10, while with the DACU-9(α, side=0) 790, the view focuses on the traffic approaching the intersection 10 from south. The later view provides surveillance information that is highly relevant to making a safe left turn in regards to:

1) Avoiding collisions with traffic from south, especially in multi-lane intersections. Referring to the automobile 100 in FIG. 1, if there is another lane to the left of the automobile 100, then the automobile 100 becomes very vulnerable to traffic going north in that lane.
2) Avoiding collisions with a bicycle or a motorcycle following the automobile 100.
3) Giving the driver of the automobile 100 more time to concentrate on the traffic from other directions, by quickly informing the driver about the traffic from the south.

The above embodiment would work if we select DACU-9 790 to be the same as DACU-2 800.

### Embodiment 10

Embodiment 10 provides another method for dynamically adjustable mirrors, a method for the right-side augmented mirror 4 for a right turn and for the left-side augmented mirror 5 for a left turn. Embodiment 10 improves the view and it improves the surveillance for making a turn at intersections, more specifically the view and the surveillance of a road section into which the vehicle is turning.

At the heart of embodiment 10 is a Dynamically Adjustable Mirror Control Unit 10, DACU-10795 comprising 1) The micro-controller 200, 2) The digital-compass 500, 3) The turn-signal-switch 400, and 4) The stepper-motors 300 and 301. The connectivity of these components is as before.

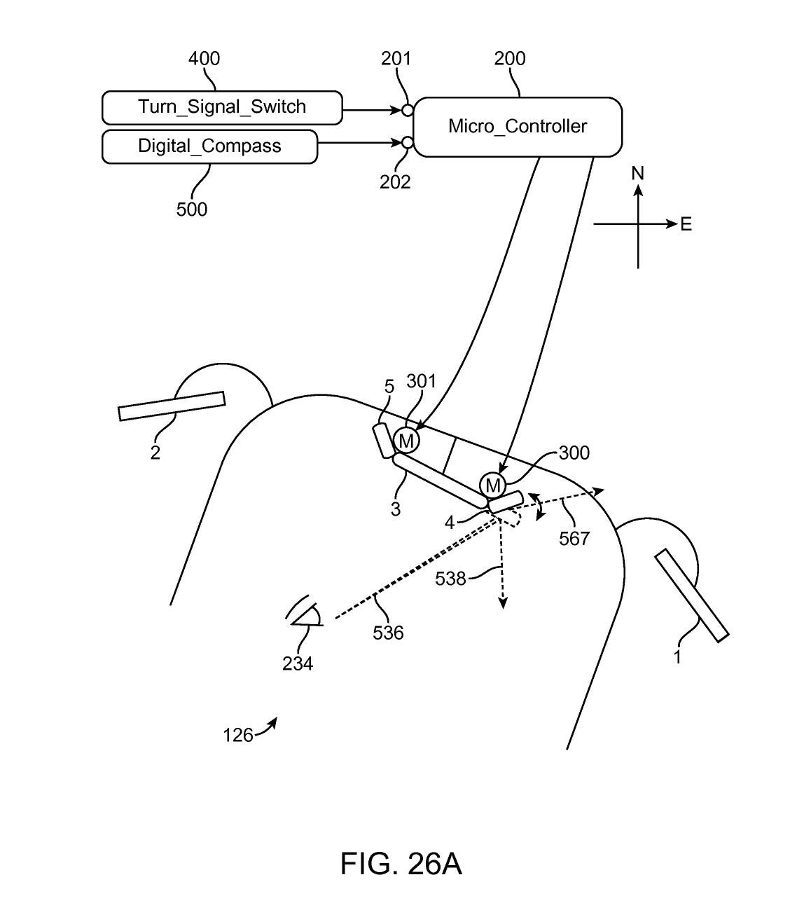

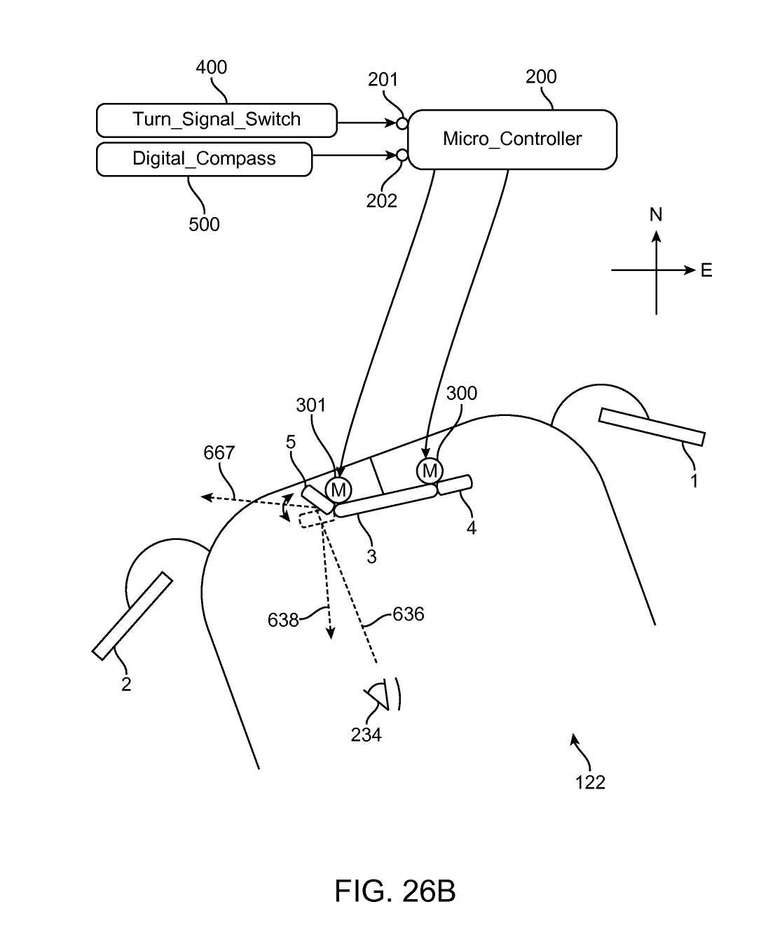

DACU-10(α, side=1), 795 relates to the right-side augmented mirror 4 during right turns, and DACU-10(α, side=0), 795 relates to the left-side augmented mirror 5 during left turns. We first describe DACU-10(α, side=1), 795 using FIGS. 21A and 26A. FIG. 21A relates to the automobile 100, position 120 during a right turn, and FIG. 26A relates to the automobile 100, position 126 during a right turn. These positions were depicted in FIG. 2.

FIG. 21A relates to the automobile 100 position 120 at the start of the right turn after a right turn is detected. The right-side augmented mirror 4 oriented as shown enables the driver 234 to view the field of vision 562 via the field of vision 536 of the right-side augmented mirror 4. FIG. 26A relates to the automobile 100 position during the right turn. The right-side augmented mirror 4 oriented as shown enables the driver 234 to view the field of vision 567 via the field of vision 536 of the right-side augmented mirror 4. The fields of vision 562 and 567 provide views of the road section into which the vehicle is turning.

On a right turn, the microcontroller 200 performs the following tasks with respect to the right-side augmented mirror 4.

First, a right turn is detected based on the turn signal switch 400 signal through the port 201.

Second, the right-side augmented mirror 4 position is depicted with dotted lines in FIG. 21A. In this position, the right-side augmented mirror 4 shows a view generally toward south. Once a right turn is detected, the micro-controller 200 quickly rotates the right-side augmented mirror 4 by about α=45 degrees counter-clockwise with respect to FIG. 21A top view reference. The micro-controller 200 uses the electric motor 300 to move the right-side augmented mirror 4. After this rotation, the view of the right-side augmented mirror 4 rotates about 90 degrees in counter-clockwise direction, generally facing east. The right-side augmented mirror 4 position after the rotation is depicted with solid lines in FIG. 21A.

Third, as the automobile 100 performs the right turn, the micro-controller 200 detects gradual changes in the direction of the automobile 100 based on the signal of the digital compass 500 through the port 202. Then the micro-controller 200 dynamically makes appropriate adjustments to the right-side augmented mirror 4 position through the motor 300, so that the right-side augmented mirror 4 continuously provides a view generally facing east.

Fourth, as the automobile 100 ends the right turn, the proposed apparatus, DACU-10795, quickly returns the right-side augmented mirror 4 to its neutral position, corresponding to the position it had before the right turn was detected. This concludes the operations of the proposed apparatus, DACU-10, 795, for the right-side augmented mirror 4 during a right turn.

A quick inspection shows: DACU-10(α, side=1), 795 is identical to DACU-1(α, side=1), 700. Therefore, we refer to DACU-1 for the details of DACU-10(α, side=1), 795.

In summary, referring to FIG. 2, in the absence of the DACU-10(α, side=1), 795, the right-side augmented mirror 4 view during a right turn spans the south west corner of the intersection 10, while with the DACU-10(α, side=1), 795, the view focuses on the traffic approaching the intersection 10 from east. The later view provides surveillance information that is highly relevant to making a safe right turn in regards to:

1) Avoiding collisions with incoming traffic from east.
2) Avoiding hitting pedestrians crossing the intersection between south/east and north/east corners of the intersection 10.
3) Giving the driver of the automobile 100 more time to concentrate on the traffic from north and the traffic from west, by quickly informing the driver about the traffic from east.
4) Informing the driver of the automobile 100 about traffic in the road section into which the vehicle is turning.

When the surveillance device is a mirror as in the description above, an upper bound to the rotation of the right-side augmented mirror 4 is desired, as in embodiments 4 and 5. However if the surveillance device is the camera 1100, then such upper bounds are not in general necessary, since in the former case, the viewing window of the right-side augmented mirror 4 shrinks as it rotates counter-clockwise while the viewing window of a camera would not necessarily shrink, for instance if we use the monitor 1105 inside the automobile 100.

Next we discuss the embodiment 10 for the left-side augmented mirror 5 during a left turn. The mirror 5 is connected to a DACU-10(α, side=0), 795 as follows.

We describe DACU-10(α, side=0), 795 using FIGS. 21B and 26B. FIG. 21B relates to the automobile 100, position 120 during a left turn, and FIG. 26B relates to the automobile 100, position 122 during a left turn. These positions were depicted in FIG. 1.

FIG. 21B relates to the automobile 100 position 120 at the start of the left turn after a left turn is detected. The left-side augmented mirror 5 oriented as shown enables the driver 234 to view the field of vision 662 via the field of vision 636 of the left-side augmented mirror 5. FIG. 26B relates to the automobile 100 position during the left turn. The left-side augmented mirror 5 oriented as shown enables the driver 234 to view the field of vision 667 via the field of vision 636 of the left-side augmented mirror 5. The fields of vision 662 and 667 provide views of the road section into which the vehicle is turning.

On a left turn, the microcontroller 200 performs the following tasks with respect to the left-side augmented mirror 5.

First, a left turn is detected based on the turn signal switch 400 signal through the port 201.

Second, the left-side augmented mirror 5 position is depicted with dotted lines in FIG. 21B. In this position, the left-side augmented mirror 5 shows a view generally toward south. Once a left turn is detected, the micro-controller 200 quickly rotates the left-side augmented mirror 5 by about α=45 degrees clockwise with respect to FIG. 21B top view reference. The micro-controller 200 uses the electric motor 301 to move the left-side augmented mirror 5. After this rotation, the view of the left-side augmented mirror 5 rotates about 90 degrees in clockwise direction, generally facing west. The left-side augmented mirror 5 position after the rotation is depicted with solid lines in FIG. 21B.

Third, as the automobile 100 performs the left turn, the micro-controller 200 detects gradual changes in the direction of the automobile 100 based on the signal of the digital compass 500 through the port 202. Then the micro-controller 200 dynamically makes appropriate adjustments to the left-side augmented mirror 5 position through the motor 301, so that the left-side augmented mirror 5 continuously provides a view generally facing west.

Fourth, as the automobile 100 ends the left turn, the proposed apparatus, DACU-10795, quickly returns the left-side augmented mirror 5 to its neutral position, corresponding to the position it had before the left turn was detected. This concludes the operations of the proposed apparatus, DACU-10, 795, for the left-side augmented mirror 5 during a left turn.

A quick inspection shows: DACU-10(α, side=0), 795 is identical to DACU-1(α, side=0), 700. Therefore, we refer to DACU-1 for the details of DACU-10(α, side=0), 795.

In summary, referring to FIG. 1, in the absence of the DACU-10(α, side=0), 795, the left-side augmented mirror 5 view during a left turn spans the south east corner of the intersection 10, while with the DACU-10(α, side=0), 795, the view focuses on the traffic approaching the intersection 10 from west. The later view provides surveillance information that is highly relevant to making a safe left turn in regards to:

1) Avoiding collisions with incoming traffic from west.
2) Avoiding hitting pedestrians crossing the intersection between south/west and north/west corners of the intersection 10.
3) Giving the driver of the automobile 100 more time to concentrate on the traffic from north and the traffic from east, by quickly informing the driver about the traffic from west.
4) Informing the driver of the automobile 100 about traffic in the road section into which the vehicle is turning.

When the surveillance device is a mirror as in the description above, an upper bound to the rotation of the left-side augmented mirror 5 is desired, as in embodiments 4 and 5. However if the surveillance device is the camera 1100, then such upper bounds are not in general necessary, since in the former case, the viewing window of the left-side augmented mirror 5 shrinks as it rotates counter-clockwise while the viewing window of a camera would not necessarily shrink, for instance if we use the monitor 1105 inside the automobile 100.

The following remarks help better describe the disclosure.

Remark 1: We suggest the following tools in measuring angular position:
A: If the intersection 10 is generally flat with little inclinations, use a compass; 2 or 3 dimensional. We used a three dimensional digital compass: 3 axes magneto-resistive sensor HMC5883L by Honeywell.
B: If the intersection 10 is generally flat with small inclinations, use a compass but correct for the inclinations using other sensors: tilt sensors, accelerometers, gyro stabilizers, etc.
C: If the intersection 10 is generally flat with inclinations, use a (pitch and roll) sensor. (We use the terminology used in “Applications of Magnetic Sensors for Low Cost Compass Systems,” by Michael J. Caruso, Honeywell, SSEC.)

The (pitch and roll) sensor could be a tilt sensor or any other sensor or combination of sensors for measuring (pitch and roll).

So far, we have only addressed A and B above. Now we explain C.

Rotation angle as a function of (pitch and roll):

We define the relationship between the rotation of the automobile 100 and (pitch and roll) in the next 4 steps:

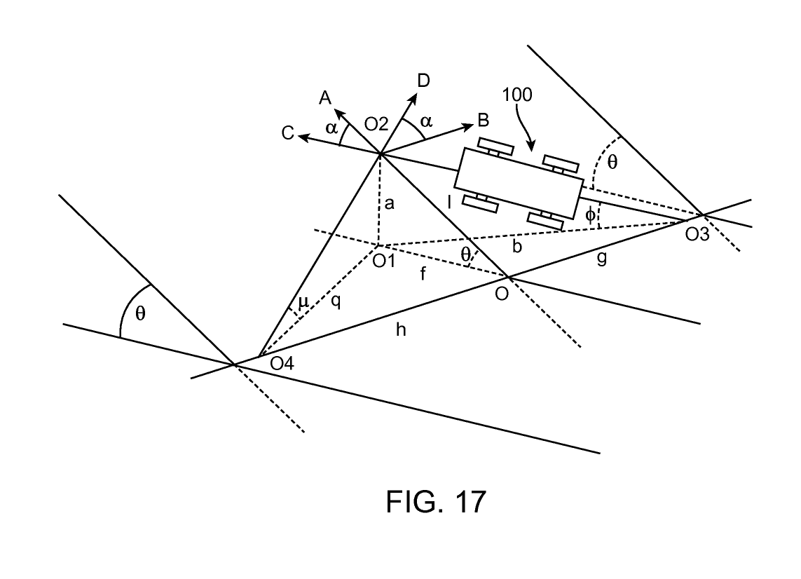

Step 1: Referring to FIG. 17, two planes are shown; the first plane, P1, contains line h and point O1, and the second plane, P2, contains line h and point O2. The plane P1 is a horizontal plane and the plane P2 represents the intersection 10 plane. Also depicted is the automobile 100. There are 4 important angles that are shown.

Angle θ: The angle between the planes P1 and P2.
0≦θ≦90°
Angle α: The angle between line OO2 and the direction of the automobile 100.
Angle φ: The angle between line O3O1 and line O3O2.
Angle φ is called pitch of the automobile 100.
sign(φ)>0 if the automobile 100 is heading upward.
Angle μ: The angle between line O4O1 and line O4O2.
(Line O4O2 is perpendicular to O3O2.)
Angle μ is called roll of the automobile 100.
sign(μ)>0 if the automobile 100 is tilted such that the passenger side is higher.
Step 2: With respect to the embodiments in this disclosure we are more interested in measuring rotation in the plane P2 than in the plane P1 since the automobile 100 and the intersection 10 are in the plane P2.
Step 3: When 0=0 (case A above) or 0=small (case B above), then the measurement of rotation in the plane P1 and the measurement of rotation in the plane P2 would be the same or very close. But when 0=not small, then the two measurement are not the same and we are interested in the measurement in the plane P2.

Step 4: Let us find the relationship between (θα) and (pitch roll)=(φ, μ).

We use the example of the FIG. 17, with the automobile 100 facing upward. We have:

f=I×cos(θ)
g=I×tan(α)

Therefore, b=sqrt(g²+f²)=I×sqrt(cos²(θ)+tan²(α)).

Now we also have

α=I×sin(θ)

Therefore, we have

tan(φ)=a/b, hence
φ=tan⁻¹ (a/b)=tan⁻¹(sin(θ)/sqrt(cos²(θ)+tan²(α))).

Similarly, we have

μ=tan⁻¹ (a/q)=tan⁻¹(sin(θ)/sqrt(cos²(θ)+cot²(α))).

Next we drive a in terms of φ and μ.

α=sin⁻¹(sqrt(U/(U+V))), where
U=sin²(μ) and V=sin²(φ).

The sign of α in general can be obtained from the sign of the pitch and sign of the roll, and the fact that because of gravity, the automobile 100 can only drive on one surface of the plane P2.

Now the rotation angle of the automobile 100 from a first position with α1 to a second position with α2 is: α2−α1.

Interestingly,

i) When (pitch and roll)=(φμ) are zeroes, we can't use the above equation for a to obtain rotation angle.
ii) When (pitch and roll)=(φμ) are small, we can't use the above equation for a to obtain rotation angle reliably since a small noise can cause a big measurement error.
iii) When (pitch and roll)=(φμ) are not small, we can use the above equation for a to obtain rotation angle.

Therefore, in one or more embodiments, when (pitch and roll) are zeroes or small, we use a compass based sensor for evaluating the angle of rotations. But when (pitch and roll) are not small, then we use a (pitch and roll) based sensor.

Again by “compass based” sensor we mean any of the followings: compass, compass and tilt sensor, compass and tilt sensors and accelerometers, or etc.

And by “(pitch and roll) base” sensor we mean any of the followings: (pitch and roll) sensor, tilt sensor, tilt sensor and accelerometer, or etc.

If the micro-controller 200 uses the compass based sensors for all intersections, then the angle of rotation will be less accurate when the intersection 10 is on a plane P2 with a large slope. Therefore, to increase robustness, the micro-controller 200, can first use a (pitch and roll) sensor to decide how to measure the angle of rotation.

Many digital compasses have calibration features. Calibrating the compass at least on start up is recommended.

Nevertheless, magnetic based sensors may be the best for solving the problems addressed here because the problems in this disclosure differ from other ones.

Remark 2: A tool that improves the performance of sensors is filtering. Filtering cleans up certain types of noises and improves the performance of the sensor.

Low pass, high pass, band pass, and Kalman are among famous filtering. Please see “Professional Android Sensor Programming,” Greg Milette, and Adam Stroud, Publisher is Wrox Publisher, Jun. 5, 2012, Part II: Inferring Information from Physical Sensors.

Our method based on the parameter DIFF (note 2 above) is a kind of filtering.

Remark 3: Instead of having two DACU's for each mirror, one can use just one. For example, referring to the right-side mirror 1 of FIG. 1, instead of having the DACU-1 700 for left turns and the DACU-2 800 for right turns, we can modify one of the DACU's to handle both turns, especially since as we have seen, the DACU-2 800 performs only a subset of the tasks that the DACU-1 700 performs.
Remark 4: We can generalize Remark 3). Specifically, we can use one micro-processor to control both the right-side mirror 1 and the left-side mirror 2. One way to accomplish this task is to do “time sharing”. In time-sharing, there is one stepper-motor 300 assigned to the right-side mirror 1 and there is another stepper-motor 300 assigned to the left-side mirror 2. The stepper-motor 300 assigned to the right-side mirror 1 is connected to the CPU 250 through the I/O port 204, and the stepper-motor 300 assigned to the left-side mirror 2 is connected to the CPU 250 through another I/O port 205. The CPU 250 first processes the right-side mirror 1, and controls it by the stepper-motor 300 connected to the I/O port 204. Next the CPU 250 processes the left-side mirror 2, and controls it by the stepper-motor 300 connected to the I/O port 205.
Note 1: Since the arithmetic computations are very similar for side=0 and side=1, they can be done once, and then the results can be used for both the right-side mirror 1 and the left-side mirror 2, wherever possible.
Note 2: The following changes will help the same CPU 250 to control several mirrors.

Referring to FIG. 10, in the embodiments, as mentioned earlier, the micro-controller 200 is acting as the controller 310 for the stepper-motor 300. One way to reduce the interdependency is to use an external controller 310 and a buffer 330. The micro-controller 200 would send its motor operating commands to the buffer 330. Then the controller would fetch the commands one by one, turning them into appropriate signals for the motor 300 driver. Please see “Programmable Microcontrollers with Applications MSP430 LaunchPad with CCS and Grace” by Cem Ünsalan and H. Deniz Gürhan, copyright © 2014 by McGraw-Hill Education, and “Microcontrollers and Microcomputers Principles of Software and Hardware Engineering” by Frederick M Cady, (Jun. 19, 2009), Oxford University Press, USA; 2 edition (Jun. 19, 2009).

Remark 5. We give the terminating conditions for DACU-1, 700 below. Any one of these conditions can be used in the D portion of the instructions.
Terminate condition 1: (given in the instructions)

If the timer 280>T1; [terminate] [T1 is a predetermined value, in this embodiment T1=10 seconds, if we expect the average length of a turn to be 10 seconds.]

Terminate condition 2. if the counter 290>C1; [terminate] [C1 is a predetermined value; and it relates to the length of the turn in feet; if each pulse from the odometer 600 indicates one full rotation of the tire wheel of the automobile 100, then C1=floor(the distance of the turn/C), where C is the circumference of the tire wheel.]

Referring to FIG. 1, if the automobile 100 is slow in making the left turn because of traffic, then the terminate condition 1 might be reached prematurely.

On the other hand if the turn is much longer than C*C1 feet, then the terminating condition 2 might be reached prematurely.

The condition 3 below offers a good compromise.

Terminate condition 3. If the timer 280>T1 AND if the counter 290>C1 [terminate]

Terminate condition 4. Referring to variable Q1 in part D of the CPU instructions, for cases based on the second method of updating, we have:

The angle between the initial direction of the digital-compass 500 and the current direction of the digital-compass 500=(Q1 360/2¹⁰) degrees.

if absolute(90−(Q1*360/2¹⁰))<Th1 [terminate][Th1 is a predetermined small angle.] [Base on the assumption that the turn is almost 90°.]

Terminating condition 5. Any combination of the condition 4 with one or more of the other conditions.

For DACU-2(α,side) 800, four terminating conditions are given below. Any one of these conditions can be used in the instructions, in part D.

Terminating condition 1: The same as above.
Terminating condition 2: The same as above.
Terminating condition 3: The same as above.
Terminating condition 4:

If absolute value (α−(Q1*360/2¹⁰)) is less than Th1, then [terminate][Th1 is a predetermined small angle.]

In other words, if the automobile 100 completes about a degrees rotation during a turn we terminate the operation of the DACU-2 800.

Terminating condition 5: Any combination of the condition 4 with one or more of the other conditions.
Remark 6: With this remark we answer the question, “Could the DACU's operate without a compass, or a tilt detector?”

In general, the answer is yes. All we need to measure is the angle the automobile 100 is making during a turn with respect to its original position at the start of the turn.

In addition to using very sophisticated relationships that can be found under “dead reckoning”, we offer a relatively simple approximate solution below.

Let's assume the car has a steering wheel 1500, and a wheel encoder 1510 that measure the steering wheel angular location. Let's assume the wheel encoder 1510 is connected to the CPU 250 through one of the CPU 250 ports.

Further, let's assume that every time a tire wheel makes a full turn, the odometer 600 sends a digital pulse to the CPU 250. Let's have the counter 290 to count the odometer 600 pulses. Now, for every P (for example P=3) count of the counter 290, let's store the steering wheel 1500 position in a variable, wheel-angle.

Next let's have the CPU 250 perform

car-angle=car-angle+wheel-angle,
where the variable, car-angle, is initialized to zero at the beginning of the turn.

Now, the variable, car-angle, is approximately proportional to the true angle, true-car-angle. Let g denote the constant of the proportionality. The constant, g, depends on the wheel encoder 1510.

Also please not that for small angle (in radians) angle≈ sin (angle)≈ tan (angle)

Therefore, true-car-angle=car-angle/g (in radians).

Now we can use the absolute value of (true-car-angle*1024/(2pi)) for Q1, and we can use -sign(wheel-angle) as Q2 in the embodiments, avoiding compasses and tilt sensors. Remark 7: Dynamically adjusting motions

Below are several ways a view belonging to a mirror can dynamically adjust to a turning automobile. Let τ(t) denote the total rotation angle of the automobile at time t.

1) Gradually turn by τ(t) degrees
2) Gradually turn by τ(t)*factor degrees, 0<factor<1.
3) Gradually turn by −τ(t)*factor degrees, 0<factor<1.

### 4) Remain fix

5) Gradually follow F(τ), where F is a predetermined function of T.

Update rules for 1-4 above are given in Appendix 4.

To get the motion in 5,

a) We store F in the micro-controller, either as a function or in a table form (values of F for distinct values: τ1, τ2, τ3, and etc.)
b) Let τ* denote the measured rotation angle of the automobile at an instant, t. We want the mirror to dynamically adjust to τ* by producing a view in the direction F(τ). (τ is the closest τ1, τ2, τ3, and etc., to τ*.)

In order to generate the desired view in the direction F(τ), the mirror needs to rotate by an angle given in Appendix 2. The mirror can be rotated with updates according to either rule 1 or rule 2 methods. These methods have been given earlier.

Remark 8: Referring to FIG. 1, let's suppose the angle τ is not 90°. Further, suppose the micro-controller 200 is given the angle τ. Then the following modifications would improve the overall performance of the embodiments.

We consider 3 cases if τ<90°:

1) On a left turn, for the right-side mirror 1:
The micro-controller 200 sets α=τ/2.
Result: The DACU-1(α, side=1) 700, will rotate the right-side mirror 1 by α=τ/2 CCW. Hence the view will be in the direction of the traffic coming from the right side of the intersection 10.
2) On a left turn, for the left-side mirror 2:
The micro-controller 200 sets α=τ.
Use terminating condition 4, in Remark 5 for the DACU-2 800. This will cause the DACU-2 800 to terminate close to the end of the turn.
3) On a right turn, for the left-side mirror 2:
Use DACU-3-1 (α, side=0) 710, but modify it such that β+2α=180−τ.
Result: After the first stage of the right turn, the general view of the left-side mirror 2 will be toward incoming traffic from the left side.

And we consider three cases if τ>90°

1) On a right turn, for the left-side mirror 2:
The micro-controller 200 sets α=τ/2
2) On a right turn, for the right-side mirror 1:
The micro-controller 200 sets α=τ.

Use terminating condition 4, in Remark 5 for DACU-2 800.

3) On a left turn, for the right-side mirror 1: Use DACU-3-1 (α, side=1) 710, but modify it such that 13+2α=τ.

1.

Now, information on τ can be provided to the micro-controller 200 by a GPS unit, either through waypoints or other means.

A GPS unit can provide another useful side information to the DACU's—information on how close the automobile 100 is to the intersection 10. This information can be used by the CPU 250 to:

Referring to FIG. 1, we generalize the definition of the angle τ such that it referrers to the angle between the automobile 100 and the east-west street. When the automobile 100 is in the position 120, the two definitions τ agree because the automobile 100 is in the direction of the street in south-north direction. However, assume the automobile 100 is waiting in the intersection 10 and it is not in the south-north direction but it is in a somewhat north-east direction, having already made a partial right turn before stopping at the intersection. Further assume the right signal is turned on after the stop. In this situation, turning the left-side mirror 2 by a predetermined angle α might overshoot the view toward north-east instead of the desired view—east.

We briefly suggest two solutions to alleviate this overshoot problem:

1) Without using a GPS:
After receiving a right turn signal, have the micro-controller modify the predetermined angle α based on recent, net changes in the angular position of the automobile 100. If recent, net changes is negligible then do not change the angle α, but if recent, net changes is noticeable, then modify the angle α accordingly.

### 2) Using a GPS:

Receive the angular direction of the intersecting street from GPS. Then modify the predetermined angle α based on the current angular direction of the automobile 100 and the angular direction of the intersecting street.
1) Signal the start of the operation of the DACU's, especially for the right-side mirror 1 during a left turn and the left-side mirror 2 during a right turn, or
2) Signal the termination of the operation of the DACU's.
Please see the reference below.
“GPS Satellite Surveying” by Alfred Leick, John Wiley & Sons, Inc. publisher, 2004.
   Remark 9: If we replace the right-side mirror 1 with the small digital video camera 1100, then the DACU-1 700 and the DACU-2 800, can control the views of the camera 1100 during turns as before. The small monitor 1105 in the automobile 100 can provide these views to the driver of automobile 100.

Other mirrors on the automobile 100 can be replaced by cameras similarly. The dynamically adjustable direction of the view toward key views is how this use of cameras may differ.

Since the stepper-motor 300 of the DACU's can dynamically control any mirrors, lenses or cameras to generate key views, we generalize the scope of the embodiments to all surveillance devices that provide visual information to the driver of the automobile 100.

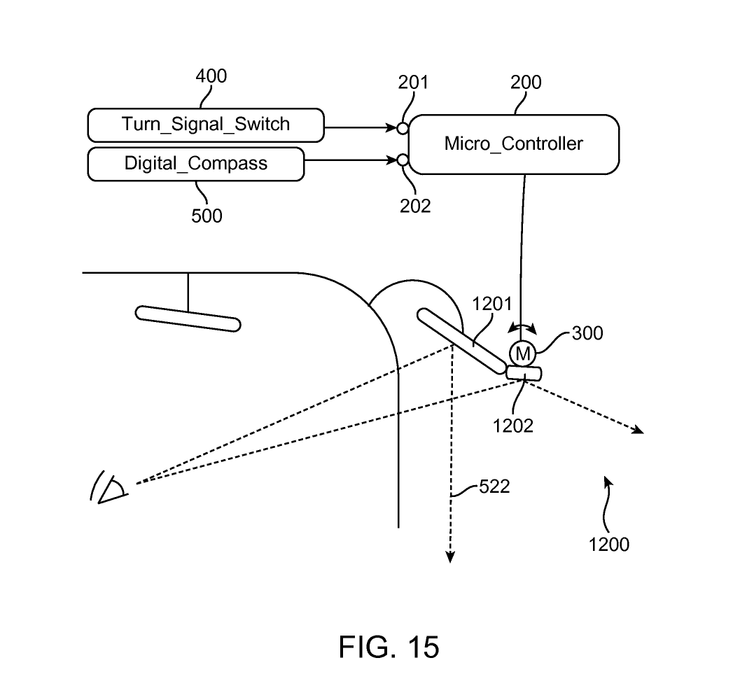

Remark 10: To have the advantages of both a traditional right-side mirror and a right-side mirror according to this application, we can have a right-side mirror 1200 comprising a first right mirror 1201 and a second right mirror 1202, where the first right mirror 1201 is a traditional right mirror and the second right mirror 1202 is a right mirror according to this application. Referring to FIG. 15, the right-side mirror 1200 is shown. The first right mirror 1201 and the second right mirror 1202 are shown too. The second right mirror 1202 is controlled by one of the DACU's according to this application. We can have a similar mirror for the left side as well.
Remark 11: The embodiments 1-7 also improve the views of the mirrors of the automobile 100 during lane changes.

For instance, in normal situation, when we signal to pass, our view on the left-side mirror 2 is generally toward vehicles in the lane to our left. But while making the lane change the view moves toward vehicles in the lane we are moving from. However, with the DACU-2 800 method, while making the lane change the view generally stays toward the vehicles in the lane we are moving into. In a similar way, when we change from our lane to the lane to our right, the right-side mirror 1 view benefits from DACU-2, 800 apparatus.

Remark 12: If desired, each DACU can be de-activated, when the automobile 100 is in reverse. To this end, in terms of hardware, many micro-controllers have more I/O ports than were utilized in the embodiments. Typically, each port comprises a set of I/O pins.

One unused pin can be assigned to communicate the information that the automobile 100 is in reverse. In terms of software, the instructions for the DACU need to terminate the operation of the DACU when the automobile 100 is in reverse.

Remark 13: The parameter a of the DACU's can be made programmable. This would offer more flexibility to the driver of the automobile 100. Programming a parameter is typically done in three steps.
Step 1) put the CPU 250 into parameter customization mode Step 2) parameter definition mode
Step 3) exit parameter customization mode

Each of the Steps 1)-3) can be done by either sending a signal to the CPU 250 through a customized pin or sending a customized sequence of signals through regular pins. Other parameters of the DACU's can be made programmable similarly.

Remark 14: In general, given a mirror we are interested in the following ratio: R (small change in angle of rotation of the mirror/(small change in angle of the view) For planner mirrors we use R=0.5. Therefore, to achieve a given change in the angle of the view, cav, we rotate the mirror by R*cav degrees.

R=0.5 is also a good approximation for most non-planer mirrors for automobiles. However, for more accurate operation with non-planner mirrors, we need to

1) Measure R as a function of the rotational position of the mirror.
2) To achieve a given change in angle of the view, cav, we rotate the mirror by R(crp)*cav degrees, where crp=the current rotational position of the mirror.

### APPENDIX 1

### Q1 and Q2 Calculations

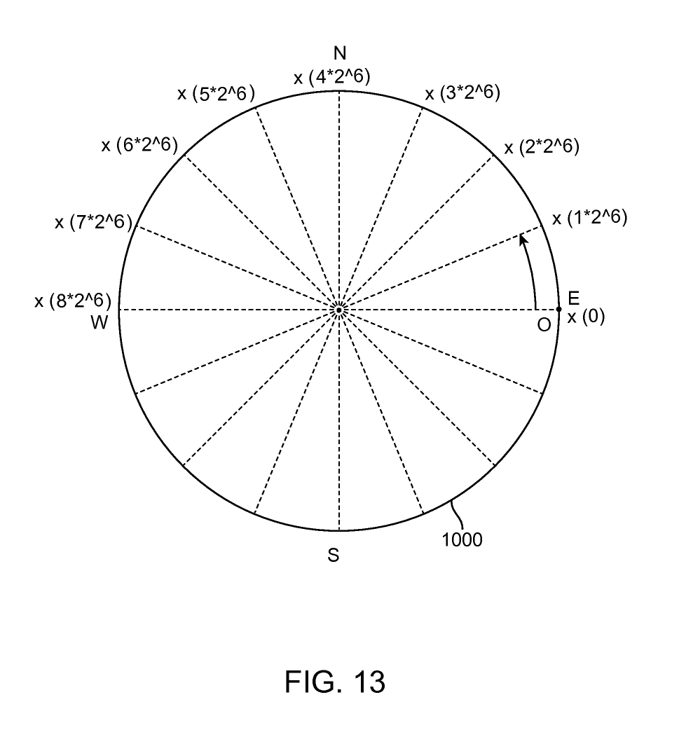

Referring to FIG. 13, a circle 1000 is shown. A point labeled ‘0’ is marked on its circumference. Angles are measured counter-clock-wise from ‘0’.

FIG. 13 is used to relate 4 sets: S1, S2, S3, and S4 below.

Points x(0), x(1), . . . , x(2¹⁰−1) are marked on the circumference of the circle 1000 such that x(0) coincides with ‘0’ and

x(i), 1≦i≦2¹⁰−1, is at an angle (i*360/2̂10) degree. Some of the x's are shown.

Now, S1={x(i): 1≦i≦2¹⁰−1}, and S2={compass directions in the directions of angle (i*360/2̂10), 1≦i≦2¹⁰−1 on the circumference}. A few of the compass directions are shown.

Also S3={10 bits values of the digital-compass 500} and S4={angle at i*360/2̂10 degree: 1≦i≦2¹⁰−1}.

Sets S1-S4 relate to each other in the obvious and trivial way.

To show S1=>S2:

Map12: Map point x(i) to compass direction i*360/2̂10i, for 1≦i≦2¹⁰−1.

To show 52=>53:

Map23: Map compass direction i*360/2̂10i, for 1≦i≦2¹⁰−1, to the digital-compass 500 output that is binary representation of i.

To show S3=>S4:

Map34: Let dc=(dc(θ) dc(1) . . . dc(9)) be the output of the digital-compass 500. Map dc to the angle i*360/2̂10 degree, where i is the base 10 representation of dc.

To show S4=>S1:

Map41: Map the angle i*360/2̂10 degree, 1≦i≦2¹⁰−1, to x(i).

The rest of this appendix shows how to calculate Q1 and Q2.

Given two directions of the digital-compass:
compass-direction-new (10 bits)
compass-direction-old (10 bits)

We are interested in calculating two quantities: Q1 and Q2

Let q1=the angle from compass-direction-new to compass-direction-old. We note that the convention is: counter-clock-wise, positive and clock-wise, negative.

Q1=Map23(Map12(Map41(magnitude(q1))))
Q2: sign(q1)

Note: We assume magnitude(q1)<180°, equivalently Q1<2⁹. This assumption is based on the expectation that the automobile 100 does not move fast enough to cause ≧180° change in the digital-compass 500 output during two consecutive readings of the output. The longest delay between two readings is kept below 1 second.

Quantities Q1 and Q2 are generated as below:

### Case 1:

(compass-direction-new)>(compass-direction-old)
(compass-direction-new)−(compass-direction-old)<2⁹
Q1=(compass-direction-new)−(compass-direction-old)
Q2=0 (clock-wise, negative)

### Case 2:

(compass-direction-new)>(compass-direction-old)
(compass-direction-new)−(compass-direction-old) 2⁹

### Q1=

2¹−((compass-direction-new)−(compass-direction-old)
Q2=1 (counter-clock-wise, positive)

### Case 3:

(compass-direction-new)≦(compass-direction-old)
(compass-direction-old)−(compass-direction-new)<2⁹
Q1=(compass-direction-old)−(compass-direction-new)
Q2=1 (counter-clock-wise, positive)

### Case 4:

(compass-direction-new)≦(compass-direction-old)
(compass-direction-old)−(compass-direction-new) 2⁹

### Q1=

2¹⁰−((compass-direction-old)−(compass-direction-new)
Q2=0 (clock-wise, negative)

### APPENDIX 2

### Mirror View Direction

We use the following convention. We say a rotation is alpha (alpha>0) degrees if it is counter-clock-wise, and we say a rotation is alpha (alpha≦0) degrees if it is clock-wise.

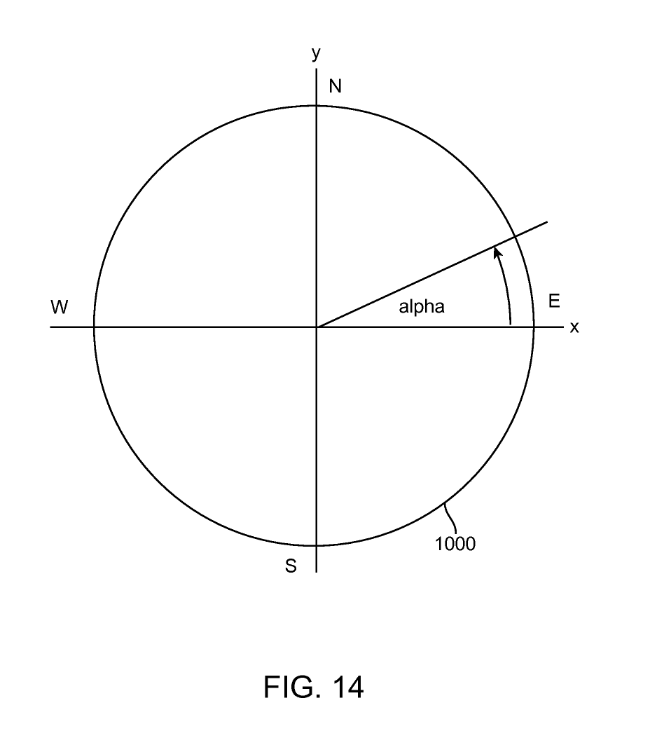

On an x-y coordinates system, FIG. 14, lets measure angles from positive x axis in counter-clockwise direction. Also let's assign north, south, east, and west directions such that north is +y direction, so on.

Lemma: Let's consider an initial angular position for an automobile, alpha-car-initial, and let's assume the view from one of the mirrors is from direction, mirror-view-initial. If the automobile 100 changes its position such that now its angular position is alpha-car-current, and if the mirror makes a rotation with respect to the automobile by rotation-mirror, then the current view of the mirror is at the direction, mirror-view-current, where

mirror-view-current=mirror-view-initial+(rotation-mirror)*2+
(alpha-car-current)−(alpha-car-initial)
Proof: straightforward

### Corollary 1:

If the mirror does not rotate (rotation-mirror=0), then

mirror-view-current−mirror-view-initial=
(alpha-car-current)−(alpha-car-initial)

Therefore, the view from the mirror follows the automobile rotation.

Corollary 2:

If the mirror rotates half the automobile rotation, and if it rotates in the opposite direction as the automobile rotation, then the direction of the view in the mirror stays the same.

Proof: Use the equation above with (rotation-mirror)*2=−((alpha-car-current)−(alpha-car-initial))

Therefore, mirror-view-current=mirror-view-initial

### APPENDIX 3

Given an angle α°, calculate the number of steps the stepper-motor 300 shaft needs in order to rotate absolute(α°).

Since the stepper motor 300 has 400 steps (in half stepping mode), each step covers 0.9°. Since we want absolute(α°) rotation, we need to promote the stepper-motor 300 shaft by floor(absolute(α°)/0.9° steps. (absolute(x) is the absolute value function of x, and floor(x) denotes the floor function of x.)

### APPENDIX 4

We would like to know how to achieve the following situations:

1) The automobile 10 making a gradual turn of τ degrees and the direction of the view of the right-side mirror 1 is making a gradual turn of τ degrees
2) The automobile 10 making a gradual turn of τ degrees and the direction of the view of the right-side mirror 1 remains fixed
3) The automobile 10 making a gradual turn of τ degrees and the direction of the view of the right-side mirror 1 is making a gradual turn of τ*factor degrees, 0<factor.
4) The automobile 10 making a gradual turn of τ degrees and the direction of the view of the right-side mirror 1 is making a gradual turn of −τ*factor degrees, 0<factor.
Situation 1) This is achieved if we do not rotate the stepper-motor 300.
Situation 2) This is achieved if we follow the steps given in the instructions list D. More specifically, as the automobile 100 is making, A°, rotation, we rotate the right-side mirror 1 by −Δ°/2. (Appendix 2)
Situation 3) From Appendix 2, we have
(mirror-view-current)=(mirror-view-initial)+(alpha-mirror)*2+
(alpha-car-current)−(alpha-car-initial)

After the automobile 100 makes beta rotation, we have

(mirror-view-current)=(mirror-view-initial)+(alpha-mirror)*2+
beta
(mirror-view-current)−(mirror-view-initial)=(alpha-mirror)*2+
beta

But we would like to have

(mirror-view-current)−(mirror-view-initial)=factor*beta,
therefore,
factor*beta=beta+2*(alpha-mirror).

Hence (alpha-mirror)=beta*(factor−1)/2; 0<factor

Therefore, in the instruction list D, we make the following change:

Replace

H1=floor(Q1*0.1953125) with
H1=floor(Q1*0.1953125*(1−factor)).

### Situation 4)

From Appendix 2, we have

(mirror-view-current)=(mirror-view-initial)+(alpha-mirror)*2+
(alpha-car-current)−(alpha-car-initial)

After the automobile 100 makes beta rotation, we have

(mirror-view-current)=(mirror-view-initial)+(alpha-mirror)*2+
beta
(mirror-view-current)−(mirror-view-initial)=(alpha-mirror)*2+
beta

But we would like to have

(mirror-view-current)−(mirror-view-initial)=−factor*beta,
therefore,
−factor*beta=beta+2*(alpha-mirror).

Hence

(alpha-mirror)=beta*(−factor−1)/2; 0<factor

Therefore, in D we make the following change:

Replace

H1=floor(Q1*0.1953125) with
H1=floor(Q1*0.1953125*(1+factor)).

Although the invention has been discussed with reference to specific embodiments, it is apparent and should be understood that the concept can be otherwise embodied to achieve the advantages discussed. The preferred embodiments above have been described primarily as dynamically adjustable mirror systems for moving vehicles. In this regard, the foregoing description of the dynamically adjustable mirror systems for moving vehicles is presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments, and with various modifications considered necessary by the particular application(s) or use(s) of the present invention.

Instructions to the DACU-4(α1, α, α2, 1) 750

//set up the library
//============================================================
#include <AFMotor.h>
// Adafruit Motor shield library
// copyright Adafruit Industries LLC, 2009
// this code is public domain
//============================================================
#include <Wire.h> // Arduino
//=============================================================
// measure delay
unsigned long time_1;
unsigned long time_2;
// speed of serial communication
int speed = 9600; //
// stepper motor related
// Number of full steps per revolution of stepper motor
const int STEPS = 200;
// motor used half stepping => 400 steps, therefore 50 steps = 45 degrees
const int alpha = 50;
const int RPM = 10; // speed of the stepper motor in rpm
const int DIFF = 2; // simple filtering =0 no filtering
const int number_steps_before_first_initialization = 10; // motor initialization
parameter
//clock related
const int time_in_between_single_steps = 5; // 1/200 second
const int t1 = 5; // 1/200 second
const int time_to_complete_left_turn = 10000; // 10 second
// Initialize the Stepper class 1 = > ports 1 & 2, bipolar motor
AF_Stepper motor(STEPS, 1);
// switches
int SW0 = 14; // “microswitch 340” conected to pin 14
int SW1 = 15; // “microswitch 350” conected to pin 15
int SIGNAL = 16; //“turn_signal_switch 400” (left signal switch) connected to pin
16
// the digital-compass 500 bits 1-10 connected to pin 21-30
int DC[ ]= {21 22 23 24 25 26 27 28 29 30};
// switch values 1=ON 0=OFF
unsigned char sw0 = 0;
unsigned char sw1 = 0;
unsigned char signal = 0;
// digital-compass 500 bit values 1=HIGH 0=LOW
unsigned char dc= 0;
// motor position
int task = 0; // 0 = motor at home; 1 = motor not at home
// left turn signal
int s_o = 0; int s_n = 0;
// digital compass
int c_o = 0; //old value
int c_n = 0; //new value
int c_i = 0; //initial value
// angles 1024 = 360 degree
int V_old = 0; int V = 0;
// directions 0=CW CCW
int D_old = 0; int D = 0;
//function
//updates
void UPDATE_1( )
{s_o = s_n; c_o = c_n; delay(t1); }
//function: initialize the motor to its inital position
void motor_initialization( )
{// forward = CCW
sw0 = digitalRead(SW0);
while (sw0 == HIGH) {
motor.step(1, BACKWARD, INTERLEAVE);
delay(time_in_between_single_steps);
sw0 = digitalRead(SW0);
}}
//function: /rotate the motor alpha steps
void rotate_alpha( ) {
task = 1; // indicates motor not in its initial position
c_i = c_n; //update compass;
time_1 = millis( ); // start a timer for termination rule
// Move motor SM_Steps
motor.step(alpha, FORWARD, INTERLEAVE);
V_old = 0; D_old = 1; }
//function: compute V and D
void compute_V_E( ) {
if (c_n > c_i) {
if (c_n - c_i < 512) {
V = c_n - c_i;
D = 0; }
else if (c_n - c_i >= 512) {
V = 1024 - (c_n - c_i);
D = 1; } }
else if (c_n <= c_i) {
if (c_i - c_n < 512) {
V = c_i - c_n;
D = 1; }
else if (c_i - c_n >= 512) {
V = 1024 - (c_i - c_n);
D = 0;
} } }
void setup( ) {
//Initialize Serial communication
Serial.begin(9600);
// Define physical connections:
pinMode(SW0, INPUT); //microswitch 340 is an input to microcontroller
pinMode(SW1, INPUT); //microswitch 350 is an input to microcontroller
pinMode(SIGNAL, INPUT); //turn_signal_switch 400 (left turn one) is an input
//the digital-compass 500 is an input to micro-controller
for ( int i=0; i<10;i++)
{ pinMode(DC[i], INPUT); }
// set motor speed and initialize
motor.setSpeed(RPM); // rpm
motor.step(number_steps_before_first_initialization , FORWARD, SINGLE);
motor_initialization( );
motor.release( );
delay(t1);
}
void loop( ) {
// Read I/O
// Read left turn switch of the turn_signal_switch 400
s_n = 0;
signal = digitalRead(SIGNAL);
if (signal == HIGH) {
s_n = 1;
}
// Read digital compass 10 bits
c_n=0;
for ( int i=0; i<10;i++) {
c_n=2*c_n;
dc= digitalRead(DC[i]);
if (dc ==HIGH) {c_n=c_n+1;}}
delay(t1);
// BRANCHING CASES
// 6 Cases
//Case 1: Continue turn off; motor is its initial position
if ( s_o == 1 && s_n == 0 && task == 0 ) {
UPDATE_1( );
}
//Case 2: Turn off; motor not in initial position
else if ( s_o == 1 && s_n == 0 && task == 1 ) {
// Move motor to initial position
motor_initialization( );
task = 0; // Motor is at initial position
UPDATE_1( );
}
// Case 3: Turn on; motor is in its initial position
else if ( s_o == 0 && s_n == 1 && task == 0 ) {
rotate_alpha( ); // rotate by alpha
delay(t1);
UPDATE_1( );
}
// CASE 4: Continue off; motor is in its initial position
else if ( s_o == 0 && s_n == 0 && task == 0) {
UPDATE_1( );
}
// Case 5: Continue on; motor not in its initial position
else if ( s_o == 1 && s_n == 1 && task == 1 ) {
time_2 = millis( );
if (time_2 - time_1 > time_to_complete_left_turn) {// terminate
Serial.println(“TIME'S UP”);
motor _initialization( ); // initialize the motor
delay(t1); //half a second delay
task = 0;
}
else {// do not terminate
compute_V_E( );
// V magnitude; D direcion
// Calculate number of steps [half stepping]:
V = floor(0.1953 * float(V)); // 400 steps = 1024
// 8 sub-cases
// 1 D = D_old V > V_old D = 0
// 2 D = D_old V > V_old D = 1
// 3 D = D_old V = V_old D = 0
// 4 D = D_old V = V_old D = 1
// 5 D = D_old V < V_old D = 0
// 6 D = D_old V < V_old D = 1
// 7 D != D_old D = 0
// 8 D != D_old D = 1
// ===========================================
if ( D == D_old && V > V_old && D == 0) {
int diff = V - V_old;
sw0 = digitalRead(SW0); // Read state of start signal
while (sw0 == HIGH && diff > 0) {
diff = diff - 1;
V_old = V_old + 1;
motor.step(1, BACKWARD, INTERLEAVE);
delay(time_in_between_single_steps);
sw0 = digitalRead(SW0);
}
}
else if ( D == D_old && V > V_old && D == 1) {
int diff = V - V_old; int diff1 = diff;
sw1 = digitalRead(SW1); // Read state of start signal
while (sw1 == HIGH && diff > 0 && diff1 > DIFF) {
diff = diff - 1;
V_old = V_old + 1;
motor.step(1, FORWARD, INTERLEAVE);
delay(time_in_between_single_steps);
sw1 = digitalRead(SW1);
}
}
else if (D == D_old && V == V_old && D == 0) {
}
else if (D == D_old && V == V_old && D == 1) {
}
else if (D == D_old && V < V_old && D == 0) {
int diff = V_old - V; int diff1 = V_old - V;
sw1 = digitalRead(SW1); // Read state of start signal
while (sw1 == HIGH && diff > 0 && diff1 > DIFF) {
diff = diff - 1;
V_old = V_old - 1;
motor.step(1, FORWARD, INTERLEAVE);
delay(time_in_between_single_steps);
sw1 = digitalRead(SW1);
}
}
else if ( D == D_old && V < V_old && D == 1) {
int diff = V_old - V;
sw0 = digitalRead(SW0); // Read state of start signal
while (sw0 == HIGH && diff > 0 ) {
diff = diff - 1;
V_old = V_old - 1;
motor.step(1, BACKWARD, INTERLEAVE);
delay(time_in_between_single_steps);
sw0 = digitalRead(SW0);
}
}
else if (D != D_old && D == 0) {
int diff = V + V_old;
sw0 = digitalRead(SW0); // Read state of start signal
while (sw0 == HIGH && diff > 0) {
diff = diff - 1;
V_old = V_old - 1;
motor.step(1, BACKWARD, INTERLEAVE);
delay(time_in_between_single_steps);
sw0 = digitalRead(SW0);
}
if (V_old < 0) {
V_old = -V_old;
D_old = D;
}
}
else if (D != D_old && D == 1) {
int diff = V + V_old; int diff1 = V + V_old;
sw1 = digitalRead(SW1); // Read state of start signal
while (sw1 == HIGH && diff > 0 && diff1 > DIFF) {
diff = diff - 1;
V_old = V_old - 1;
motor.step(1, FORWARD, INTERLEAVE);
delay(time_in_between_single_steps);
sw1 = digitalRead(SW1);
}
if (V_old < 0) {
V_old = -V_old;
D_old = D;
}
}
UPDATE_1( );
}
} // end Case 5
//
else if ( s_o == 1 && s_n == 1 && task == 0 ){ // begin Case 6
UPDATE_1( );
} // end Case 6
}// End main loop

What is claimed is:

1. A dynamically adjustable system for updating an angular orientation of a surveillance device of a moving vehicle, the system comprising:
a surveillance device;
a motor coupled to the surveillance device, the motor configured to rotate the surveillance device about an axis;
a compass based angular sensor configured for detecting the orientation of a vehicle, the angular sensor providing an angular position signal; and,
a controller communicating with the angular sensor and a turn signal switch of the vehicle, the controller receiving the angular position signal and a turn indication signal from the turn signal switch, the controller calculating the updated angular orientation of the surveillance device based on the angular position signal and the turn indication signal, the controller providing an updated angular orientation signal to the motor;
wherein the motor rotates the surveillance device based on the updated angular orientation signal from the controller, the surveillance device providing a driver of the vehicle with a key desired field of view.

2. The dynamically adjustable system for updating the angular orientation of the surveillance device of the moving vehicle of claim 1, wherein the key desired view comprises a view of pedestrians crossing a street.

3. The dynamically adjustable system for updating the angular orientation of the surveillance device of the moving vehicle of claim 1, wherein the key desired view comprises a view of a road section immediately behind the vehicle before the turning is initiated.

4. The dynamically adjustable system for updating the angular orientation of the surveillance device of the moving vehicle of claim 1, wherein the key desired view comprises a view of a road section opposite to that of the road section into which the vehicle is turning.

5. The dynamically adjustable system for updating the angular orientation of the surveillance device of the moving vehicle of claim 1, wherein the key desired view comprises a view of a road section into which the vehicle is turning.

6. The dynamically adjustable system for updating the angular orientation of the surveillance device of the moving vehicle of claim 1, wherein the controller delays the calculating the updated angular orientation of the surveillance device until the vehicle initiates the turn.

7. The dynamically adjustable system for updating the angular orientation of the surveillance device of the moving vehicle of claim 1, further comprising a Global Positioning System (GPS) providing GPS signals to the controller, wherein the controller is further configured to calculate the updated angular orientation of the surveillance device based on the GPS signals.

8. The dynamically adjustable system for updating the angular orientation of the surveillance device of the moving vehicle of claim 1, wherein the angular orientation of the surveillance device is bounded from above.

9. The dynamically adjustable system for updating the angular orientation of the surveillance device of the moving vehicle of claim 1, further comprising a microswitch configured to limit the rotation of the motor.

10. The dynamically adjustable system for updating the angular orientation of the surveillance device of the moving vehicle of claim 1, wherein the surveillance device comprises a reflective mirror.

11. A dynamically adjustable system for updating an angular orientation of a surveillance device of a moving vehicle, the system comprising:
a surveillance device;
a motor coupled to the surveillance device, the motor configured to rotate the surveillance device about an axis;
a pitch and roll sensor providing a pitch and roll signal; and,
a controller communicating with the pitch and roll sensor and a turn signal switch of the vehicle, the controller receiving a turn indication signal from the turn signal switch and the pitch and roll signal from the pitch and roll sensor, the controller calculating the updated angular orientation of the surveillance device based on the turn indication signal and the pitch and roll signal, the controller providing an updated angular orientation signal to the motor;
wherein the motor rotates the surveillance device based on the updated angular orientation signal from the controller, the surveillance device providing a driver of the vehicle with a key desired field of view.

12. The dynamically adjustable system for updating the angular orientation of the surveillance device of the moving vehicle of claim 11, wherein the key desired view comprises a view of pedestrians crossing a street.

13. The dynamically adjustable system for updating the angular orientation of the surveillance device of the moving vehicle of claim 11, wherein the key desired view comprises a view of a road section immediately behind the vehicle before the turning is initiated.

14. The dynamically adjustable system for updating the angular orientation of the surveillance device of the moving vehicle of claim 11, wherein the key desired view comprises a view of a road section opposite to that of the road section into which the vehicle is turning.

15. The dynamically adjustable system for updating the angular orientation of the surveillance device of the moving vehicle of claim 11, wherein the key desired view comprises a view of a road section into which the vehicle is turning.

16. The dynamically adjustable system for updating the angular orientation of the surveillance device of the moving vehicle of claim 11, wherein the controller delays the calculating the updated angular orientation of the surveillance device until the vehicle initiates the turn.

17. The dynamically adjustable system for updating the angular orientation of the surveillance device of the moving vehicle of claim 11, further comprising a Global Positioning System (GPS) providing GPS signals to the controller, wherein the controller is further configured to calculate the updated angular orientation of the surveillance device based on the GPS signals.

18. The dynamically adjustable system for updating the angular orientation of the surveillance device of the moving vehicle of claim 11, wherein the angular orientation of the surveillance device is bounded from above.

19. The dynamically adjustable system for updating the angular orientation of the surveillance device of the moving vehicle of claim 11, further comprising a microswitch configured to limit the rotation of the motor.

20. The dynamically adjustable system for updating the angular orientation of the surveillance device of the moving vehicle of claim 11, wherein the surveillance device comprises a reflective mirror.

21. A method for dynamically updating an angular orientation of a surveillance device of a moving vehicle, the method comprising:
receiving the angular position signal from a compass based angular sensor;
receiving a turn indication signal from a turn signal switch;
calculating the updated angular orientation of the surveillance device based on the angular position signal and the turn indication signal by a controller;
providing an updated angular orientation signal to the motor based on the updated angular orientation; and,
rotating the surveillance device based on the updated angular position signal.

22. The method for dynamically updating the angular orientation of the surveillance device of the moving vehicle of claim 21, the method further comprising receiving a pitch and roll signal from the pitch and roll sensor, wherein the controller is further configured to calculate the updated angular orientation of the surveillance device based on the angular position signal, the turn indication signal, and the pitch and roll signal.

23. A dynamically adjustable system for updating an angular orientation of mirrors of a moving vehicle, the system comprising:
a mirror assembly comprising:
a center mirror section having a left side and a right side;
a left mirror section rotatively coupled to the left side of the center mirror section;
a first motor coupled to the center mirror section and the left mirror section, the first motor configured to rotate the left mirror relative to the center mirror section;
a right mirror assembly rotatively coupled to the right side of the center mirror section; and,
a second motor coupled to the center mirror section and the right mirror section, the motor configured to rotate the right mirror relative to the center mirror section; and,
a controller coupled to the first motor and the second motor, the controller configured for changing the view of the left mirror section and a right mirror section during a turn, the left and the right mirror sections providing a driver of the vehicle with a key desired field of view.

24. The dynamically adjustable system for updating the angular orientation of mirrors of a moving vehicle of claim 23, further comprising:
a compass based angular sensor configured for detecting the orientation of a vehicle, the angular sensor providing an angular position signal; and,
wherein the controller is configured to communicate with the angular sensor and a turn signal switch of the vehicle, the controller receiving the angular position signal and a turn indication signal from the turn signal switch, the controller calculating the updated angular orientation of the left and right mirror sections based on the angular position signal and the turn indication signal, the controller providing an updated angular orientation signal to the first and second motors.

25. The dynamically adjustable system for updating the angular orientation of mirrors of a moving vehicle of claim 23, wherein the key desired view comprises a view of a road section opposite to that of the road section into which the vehicle is turning.
